(19) United States
(12) Patent Application Publication
(10) Pub. No.: US 2023/0107469 A1
(43) Pub. Date: Apr. 6, 2023

(54) Rainwater Collecting Apparatus

(71) Applicant: James Clostio, Erath, LA (US)

(72) Inventor: James Clostio, Erath, LA (US)

(21) Appl. No.: 17/578,627

(22) Filed: Jan. 19, 2022

(30) Foreign Application Priority Data
Jan. 19, 2021 (GB) 2100686.1
Jan. 18, 2022 (GB) 2200581.3

(51) Int. Cl. E03B 3/02

(52) U.S. Cl. CPC E03B 3/02

(57) ABSTRACT

A system for catching rainwater from a roof comprises a watering can, positioned under a side of the roof, in a position suitable for catching rainwater that falls off the side of the roof, the watering can thus being in a water catching position; and a blocking arrangement, to block view of a portion or a whole of the watering can, from a front view. The blocking arrangement may block view of a portion or a whole of the watering can, from a left view. The blocking arrangement may block view of a portion or a whole of the watering can, from a right view. Preferably, the system for catching rainwater comprises a positioning system, to keep the watering can positioned in the water catching position.

The present invention relates to a rainwater collecting apparatus. (Particular attention is paid to the hiding of water collection).

### REFERENCES TO RELATED APPLICATIONS

The following applications are included in the chain of priority of the present application: GB2100686.1, (filed January 19^{th} 2021); and GB2200581.3, (filed January 18^{th} 2022). The disclosures of these applications are herein incorporated by reference, in their entirety.

### TERMS/DEFINITIONS

### Arrangement

The term arrangement is a technical term which means a feature, or combination of features, (usually with a given purpose). For example, a ‘measuring arrangement’ is a feature or features, to facilitate measuring. A ‘holding arrangement’ is a feature or features, to facilitate holding.

### Feature

The term ‘feature’ is a broad term that includes within its scope any feature under the Sun. A feature may, for example, be an element, body, member, or may even be an aperture (eg opening/hole/gap or the such like). Thus the term ‘holding feature’ includes within its scope, for example, any element, body, member, or even aperture, to facilitate holding. A ‘feature’ may also be a ‘part’ of a broader feature; for example, if a part of an invention is disclosed/claimed as comprising a ‘padding feature’, this does not limit the padding feature to being a separate feature that is added to the invention (eg a sponge element, adhered to the invention); the invention, for example, may have a part made of sponge, or have an inner sponge (or soft) layer- in such a case, if that part of the invention is clearly of a material/nature that provides padding, then this falls within a scope of what is defined in the present application as a ‘padding feature’.

### Substantially

It is known, to those with skill in the art of patenting, that the word ‘substantially’ can, in some instances, be used to broaden a term. It should be stated that, in the present application, use of the word ‘substantially’ with a term, to define a (characterizing) feature(s), gets all the benefit (ie the benefit of any broadening) afforded by use of the word ‘substantially’, and also includes within its scope the feature(s) being that term exactly, (without broadening). For example, if two features are described/defined in the present application as being ‘substantially parallel’, then that includes, within its scope, the features being ‘close’ to parallel (in so far as the word ‘substantially’ is deemed to broaden the term ‘parallel’), and also includes within its scope the features being ‘exactly’ parallel).

### ‘Velcro®’ And ‘Velcro®-type’

It will be known that the term ‘Velcro®’ has become synonymous (in layman’s terms) for hook-and-hook, hook-and-loop, loop-and-loop, and all such similar attachment solutions. In the present application, where the term ‘Velcro®’ is used, in includes within its scope all of the above, and whatever solutions would be considered to be, from a layman’s point of view, ‘Velcro®’. Thus it is a broad term. The term ‘Velcro®’, or ‘Velcro®-type’, may be used, (in the disclosure generally, and may also be used in a claim(s)), and is thus a broad term which includes within its scope any solutions/features which would be considered, from a layman’s point of view, to be ‘Velcro®’.

### ‘Attached’ And ‘Connected’

If a feature (or two features) are defined in a claim as being attached, that would include within its scope the feature (or two features) being permanently attached, (of course), and would also include within its scope the feature (or two features) being removably attachable, (because, if removably attachable, the feature (or two features) can be attached, and therefore, when attached, would be within a scope of being ‘attached’). Furthermore, the feature (or two features) being defined in a claim as being ‘attached’ would also include within its scope the feature that is defined as being ‘attached’ being formed as one part with a portion or a whole of the other feature it is defined as being ‘attached’ to. For example, if a table leg is defined in a claim as being ‘attached’ to a table top, that would include within its scope the table leg being formed as one part with a whole of the table top (eg if the table leg and table top were formed as one piece of plastic, for example) and would also include within its scope the table leg being formed as one part with a portion (rather than a whole) of the table top (eg if the table top was formed of more than one part, and the table leg was formed as one part with a part of the table top, but not a whole of it). (It would also include within its scope a portion (rather than a whole) of the feature that is defined as being ‘attached’ being formed as one part with a portion (or a whole) of the other feature it is defined as being ‘attached’ to. Thus if the table leg had a separate top half and bottom half, for example, (that are attached together, in use), an embodiment where the top half of the leg is formed as one part with a portion (or a whole) of the table top would also be within a scope of the table leg being ‘attached’ to the table top). It should be noted, some (few) patent offices require structural connection/relationship terms (in claims), to define structural connection/relationship between features of the claim. With this in mind, (and if it should be required, although it often is not), the term ‘connected’, if used in a claim, is a broad term, which includes within its scope direct connection, and also includes within its scope indirect connection. (‘Direct’ connection would be where two features, for example, are directly connected to each other (eg an arm is ‘directly’ connected to a shoulder). ‘Indirect’ connection would be where two features, for example, are connected, but via intermediate feature(s) (eg a person’s foot is ‘connected’ to their head, but ‘indirectly’, (via their leg, abdomen, torso, etc, which are ‘intermediate features’)). Where the term ‘connected’ is used in a claim, it includes within its scope ‘direct’ connection, and also includes within its scope ‘indirect’ connection. The term may be used in a claim, (and is deemed supported), whether ‘direct’ and/or ‘indirect’ connection embodiment(s) is (/are) disclosed in the present application, and, as stated, includes within its scope ‘direct’ connection, and also includes within its scope ‘indirect’ connection. Furthermore, if a feature(s) is (/are) defined as being ‘connected’, that would include within its scope the (or any- ie more than one of the said) feature(s) being removably attachable, if, when attached, the feature(s) is (/are) in a state of being ‘connected’, (directly or indirectly). Thus if a first feature is defined as being ‘connected’ to a second feature, it would include within its scope the first feature and/or the second feature being removably attachable, if, when attached, the first feature is connected to the second feature, (directly or indirectly). Furthermore, of course, (and similarly to the word ‘attached’), if a feature (or two features) are defined in a claim as being ‘connected’ it would also include within its scope the feature that is defined as being ‘connected’ being formed as one part with a portion or a whole of the other feature it is defined as being ‘connected’ to.

### ‘The Or Each’ And ‘The Or Any’

The term ‘the or each’ (either in disclosure and/or a claim) can refer back to a single feature/thing, and/or can refer back to a plurality of features/things. When the term is read as referring back to a plurality of features/things, it should be taken as meaning, and including within its scope, ‘at least one, or more, or all (ie each)’ of the said features/things. Thus, to give an example, if a square is referred to/disclosed that has four corners, if the term ‘the or each corner’ is used, it includes within its scope ‘one of the corners, (or two, or three, or all of the corners)’.

When any one feature/thing is afforded any feature(s)/definition in the present application, it is taken as read that, where a plurality of the said feature/thing is provided, ‘the or each’ said feature/thing may be provided/claimed comprising the said feature(s)/definition (ie at least one, or more or all). Similarly, wherever a plurality of the said feature/thing are afforded any feature(s)/definition, it is taken as read that ‘the or each’ said feature/thing may be provided/claimed comprising the feature(s)/definition (ie at least one, or more, or all of the plurality), and/or that even just one said feature/thing may be provided/claimed comprising the feature(s)/definition in an embodiment/claim wherein an invention is defined as comprising ‘a’ (eg singular) said feature/thing.

(The term ‘the or any’ may be used (again including within its scope, ‘at least one, or more, or all (ie each)’, instead of the term ‘the or each’).

### ‘User Means’

It will be well known that, in certain patenting territories, (for example, the United States), use of the term ‘means’ or ‘means for’, if used in a (granted) patent claim, can be seen as a limiting term, limited to only giving the applicant/proprietor of the patent protection of means that are disclosed in the granted patent, or ‘equivalent’ means. This is not the case with the term ‘user means’ as it is used in the present application. The term ‘user means’ is a very broad term that is used in the field of product design/user-interface, and defines any means under the sun, provided for a user, for whatever action/result the user means is provided for. For example- a ‘user means’ to turn on a television could be provided by way of an ON/OFF button on the television. But it could also be provided by a button on a remote control which turns on the television when pressed. Both of these would fall (in the technical field of product design/user-interface) under the scope of the term ‘user means’ to turn on the television. Similarly, with certain inventions/products, a ‘user means’ may be provided to ‘initiate’ an action, for example. Thus, in the present application, a claim that defines an invention which comprises a ‘user means’ for [a particular action/result] is not subject to any ‘means for’ limitations that certain patent office territories (such as the United States) may appropriate to the term ‘means for’, but should be read as (and given protection for, if granted) any means under the sun, provided for a user, for [that particular action/result defined]. ‘User means’ is a technical term in the field of product design/user-interface.

### Reference To Multiple Similar Elements In Plural

In the present application, there may be provided/numbered features wherein the same primary number is used, with a suffix. For example, a first side of the/an invention may be numbered 600’, and a second side of the/an invention numbered 600”. In any such case, (or where any other suffix is used, such as ‘L’ and ‘R’ to denote ‘left’ and ‘right’, or ‘a’ and ‘b’, for example), when such features are referred to together (ie ‘the sides’), the plural may be numbered/referred to with the primary number (without the suffix). Thus the first side 600’ (or 600a, for example) and second side 600” (or 600b, for example) may, for example, be referred to simply as ‘the sides 600’. Furthermore, if a side is referred to (not specifying which one of the sides), the primary number (ie 600, for example) may be used, without any suffix.

### Background

Many houses have areas, (eg off the side of a roof), where rainwater falls, towards the ground. It could be beneficial for a gardener to try to ‘capture’ this rainwater, so that it can be used for watering plants, around the garden. However, if a basic solution is used, such as placing bucket(s) in the position(s) where the rainwater falls off the roof in the biggest volume, this creates a problem; the bucket(s) can look unattractive. If a person cares greatly about the look of the garden, they may not want to leave bucket(s) around the garden in this way, which could look untidy, for example. Furthermore, buckets are not the best type of apparatus for watering plants with.

It would be desirable if the rainwater could be captured, without ruining the aesthetic of a garden, and if it could be captured in such a way that makes it easy and effective to water plants with the captured water.

### SUMMARY

An invention(s) is defined by the accompanying claims, to which reference should now be made.

Examples of the present invention seek to provide a solution to any or all of the above problem(s) by providing, according to one aspect of what is invented: a system for catching rainwater from a roof, comprising: a watering can, positioned under a side of the roof, in a position suitable for catching rainwater that falls off the side of the roof, the watering can thus being in a water catching position; and a blocking arrangement, to block view of a portion or a whole of the watering can, from a front view.

Thus the watering can can be positioned in a suitable position, to catch water from off the side of the roof. The watering can can then be used, to water plant(s), (eg around a garden). Thus the user, in such a situation, does not have to themselves ‘fill up’ the watering can- the work is done for them, by the watering can catching rainwater that falls off a roof.

The watering can can be (at least partially) ‘hidden’ by the blocking arrangement. The blocking arrangement may comprise plant(s). This can be helpful in ‘blending in’ to the surroundings, (and/or simply to provide an aesthetic look).

The blocking arrangement may block view of a portion or a whole of the watering can, from a left view. The blocking arrangement may block view of a portion or a whole of the watering can, from a right view.

Preferably, the system for catching rainwater comprises a positioning system, to keep the watering can positioned in the water catching position. (It will be apparent that this may be of significant importance, otherwise the watering can could be blown away, (or at least blown out of position), by the wind, for example. It may also be useful, to

According to another aspect of what is invented, there is provided: a rainwater catching apparatus, comprising: a watering can; and a blocking arrangement, to block view of a portion or a whole of the watering can, from a front view.

(Preferably, the rainwater catching apparatus comprises a positioning system, to keep the watering can positioned in a position. (Thus, in use, this can be used, to keep the watering can in a water catching position))

According to another aspect of what is invented, there is provided: an apparatus comprising: a watering can; and an apparatus/part that comprises an area to input water into, the apparatus not being the watering can; and a positioning system, to keep the watering can in a position.

(Thus weight of the water can be used, to help prevent or limit movement of the watering can). (Preferably the area for inputting water into is a water storage area that is operable in a closed mode, where water cannot escape). (Examples will be explored, wherein the position is an upright position, there thus being provided: an apparatus comprising: a watering can; and an apparatus/part that comprises an area to input water into, the apparatus not being the watering can; and a positioning system, to keep the watering can positioned in an upright position). (Examples will be explored of the watering can being kept in a desired position, there thus being provided: an apparatus comprising: a watering can; and an apparatus/part that comprises an area to input water into, the apparatus not being the watering can; and a positioning system, to keep the watering can positioned in a desired position). (Examples will be explored, wherein the position is a water catching position, (for catching rainwater that falls off a side of a roof), there thus being provided: an apparatus comprising: a watering can; and an apparatus/part that comprises an area to input water into, the apparatus not being the watering can; and a positioning system, to keep the watering can positioned in a water catching position, (for catching rainwater that falls off a side of a roof)).

According to another aspect of what is invented, there is provided: a watering can, comprising: a water storage area; and an output point, for outputting water. Thus water that is stored in the water storage area can be outputted, out of the output point, (which may also be referred to as a ‘water output point’). (The watering can may comprise an overflow output point. This may be helpful/important, to stop the watering can overflowing).

According to another aspect of what is invented, there is provided an apparatus, comprising: a watering can; and an apparatus/part comprising a planting area, to plant one, or more than one, plant into. (The apparatus/part may comprise a plurality of planting areas). (It has been shown how plant(s) can be useful in blocking view of a portion or a whole of a watering can).

According to another aspect of what is invented, there is provided: a system for catching rainwater from a roof, comprising: a watering can, positioned under a side of the roof, in a position suitable for catching rainwater that falls off the side of the roof, the watering can thus being in a water catching position; and a blocking arrangement, to block view of a portion or a whole of the watering can.

According to another aspect of what is invented, there is provided: a rainwater catching apparatus, comprising: a watering can; and a blocking arrangement, to block view of a portion or a whole of the watering can.

According to another aspect(s) of what is invented, it is here stated that, for any invention invented and/or stated that includes a ‘watering can’, it is here more broadly stated that the broad term ‘water storage apparatus’ may be used, (which includes a ‘watering can’ within its scope), and is, (by virtue of this statement), deemed fully supported. The term ‘water storage apparatus’ is a broad term, and includes within its scope any apparatus used to store water, and would include within its scope, for example, a bucket, or, for example, any ‘generic’ apparatus that can catch rainwater that falls of a roof, not limited to being a watering can. For example, according to this aspect, a ‘tub’, for example, may be used, (as a water storage apparatus). For example, an apparatus may feasibly be used that does not comprise a spout, for example, (as a water storage apparatus).. For example, an apparatus may feasibly be used that does not comprise a handle, for example, (as a water storage apparatus). Nevertheless, it will be apparent that there are significant benefits of the water storage apparatus being a watering can, since, for example, user, when water has been received into the watering can from the roof, can then use the watering can, to water plants around their garden for example. (It is hard to do this so effectively with an apparatus that is not a watering can).

Note: Any of the aspects (of what is invented) may comprise/draw upon any of the feature(s) of any other aspect(s) of what is invented, and may draw upon any of the feature(s) and/or disclosure of the present application, as optional and/or preferable feature(s). Any aspect(s) (of what is invented) may comprise/draw upon any feature(s) of any other aspect(s) (of what is invented), whether the feature(s) be essential or preferable and/or optional to the other aspect(s) (of what is invented).

### BRIEF DESCRIPTION OF THE DRAWINGS

Examples of the present invention will now be more particularly described, with reference to the accompanying drawings, by way of example only, in no way limiting a scope of the invention, in which:

FIG. 1 is a perspective view, showing an example of a water catching apparatus, showing an example watering can positioned under a side of the roof, in a position suitable for catching rainwater that falls off the side of the roof, the watering can thus being in a water catching position, and showing a blocking arrangement blocking view of a portion or a whole of the watering can;

FIG. 2 is a close-up view of the example water catching apparatus of FIG. 1, from the same angle as FIG. 1;

FIG. 3 is a front view of another embodiment of a water catching apparatus, showing an outline of some plants, which the blocking arrangement, to block view of the watering can, comprises, and showing the watering can in dotted lines, to denote it is hidden behind the plants;

FIG. 4 is a side view, showing rain falling off of a roof of a building, into a watering can that is in a water catching position;

FIG. 5 is a top view, (from above), showing an example watering can, and an example front blocking portion that blocks view of a portion or a whole of the watering can, from a front view;

FIG. 6 is a top view, (from above), showing an example watering can, and an example blocking arrangement that comprises a front blocking portion, to block view of a portion or a whole of the watering can, from a front view, a left blocking portion, to block view of a portion or a whole of the watering can, from a left view, and a right blocking portion, to block view of a portion or a whole of the watering can, from a right view;

FIG. 7 is a top view, (from above), again showing an example watering can, and an example blocking arrangement that comprises a front blocking portion, to block view of a portion or a whole of the watering can, from a front view, a left blocking portion, to block view of a portion or a whole of the watering can, from a left view; and a right blocking portion, to block view of a portion or a whole of the watering can, from a right view;

FIG. 8 is a top view, (from above), showing an embodiment similar to that of FIG. 7, but now showing a water catching apparatus that comprises a portion the watering can is positioned on;

FIG. 9 is a side view, showing an example of a blocking arrangement that, at its highest point, is higher than height of a highest point of the watering can, and showing various dashed lines, to clearly denote this;

FIG. 10 is a top view, (from above), showing another embodiment of a water catching apparatus that comprises a portion the watering can is positioned on;

FIG. 11 is a side view, showing an example of wherein the apparatus comprises a positioning system, to keep the watering can in a water catching position, the example comprising a receiving portion that receives a portion of the watering can, and also comprising a protruding portion that is received into a receiving portion of the watering can, thus mating the watering can to the example portion it is positioned on;

FIG. 12 is a top view, (from above), showing the example of FIG. 11, but not showing the watering can, to show clearly several features of the portion the watering can of FIG. 11 is positioned on;

FIG. 13 is a view from below, showing an underside of an example watering can, showing an example receiving portion the watering can comprises, to facilitate mating;

FIG. 14 is a side view, showing an example of wherein the watering can is removably attachable;

FIG. 15 is a perspective view of an embodiment where the blocking arrangement comprises plants;

FIG. 16 is a perspective view of the same embodiment as shown in FIG. 15, but now with the plants removed, now clearly showing the watering can;

FIG. 17 is another perspective view of the same embodiment as shown in FIG. 15 and FIG. 16, but now with the watering can also removed, an example protruding portion, to facilitate mating, now being clearly visible;

FIG. 18 is another view, looking down from in front of the same embodiment as FIGS. 15-17, showing a separated view, revealing that the portion the watering can was positioned on, in FIG. 16, is provided by way of a separate apparatus, and showing an example planting area, comprising a plurality of drainage holes;

FIG. 19 shows a same view as shown in FIG. 18, showing an almost identical embodiment to the embodiment of FIG. 18, but now showing an example portion that can help a user pick up both parts that are shown in the Figure, together;

FIG. 20 shows a same view as shown in FIG. 18 and FIG. 19, but now showing how the portion that can help a user pick up both parts that are shown in the Figure, together, can be provided by way of sub-portions;

FIG. 21 is a top view, (from above), of an embodiment extremely similar to that of FIGS. 15-20, but wherein the embodiment is more curved in shape;

FIG. 22 is a raised side view, looking slightly downwards, showing the embodiment of FIG. 15, but not showing the plants and thus not showing the blocking arrangement, and showing the watering can in a water catching position;

FIG. 23 is a front view of a different embodiment of a water catching apparatus, showing an example front blocking portion that comprises planting areas, but wherein plants planted in the planting areas do not play a blocking role;

FIG. 24 is a top view, (from above), of an embodiment extremely similar to the embodiment of FIG. 23, showing example protruding portions that comprise a planting area;

FIG. 25 is a front view of an embodiment wherein the blocking arrangement comprises a frog figure;

FIG. 26 is a front view of an embodiment wherein the blocking arrangement comprises a gnome figure;

FIG. 27 is a view from a raised front angle, showing an exploded view of features relating to a water input point of the example watering can;

FIG. 28 is another exploded view of features relating to a water input point of another example watering can, similar to the view of FIG. 27, showing another watering can;

FIG. 29 is a view from a raised front angle, showing an embodiment of a blocking arrangement, for blocking movement of the watering can;

FIG. 30 is a perspective view of an embodiment that is otherwise identical to the embodiment of FIG. 16, but wherein the separate position and blocking parts shown separated in FIG. 18, rather than being provided as separate parts, are provided as one part;

FIG. 31 is a perspective view of an example watering can that comprises an openable and closable water output point;

FIG. 32 is a basic exploded view of an example wherein the watering can comprises a mosquito-proof aperture arrangement, to stop mosquitos getting into the watering can, via the water output point of the watering can;

FIG. 33 is a top view, (from above), showing an example watering can, and an example blocking arrangement, showing an example similar to those of FIG. 6, FIG. 7 and FIG. 8; and

FIG. 34 is a basic cross-section cut-off view of an example lip portion on a border/edge of a planting area.

Note: At some patent offices, when claim(s) are allowed for patent, it is required that Figures that do not show all the feature(s) of the/an invention claimed (and/or that are not within a scope of what is claimed) are denoted as ‘not being claimed’ or ‘not within a scope of what is claimed’ (or words to that effect). Even in such case, it will be apparent that such Figure(s) may or do show feature(s) that are essential, or preferable and/or optional, to the/an invention claimed, which will be apparent, in light of the disclosure. Thus such Figure(s) (and/or disclosure related to such Figure(s) and/or embodiment(s)), should nevertheless be considered relevant to the/an invention claimed.

### DETAILED DESCRIPTION

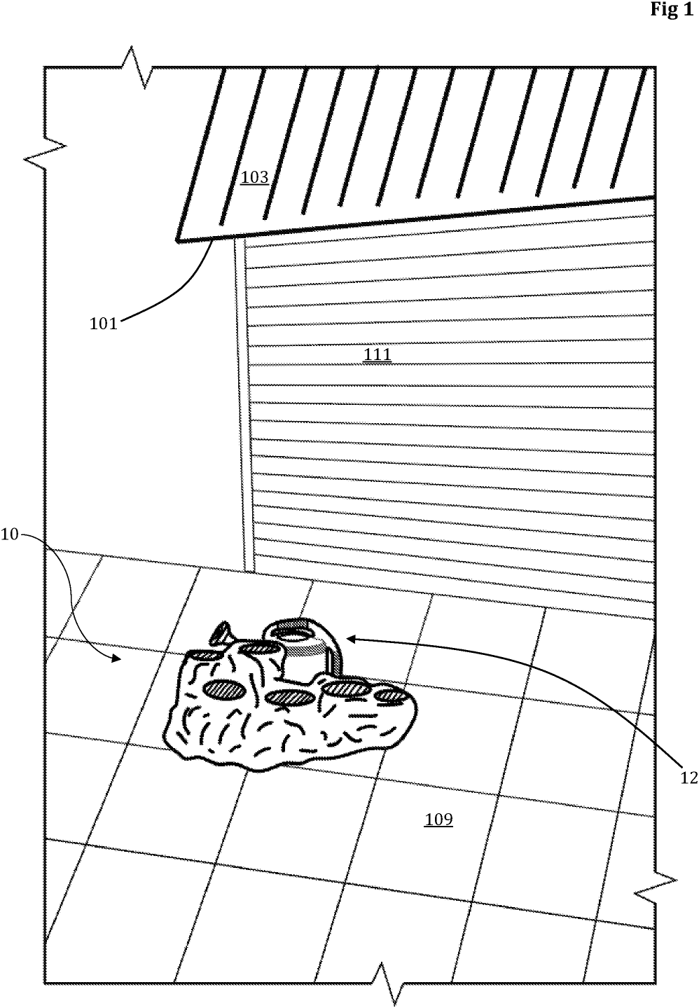

Referring to the drawings, there is shown a rainwater catching apparatus 10, comprising: a watering can 12; and a blocking arrangement 14, comprising a front blocking portion 14F, to block view of a portion or a whole of the watering can 12, from a front view. (Example(s) are shown of a system for catching rainwater from a roof, comprising: a watering can 12, positioned under a side 101 of the roof 103, in a position suitable for catching rainwater 105 that falls off the side of the roof, the watering can thus being in a water catching position; and a blocking arrangement 14, comprising a front blocking portion 14F, to block view of a portion or a whole of the watering can, from a front view. (This is particularly well shown in FIGS. 1, 4 and 22).

(Note: Disclosure is often provided, in the present application, of a ‘front blocking portion’, (to block view of a portion or a whole of the watering can, from a front view). It should be stated, any embodiment that comprises a blocking arrangement, to block view of a portion or a whole of the watering can, ‘from a front view’, is considered to comprise a ‘front blocking portion’,(to block view of a portion or a whole of the watering can, from a front view). (Thus any blocking arrangement that blocks view of a portion or a whole of the watering can, from a front view is considered to be an embodiment that comprises a ‘front blocking portion, (to block view of a portion or a whole of the watering can, from a front view). Thus these definitions may be used interchangeably, and, it should be stated, disclosure of/use of terminology of ‘a front blocking portion’, (to block view of a portion or a whole of the watering can, from a front view), is considered to fully support, (eg in a claim), definition of ‘a blocking arrangement, to block view of a portion or a whole of the watering can, from a front view’. (Thus any disclosure afforded to a ‘front blocking portion’, (to block view of a portion or a whole of the watering can, from a front view), supports such disclosure being afforded to ‘a blocking arrangement, to block view of a portion or a whole of the watering can, from a front view’).

(Thus examples are shown in the drawings of a rainwater catching apparatus 10, comprising: a watering can 12; and a blocking arrangement 14, to block view of a portion or a whole of the watering can 12, from a front view).

Preferably, in a water catching mode, the blocking arrangement blocks view of at least a quarter of a main body of the watering can, from the front view. (Various examples are shown of this). Preferably, in a water catching mode, the blocking arrangement blocks view of at least a half of a main body of the watering can, from the front view. (Various examples are clearly shown of this, (and example are in fact clearly shown where the blocking arrangement blocks most, (ie more than half), of the main body of the watering can, from the front view). Preferably, in a water catching mode, the blocking arrangement blocks view of at least three quarters of a main body of the watering can, from the front view. Preferably, in a water catching mode, the blocking arrangement blocks view of a whole of a main body of the watering can, from the front view. Preferably, in a water catching mode, the blocking arrangement blocks view of a whole of the watering can, from the front view.

With reference to what is meant by ‘view’, (ie ‘from a front view’, or ‘from a left view’, or ‘from a right view’), FIG. 5, (and various dashed lines), help to make this clear. So, looking at FIG. 5, (which shows a view from above, showing a basic representation of a watering can 12 and an example blocking arrangement 14, (comprising an example front blocking portion 14F)), various dashed lines are shown. Dashed lines F1-F6 denote some views, ‘from a front view’, (the ‘F’ standing for ‘front’); dashed lines L1-L3 denote some views, ‘from a left view’; and dashed lines R1-L3 denote some views, ‘from a right view’. (It will be noticed that the ‘left view’ dashed lines and the ‘right view’ dashed lines are the same lines, (ie that dashed line L1 and dashed line R1, for example, are the same line). This will be explained).

Looking then, at FIG. 5, and looking now at dashed lines F1-F6, the lines define various views, ‘from a front view’. What is being explained here is that, wherever the view ‘starts from’, (ie see dashed line F1, starting to look at it from the bottom of FIG. 1, where it ‘begins’, (and is noted as ‘F1’)), the dashed line in no way changes ‘laterally’, (from the front view). Thus, in a ‘strafe-like’ manner, views F1-F6 all start at a different ‘lateral’ position, but all are considered to be ‘from a front view’. To explain this still further, (and demonstrate what ‘from a front view’ means), dashed line F1 denotes, in the example of FIG. 5, what the furthest point, ‘laterally’, of the blocking arrangement is, to one side of the blocking arrangement, (and one side of the watering can). Dashed line F6, (similarly), denotes what the furthest point, ‘laterally’, of the blocking arrangement is, to the other side of the blocking arrangement, (and the other side of the watering can). It is clear, then, that ‘from a front view’, the blocking arrangement extends left further than the watering can does, and extends right further than the watering can does. (Dashed line F2 denotes, in FIG. 5, how far the watering can extends to one side, and dashed line F5 denotes, in FIG. 5, how far the watering can extends to the other side. (Thus dashed line F2 and F5, together, denote how far the watering can spans, (from the front view). It is clear then, given that dashed line F1 is further right, (‘laterally’, (from the front view)), than the ‘right-most’ part of the watering can, (defined by dashed line F2), (from the front view), and given that dashed line F6 is further left, (‘laterally’, (from the front view)), than the ‘left-most’ part of the watering can, (defined by dashed line F5), (from the front view), that the example blocking arrangement, (and the example front blocking portion of the blocking arrangement, in the example embodiment, (provided by way of example only)), spans a whole width of the watering can, (and in fact spans more than this). (Thus dashed lines F2 and F5, together, define the area the example watering can ‘spans’, (from the front view)). (Dashed lines F3 and F4, together, define the area a ‘main body’ of the example watering can ‘spans’, (from the front view). (Meaning of ‘main body’ will be explained/explored)).

Now, similarly, looking still at FIG. 5, and looking now at dashed lines L1-L3, (the ‘L’ standing for ‘left’), the same methodology is at work. For example, dashed line L1 denotes how far the example blocking arrangement extends ‘back’, (from the left view); dashed line L2 denotes a ‘beginning point’ of the watering can, (from the left view); and dashed line L3 denotes an ‘end point’ of the watering can, (from the left view). (It will be noted that the same dashed lines, (ie dashed lines L1-L3), are also labelled ‘R1’, ‘R2’, and ‘R3’, from the right side, (the ‘R’ standing for ‘right’). Thus, in the same way as for dashed lines L1-L3, dashed line R1 denotes how far the example blocking arrangement extends ‘back’, (from the right view); dashed line R2 denotes a ‘beginning point’ of the watering can, (from the right view); and dashed line R3 denotes an ‘end point’ of the watering can, (from the right view). (It should also be noted, lines F1-F6 are also labelled, (from the back side), as lines B1-6, (the ‘B’ standing for ‘back’).

It is hoped this explains the specific meaning of ‘view’ terms, such as ‘from a front view’, and ‘from a left view’, and ‘from a right view’. (The same methodology is also the case, when the term ‘from a top view’ is used, (eg in a claim, for example)).

(The ‘left view’ may also be referred to as the ‘left side view’. The ‘right view’ may also be referred to as the ‘right side view’).

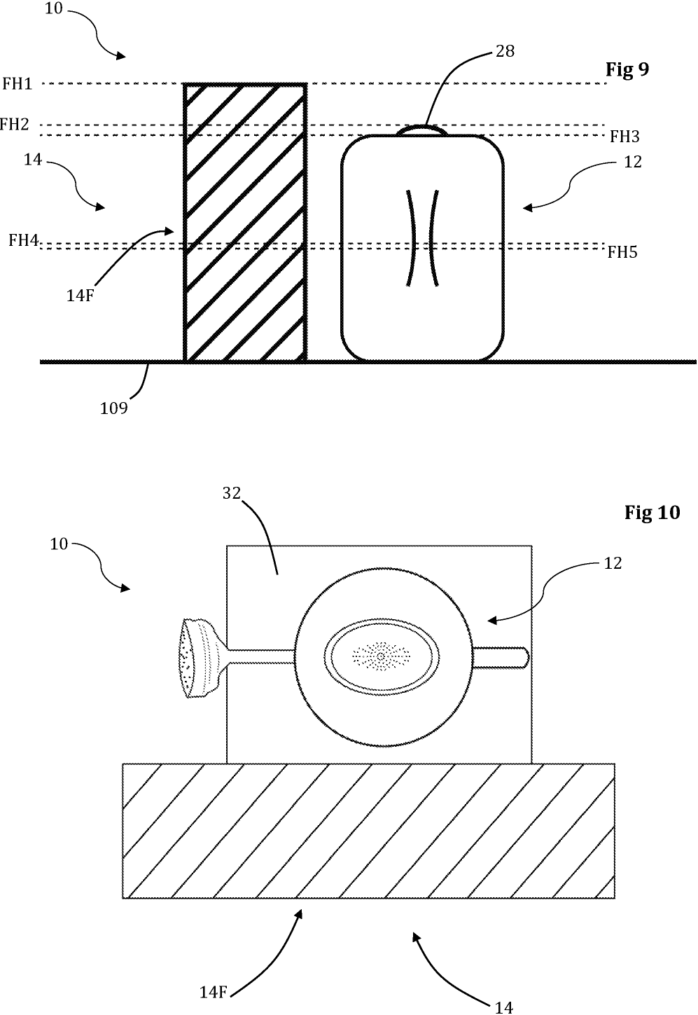

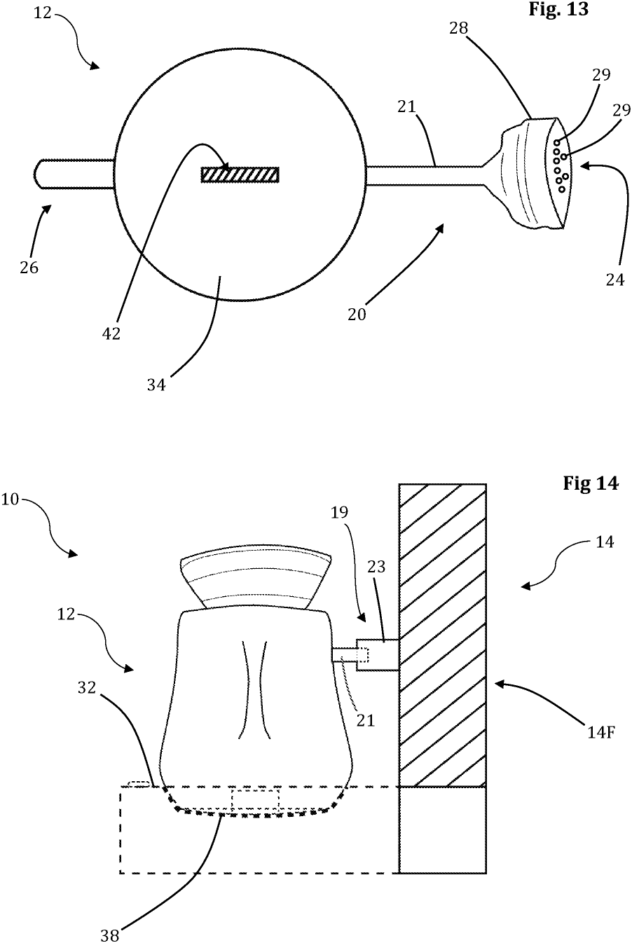

It should also be stated, the same methodology is the case, in terms of definitions of ‘height’, (eg of the blocking arrangement, with relation to the watering can). To explain this, looking at FIG. 9, dashed lines FH1, FH2, FH3, FH4 and FH5 are shown. (The ‘F’ again stands for ‘front’, (as in ‘front view’), and the ‘H’ stands for ‘height’). It can be seen that dashed line FH1 defines a ‘highest point’ of the example blocking arrangement. It can be seen that dashed line FH2 defines a ‘highest point’ of the example watering can. (The example watering can comprises a spout body, (not visible, due to being on the other side, relative to the view shown), culminating in an example sprinkler head 28, (a portion of which is visible), and the ‘highest point’ of the watering can is at the ‘highest point’ of the sprinkler head, in the example embodiment). (Note: Only a portion of the sprinkler head 28 is visible, but it is clear, from the view shown, that the ‘highest point’ of the watering can is at the top of the sprinkler head. To see a more clear example, (where an example watering can is much more clearly visible, and where a sprinkler had provides the highest point of the watering can, please see FIG. 16). It can be seen that dashed line FH3 defines a ‘highest point’ of a main body of the example watering can. (In various Figures, the main body of the watering can is numbered ‘16’. The ‘main body’, for the sake of the present application, is not considered to include any ‘spout’ of the watering can. Thus a highest point of the watering can, and a highest point of the ‘main body’ of the watering can can be at different heights, (the example in FIG. 9 being a good example of this, (and as shown clearly in the example of FIG. 16, for example), where the ‘highest point’ of the watering can is at the highest point of the sprinkler head, but the highest point of the ‘main body’ is not as high, (in the examples)). (Note: For the sake of the present application, if the watering can comprises any features, to do with the input point of the watering can, that generally ‘protrude’ at the top of the watering can, (eg as shown, for example, very clearly, in the embodiments of FIGS. 11, 14, (and 3), for example), these are considered to be part of the main body, (whether they are provided as removable parts, or not). So, in the example of FIG. 3, for example, it can be seen that, in that example, a highest point of the main body is also a highest point of the watering can, (the highest point of the main body actually being higher than the sprinkler head, the example of FIG. 3)). And also denoted is dashed line FH4, which denotes/defines ‘half height’ of the watering can in the Figure, and dashed line FH5, which denotes/defines ‘half height’ of the main body of the watering can in the Figure, (which is slightly lower than dashed line FH5. Thus it can be seen, similarly to dashed lines F1-F6 of FIG. 5, (ie how wherever the view ‘starts from’, the dashed line in no way changed ‘laterally’, (from the front view)), so, (looking at FIG. 9), wherever the view ‘starts from’, (ie see dashed line FH1, starting to look at it from the left of FIG. 9, where it ‘begins’, (and is noted as ‘FH1’), the dashed line in no way changes in terms of height position. (Thus whatever ‘height’ the view starts at/is from, the dashed line in no way changes in terms of height position. Thus, (with this in mind), it is clear that the example blocking arrangement depicted/denoted in FIG. 9, at its highest point, (ie defined by dashed line FH1), is higher than a highest point of the watering can, (defined by dashed line FH2). It is hoped this helps, in understanding what is meant by ‘from a front view’, (or ‘from a left/right view’), and what is meant by any height disclosure/definitions. (As stated, the same methodology is also the case, when the term ‘from a top view’ is used, (eg in a claim, for example)).

Preferably, in a water catching mode, the front blocking portion, at its highest point, is equal to or higher than height of half height of the watering can. Preferably, in a water catching mode, the front blocking portion, at its highest point, is equal to or higher than height of half height of a main body 16 of the watering can. (The term ‘main body’ is here used to imply the portion of the watering can that comprises the water storage area of the watering can, but not including any ‘spout’ of the watering can. (Note: It will be known that water stored in the water storage area of a watering can tends to be able to travel up the spout, when a certain amount of water is inputted into the watering can. Nevertheless, it will be understood what is meant by a ‘water storage area’ of the watering can, since there is clearly a ‘main storage area’ of the watering can. This is what is being alluded to, when the term ‘water storage area’ is used, with reference to a/the watering can. (Note: It is feasible a water storage area of a watering can could feasibly comprises multiple compartments, for storing water. But whilst this is possible, it is not the standard, and the water storage area of a watering can tends not to comprise multiple compartments)). (To explain, looking at FIG. 5, what is shown between lines F3 and F4 is the example ‘main body’ 16 of the example watering can. What is shown between lines F2 and F3 is the example handle 26 of the example watering can. (It will be apparent that may different shapes and/or sizes and/or designs of handle are possible, and the example provided is provided by way of example only). What is shown between lines F4 and F5 is the example spout body 20 of the example watering can. (The spout body may, or may not, comprise a sprinkler head). (The/a ‘spout body’ may also simply be referred to as a ‘spout’). (Note: The/a spout body may, or may not, comprise a plurality of separate parts. For example, the sprinkler head may be removably attachable. (However, it is feasible the/a sprinkler head is not removably attachable. For example, a (portion or a whole of the) sprinkler head may be formed as one part with the rest of the spout body). (It should also be said, an embodiment could be provided wherein a (portion or a whole of the) sprinkler head is formed as one part with a portion, (but not a whole of) the rest of the spout body)). (As another example, it is feasible, (for whatever reason(s)), (although unlikely), that an elongate body, (such as elongate body 21 in FIG. 13, for example), could be provided in multiple separate parts, that attached together, (eg screwing together, for example). This is simply mentioned to make clear that the term ‘body’ in no way limits a feature only to being able to be provided as one part. Generally speaking, then, a ‘body’ may be provided in one part, or may be provided in multiple parts). (In the example(s), the spout body 20 can generally be described as elongate. (In the examples, (best shown in FIG. 13), the spout body 20 comprises an elongate body 21). However, it should be stated, it is feasible a watering can could have build characteristics similar to a modern kettle, for example, (‘modern kettle’ here referring to build characteristic of having a ‘snubby’ spout, (abbreviated/short), rather than an elongate one, (and the term ‘modern’ here being used to differentiate from ‘old-fashioned’, since ‘old-fashioned’ type kettle can come in more of a ‘teapot’-type design, having elongate (rather than ‘snubby’) spouts, (which are often elongate and curved)). (It should also be stated, (especially if a ‘snubby’ spout is provided), that whilst examples are shown in the Figures of wherein the water input point 30 is different from the water output point 24, it is technically feasible that the water input point and the water output point could be the same. For example, in a ‘snubby’ output point embodiment, (ie similar to output point characteristics of a modern kettle, it is feasible there could be a water input point, (which can catch water that falls off a roof), and that there is simply then a ‘snubby’ spout body, which itself provides part of (and is formed from) a portion of a perimeter of the water input point. (This is not the only way a ‘snubby’ water output point can be formed/provided, and is mentioned by way of example only, simple to give an example of wherein a water input point of a watering can and a water output point of a watering can may not be ‘separate’, (as opposed to the examples provided in the drawings, where the water input point 30 and water output point 24 are clearly separate). (Thus a ‘kettle’-type design, (with a ‘snubby’ (small) spout), is still considered, for the sake of the present application, to be within the scope of being a watering can). (Note: If definition is provided, (eg in a claim), that there is ‘a water input point, and a water output point’, this includes within its scope whether the water input point and water output point are ‘separate’, or not. Both are within this scope). Thus the example watering can(s) is shown comprising a main body, (that comprises a water storage area), and a spout body. (An example water output point 24 is shown).

(Note: When it is stated that, ‘in a water catching mode’, the blocking arrangement, at its highest point, is higher than a highest height of the watering can, (and similar such statements/definitions), this takes into account whatever height the watering can is raised off the ground, (in a water catching mode). For example, to explain this, looking at FIG. 11, for example, let it be imagined that, when in the position as shown in FIG. 11, positioned on the example portion 32 it is positioned on, the watering can is raised four inches above the ground. And let it be imagined that the watering can, at its highest point, is twelve inches high, (ie if the watering can was simply placed on the ground, (or any surface), its highest point would be twelve inches above that ground). Since, (in this imagined example, it is also raised four inches off the ground, (in the water catching mode), that would mean, at its highest point, it is effectively, (when in the water catching mode), sixteen inches higher than ground level. Therefore, for a blocking arrangement, in the water catching mode, at its highest point, to be ‘equal to or higher than’ height of a highest point of the watering can, its highest point, (in this imagined example), would have to be sixteen inches, (or more), higher than ground level, in this example, (ie twelve inch height of the watering can, plus the four inches that the watering can is raised above the ground). (This is just taken as an example, (simply as an example only), to help explain that height that the watering can is raised off the ground is taken into account). (So the same such things must be taken into account/factored in, with statements/definitions relating to ‘half height’ of the watering can, (in the water catching mode), etc). (Note: It should be made clear that, in the example of FIG. 9, for example, the watering can is not raised off the ground. So, in the example of FIG. 9, looking at FIG. 9, if the watering can, at its highest point, is twelve inches high, (ie if dashed line FH2, in the example, is at twelve inches), then if it is stated that, in the water catching mode, the blocking arrangement, at its highest point, is equal to or higher than a highest point of the watering can, then that would mean the blocking arrangement, at its highest point, is at twelve inches, or higher).

(Looking at FIG. 11, example portion 32 may be attached to (a portion or a whole of) the example blocking arrangement, or may not be).

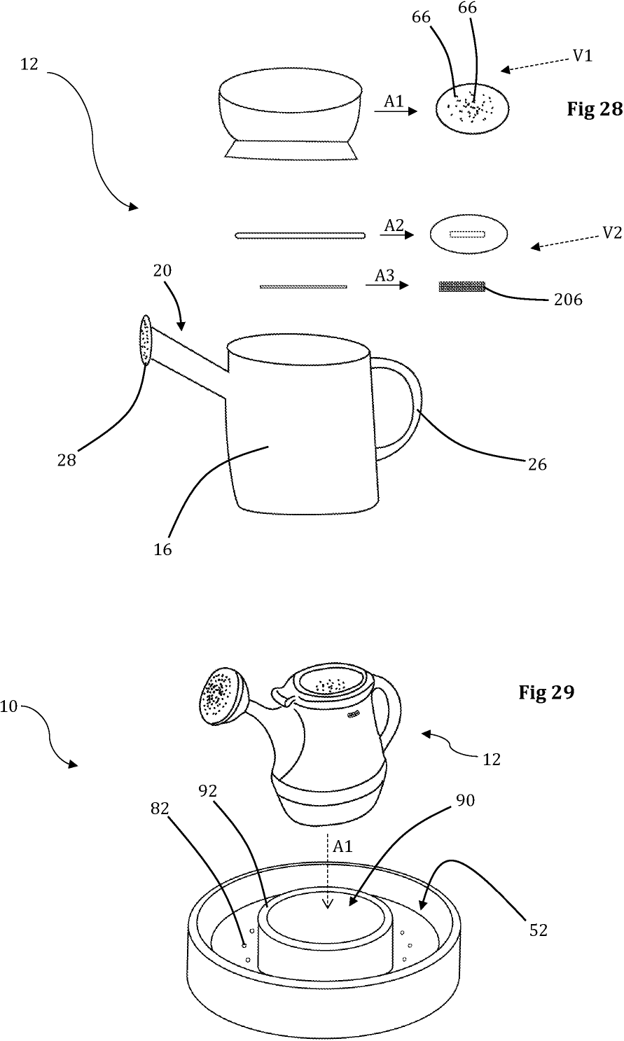

In the example embodiment, the watering can comprises a sprinkler head 28. The sprinkler can clearly be seen comprising a plurality of apertures 29. (These may be referred to as output apertures, since they are for outputting water out of). (Several output apertures 29 are numbered in the example of FIG. 13, but it will be apparent that many other Figures show a watering can, where the output point 24 comprises a plurality of output apertures). However, it should be said, an output point 24 of a watering can need not comprise a plurality (ie ‘more than one’) aperture. For example, many use watering cans that have an elongate spout body, culminating in just one (usually fairly large) output aperture, (without a sprinkler head, for example). (Also, it has been stated that it is feasible a watering can could have a water output point more similar to that of a kettle- such output points, (ie that kettles have) tend to only have one (quite large) output aperture). Thus the output point may not comprise a plurality of output apertures. (Thus an example water output point 24 is shown, comprising a plurality of output apertures 29. (However, as stated, it should be said, an output point 24 of a watering can need not comprise a plurality (ie ‘more than one’) aperture). (It will be known that some watering cans have a spout body that comprises an elongate body 21, but which does not comprise a sprinkler head, often instead culminating in one, (relatively large), output aperture, at the end of the elongate body 21). Thus, with reference to the water output point, there may be only one output aperture, or there may be a plurality of output apertures). An example water input point 30 is also shown. (Similarly to what has been stated with reference to the water output point, so, with reference to the water input point, there may be only one input aperture, or there may be a plurality of input apertures). (Note: When relevant features are ‘added’ to the water output point, or water input point, this may change consideration of how many ‘apertures’ (and/or what other feature(s)) the water output point, or water input point, are considered to comprise. For example, if a watering can comprises a water output point where there is only one (eg relatively large) output aperture, if a sprinkler head is attached, so that water is then outputted out of a plurality of output apertures, it is considered, for the sake of the present application, that the water output point now comprises ‘a plurality of output apertures’. Similarly, looking at FIG. 27, whilst the large opening is numbered ‘30’ as the `water input point, (in the exploded view), when the example parts above are in position, (especially what is denoted as the ‘first level’ V1 in FIG. 27, which, of itself, comprises a plurality of (input) apertures), (eg as shown in FIG. 16, then the water input point 30 is considered to comprise ‘a plurality of apertures).

(Note: If the apparatus/system is ‘operable with’ the front blocking portion, at its highest point, being equal to or higher than height of half height of a main body of the watering can, in a water catching mode, (ie even if there is also an option, in the water catching mode, for the front blocking portion, at its highest point, not to be equal to or higher than height of half height of a main body of the watering can), then that is considered, for the sake of the present application, to be within a scope of, in a water catching mode, the front blocking portion, at its highest point, being equal to or higher than height of half height of a main body 16 of the watering can. For example, (simply to give an example to demonstrate this), if there is a curved surface the watering can is positioned on, in the water catching mode, wherein, when the watering can is on a portion of the curved surface, (eg a ‘high’ portion), the front blocking portion of the blocking arrangement, at its highest point, is not equal to or higher than height of half height of a main body of the watering can, but wherein, when the watering can is on another portion of the curved surface, (eg a ‘low’ portion), the front blocking portion of the blocking arrangement, at its highest point, is equal to or higher than height of half height of a main body of the watering can, then that, for the sake of the present application, is considered to be within a scope of the front blocking portion, at its highest point, being equal to or higher than height of half height of a main body 16 of the watering can, in a water catching mode, (because the apparatus/system is ‘operable’ with the front blocking portion, at its highest point, being equal to or higher than height of half height of a main body 16 of the watering can, in the water catching mode. (Examples are shown of wherein, in a water catching mode, the front blocking portion, at its highest point, is equal to or higher than height of half height of the watering can).

Preferably, in the water catching mode, the front blocking portion, at its highest point, is equal to or higher than height of three quarters height of a main body 16 of the watering can. (Examples are shown of wherein, in a water catching mode, the front blocking portion, at its highest point, is equal to or higher than height of three quarters height of the watering can).

Preferably, in a water catching mode, the front blocking portion, at its highest point, is equal to or higher than height of a highest point of a main body of the watering can. (Examples are shown of wherein, in a water catching mode, the front blocking portion, at its highest point, is equal to or higher than height of a highest point of the watering can).

Preferably, in the water catching mode, the front blocking portion, at its highest point, is equal to or higher than height of a highest point of the watering can.

(Examples are clearly provided/shown of wherein, in the water catching mode, the blocking arrangement, at its highest point, is higher than half height of a main body of the watering can. (Examples are clearly provided/shown of wherein, in the water catching mode, the blocking arrangement, at its highest point, is higher than half height of the watering can). Examples are clearly provided/shown of wherein, in the water catching mode, the blocking arrangement, at its highest point, is higher than three quarters height of a main body of the watering can. (Examples are clearly provided/shown of wherein, in the water catching mode, the blocking arrangement, at its highest point, is higher than three quarters height of a main body of the watering can). Examples are clearly provided/shown of wherein, in the water catching mode, the blocking arrangement, at its highest point, is higher than height of a highest point of a main body of the watering can. (Examples are clearly provided/shown of wherein, in the water catching mode, the blocking arrangement, at its highest point, is higher than height of a highest point of the watering can)).

(Examples are shown, (provided simply by way of example only), within a scope of wherein, at any point, the blocking arrangement spans a whole width of a main body of the watering can, from the front view).

(Examples are shown within a scope of wherein the blocking arrangement spans a whole width of the watering can.

Examples are shown within a scope of wherein the blocking arrangement spans a whole width of the main body of the watering can, at least up to height of half height of the main body. (Examples are shown wherein the blocking arrangement spans a whole width of the watering can, at least up to height of half height of the watering can).

Examples are shown within a scope of wherein the blocking arrangement spans a whole width of the main body of the watering can, at least up to height of three quarters height of the main body. (Examples are shown wherein the blocking arrangement spans a whole width of the watering can, at least up to height of three quarters height of the watering can).

Examples are shown within a scope of wherein the blocking arrangement spans a whole width of the main body of the watering can, at least up to height of a highest point of the main body. (Examples are shown wherein the blocking arrangement spans a whole width of the watering can, at least up to height of a highest point of height of the watering can).

Examples are shown within a scope of wherein the blocking arrangement spans a whole width of the watering can, at least up to height of a highest point of the main body. (Examples are shows wherein the blocking arrangement spans a whole width of the watering can, at least up to height of a highest point of the watering can).

(Example(s) are shown/denoted of wherein the blocking arrangement blocks view of a whole of a main body of the watering can, from the front view). (Example(s) are shown/denoted of wherein the blocking arrangement blocks view of a whole of the watering can, from the front view).

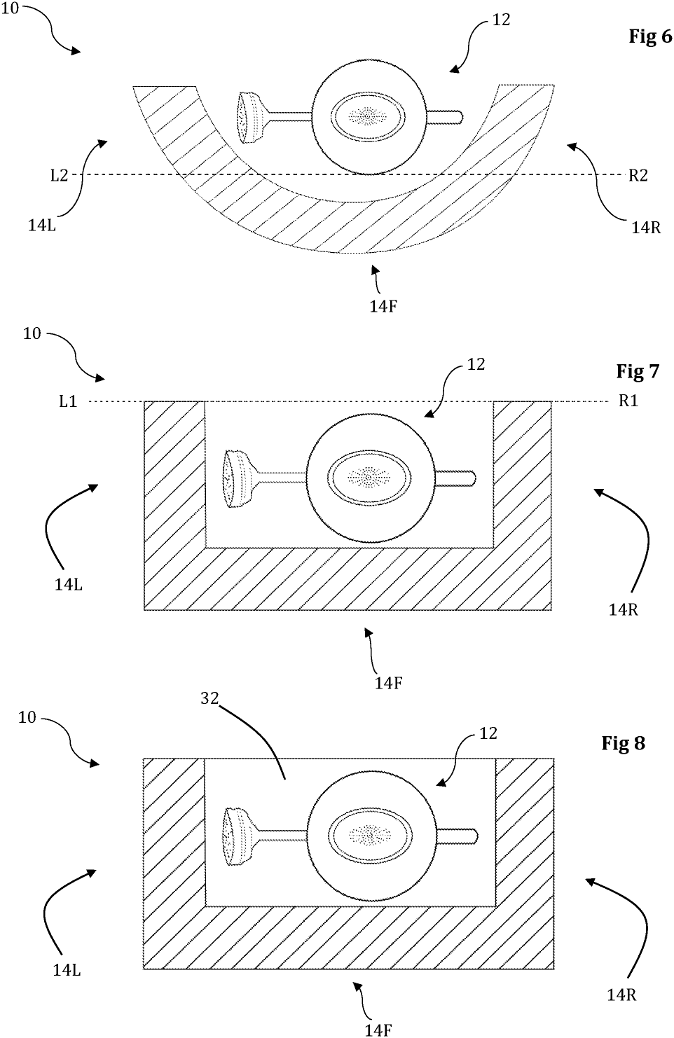

Preferably the blocking arrangement comprises: a left blocking portion 14L, to block view of a portion or a whole of the watering can, from a left view; and/or a right blocking portion 14R, to block view of a portion or a whole of the watering can, from a right view. (Various examples are shown of this in the drawings, and this is perhaps shown most demonstrably in FIGS. 6, 7, 8, 15, and 24). (Looking at FIG. 5, dashed line L2 (which (which could also be considered to be dashed line R2), denotes where the watering can ‘starts’, (from the left view, (and right view)). This line (L2, R2) is also shown in FIG. 6, to denote that this (and FIGS. 7 and 8) are also examples/representations of wherein there is a left blocking portion, (to block view of a portion or a whole of the watering can, from a left view); and a right blocking portion, (to block view of a portion or a whole of the watering can, from a right view). If the water catching apparatus is operable with a portion of the blocking arrangement blocking view of a portion or a whole of the watering can, from a left view, then that is considered to be an embodiment that comprises a left blocking portion, (to block view of a portion or a whole of the watering can, from a left view). If the water catching apparatus is operable with a portion of the blocking arrangement blocking view of a portion or a whole of the watering can, from a right view, then that is considered to be an embodiment that comprises a right blocking portion, (to block view of a portion or a whole of the watering can, from a right view). Thus line L2/R2 is relevant, (and hence is shown in FIGS. 6, 7, and 8). Thus line L2/R2, (shown in FIG. 6), helps to make clear that the examples/representations of FIGS. 6 to 8 are examples of wherein there is a left blocking portion, (to block view of a portion or a whole of the watering can, from a left view), and a right blocking portion, (to block view of a portion or a whole of the watering can, from a right view).

(Note: Disclosure is often provided, in the present application, of a ‘left blocking portion’,(to block view of a portion or a whole of the watering can, from a left view). It should be stated, any embodiment that comprises a blocking arrangement, to block view of a portion or a whole of the watering can, ‘from a left view’, is considered to comprise a ‘left blocking portion’,(to block view of a portion or a whole of the watering can, from a left view). (Thus any blocking arrangement that blocks view of a portion or a whole of the watering can, from a left view is considered to be an embodiment that comprises a ‘left blocking portion, (to block view of a portion or a whole of the watering can, from a left view). Thus these definitions may be used interchangeably, and, it should be stated, disclosure of/use of terminology of ‘ a left blocking portion’,(to block view of a portion or a whole of the watering can, from a left view), is considered to fully support, (eg in a claim), definition of ‘a blocking arrangement, to block view of a portion or a whole of the watering can, from a left view’. (So the same is the case for disclosure of, (and use of the term), ‘right blocking portion’,(to block view of a portion or a whole of the watering can, from a right view). Thus disclosure of/use of terminology of ‘a right blocking portion’,(to block view of a portion or a whole of the watering can, from a right view), is considered to fully support, (eg in a claim), definition of ‘a blocking arrangement, to block view of a portion or a whole of the watering can, from a right view’. (Thus any disclosure afforded to a ‘left blocking portion’,(to block view of a portion or a whole of the watering can, from a left view), supports such disclosure being afforded to ‘a blocking arrangement, to block view of a portion or a whole of the watering can, from a left view’). (Thus any disclosure afforded to a ‘right blocking portion’, (to block view of a portion or a whole of the watering can, from a right view), supports such disclosure being afforded to ‘a blocking arrangement, to block view of a portion or a whole of the watering can, from a right view’).

(Note: As stated elsewhere in the present application, whilst there is much disclosure, in the present application, of embodiments that comprise a left blocking portion, (to block view of a portion or a whole of the watering can, from a left view); and a right blocking portion, (to block view of a portion or a whole of the watering can, from a right view). However, it will be apparent that embodiments may be provided that comprise a left blocking portion, (to block view of a portion or a whole of the watering can, from a left view), but do not comprise a right blocking portion, (to block view of a portion or a whole of the watering can, from a right view), (and vice versa). And embodiments may be provided where there is a left blocking portion, and a right blocking portion, and where the left blocking portion and right blocking portion are not identical mirror versions of each other. Thus it should be stated, wherever there is disclosure, in the present application, of the blocking arrangement comprising left blocking portion ‘and’ a right blocking portion, it should be stated that such disclosure supports definition, (eg in a claim), of a blocking arrangement that comprises a left blocking portion, (whether or not it comprises a right blocking portion), and also supports definition, (eg in a claim), of a blocking arrangement that comprises a right blocking portion, (whether or not it comprises a left blocking portion). Thus any disclosure provided in the present application that discloses a left blocking portion ‘and’ a right blocking portion, (at least by virtue of this here statement), supports there being a left blocking portion ‘and/or’ a right blocking portion. Furthermore, where there is any disclosure relating to characteristics of the left blocking portion ‘and’ the right blocking portion, it should be stated that such disclosure supports definition, (eg in a claim), of the blocking arrangement comprising a left blocking portion with such characteristics, (whether or not the blocking arrangement comprising a right blocking portion with such characteristics, (and whether or not the blocking arrangement comprising a right blocking portion at all)). Similarly, where there is any disclosure relating to characteristics of the left blocking portion ‘and’ the right blocking portion, it should be stated that such disclosure supports definition, (eg in a claim), of the blocking arrangement comprising a right blocking portion with such characteristics, (whether or not the blocking arrangement comprising a left blocking portion with such characteristics, (and whether or not the blocking arrangement comprising a left blocking portion at all))

Preferably, in a water catching mode, the blocking arrangement blocks view of at least a quarter of a main body of the watering can, from the left view. (Various examples are shown of this). Preferably, in a water catching mode, the blocking arrangement blocks view of at least a half of a main body of the watering can, from the left view. (Various examples are clearly shown of this, (and example are in fact clearly shown where the blocking arrangement blocks most, (ie more than half), of the main body of the watering can, from the left view). Preferably, in a water catching mode, the blocking arrangement blocks view of at least three quarters of a main body of the watering can, from the left view. Preferably, in a water catching mode, the blocking arrangement blocks view of a whole of a main body of the watering can, from the left view. Preferably, in a water catching mode, the blocking arrangement blocks view of a whole of the watering can, from the left view.

Preferably, in a water catching mode, the blocking arrangement blocks view of at least a quarter of a main body of the watering can, from the right view. (Various examples are shown of this). Preferably, in a water catching mode, the blocking arrangement blocks view of at least a half of a main body of the watering can, from the right view. (Various examples are clearly shown of this, (and example are in fact clearly shown where the blocking arrangement blocks most, (ie more than half), of the main body of the watering can, from the right view). Preferably, in a water catching mode, the blocking arrangement blocks view of at least three quarters of a main body of the watering can, from the right view. Preferably, in a water catching mode, the blocking arrangement blocks view of a whole of a main body of the watering can, from the right view. Preferably, in a water catching mode, the blocking arrangement blocks view of a whole of the watering can, from the right view.

Preferably the left blocking portion, at its highest point, is equal to or higher than height of half height of a main body of the watering can; and the right blocking portion, at its highest point, is equal to or higher than height of half height of the main body of the watering can.

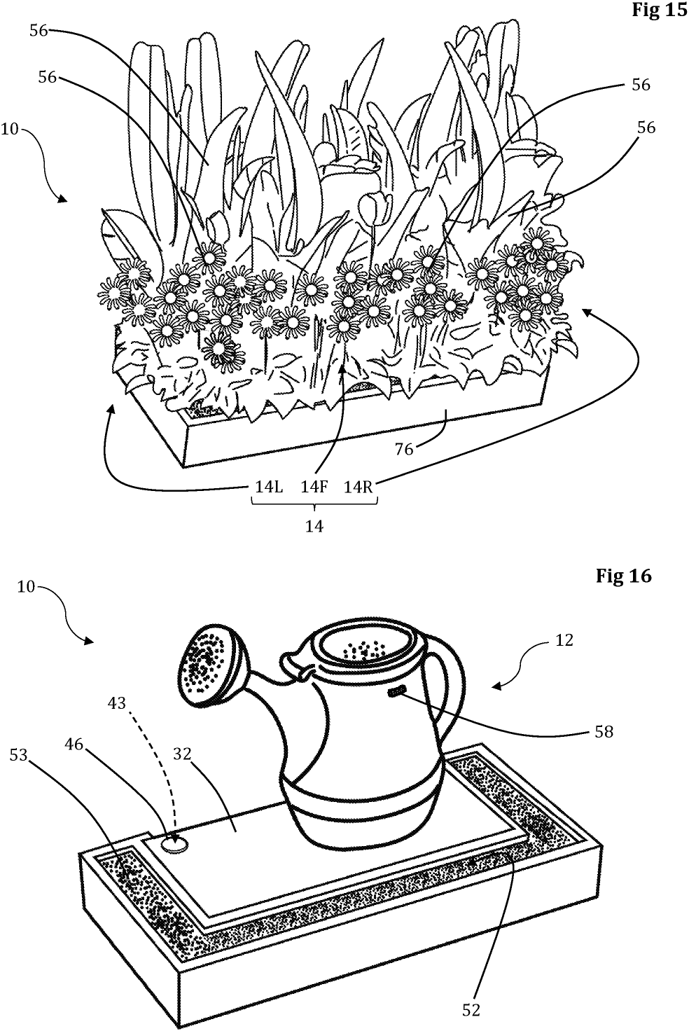

(Examples are clearly shown/alluded to of wherein the water catching apparatus is operable with the left blocking portion, at its highest point, being equal to or higher than height of half height of a main body of the watering can; and the right blocking portion, at its highest point, being equal to or higher than height of half height of the main body of the watering can. (FIG. 15, for example, is a good example of this).

Preferably the left blocking portion, at its highest point, is equal to or higher than height of three quarters height of a main body of the watering can; and/or the right blocking portion, at its highest point, is equal to or higher than height of three quarters height of the main body of the watering can.

Preferably the left blocking portion, at its highest point, is equal to or higher than height of a highest point of a main body of the watering can; and the right blocking portion, at its highest point, is equal to or higher than height of a highest point of the main body of the watering can.

Preferably the left blocking portion, at its highest point, is equal to or higher than height of a highest point of a main body of the watering can; and the right blocking portion, at its highest point, is equal to or higher than height of a highest point of the main body of the watering can.

Preferably the left blocking portion, at its highest point, is equal to or higher than height of a highest point of the watering can; and the right blocking portion, at its highest point, is equal to or higher than height of a highest point of the watering can.

Looking at dashed line L1/R1 in FIG. 7, it is clear this line denotes, in the example, how far back the left blocking portion and the right blocking portion go. (Thus, it shows a ‘furthest back point’ of the example left blocking portion, and a ‘furthest back point’ of the example right blocking portion. (It should be noted, in the example, the left blocking portion and the right blocking portion go back, to the same extent, (ie go back as far as each other). However, it should be stated, an example could be provided wherein there is a left blocking portion and a right blocking portion, but their ‘furthest back point’ is not ‘equal’, (ie one goes further back than the other). In such an example, this could be denoted, therefore, by different dashed line, (one for the left blocking portion, and one for the right blocking portion). But in the example of FIG. 7, the left blocking portion and the right blocking portion go back, to the same extent. (It should also be stated, it is feasible an embodiment could be provided wherein the blocking arrangement comprises a left blocking portion, (to block view of a portion or a whole of the watering can, from a left view), but not a right blocking portion, (to block view of a portion or a whole of the watering can, from a right view). Similarly, it is feasible an embodiment could be provided wherein the blocking arrangement comprises a right blocking portion, (to block view of a portion or a whole of the watering can, from a right view), but not a left blocking portion, (to block view of a portion or a whole of the watering can, from a left view). This various options and/or embodiments are possible. (Note: With this point in mind, it should be clearly stated that, whenever, in the present application, disclosure is afforded to both the left blocking portion ‘and’ the right blocking portion, it should clearly be stated that this, for the sake of the present application, is deemed support, (eg for a claim), for such definition, relating to only one of the left blocking portion/right blocking portion, (rather than both). For example, if it is disclosed that the left blocking portion and the right blocking portion, at their furthest back point, are level or further back than a main body of the watering can, then this, for the sake of the present application, is deemed support, (eg for a claim), for there being a left blocking portion that, at its furthest back point, is level or further back than a main body of the watering can ‘and/or’ a right blocking portion that, at its furthest back point, is level or further back than a main body of the watering can. This point is therefore clearly made, and stated. (One of the reasons this may be important is that embodiments could be provided, (eg for being used at corner between two walls of a building), where there is only a left blocking portion, or only a right blocking portion, for example. (Therefore, in short, disclosure relating to a left blocking portion ‘and’ a right blocking portion supports (eg a claim for) (disclosure relating to) a left blocking portion ‘and/or’ a right blocking portion supports. (Thus a claim only including a ‘left blocking portion’,for example, or only including a ‘right blocking portion’,is supported)). To make clear, wherever, in the present application, disclosure is afforded to both a left blocking portion ‘and’ a right blocking portion of the blocking portion, that supports, (eg in a claim), such definition being provided for the left brushing portion, (whether or not there is a right brushing portion), and supports, (eg in a claim), such definition being provided for the right brushing portion, (whether or not there is a left brushing portion). Furthermore, wherever disclosure is provided, (in the present application), with reference to left ‘and’ right, it supports a claim relating to only left, or only right. Thus, for example, if it is stated that the blocking arrangement 14 blocks view of a portion or a whole of the watering can, from the left view, ‘and’ blocks view of a portion or a whole of the watering can, from the right view, that is considered, for the sake of the present application, to support a claim that defines that the blocking arrangement blocks view of a portion or a whole of the watering can, from the left view. It is also considered, for the sake of the present application, to support a claim that defines that the blocking arrangement blocks view of a portion or a whole of the watering can, from the right view. (Furthermore, for the sake of the present application, if it is disclosed that the blocking arrangement comprises a left blocking portion, (to block view of a portion or a whole of the watering can, from a left view), ‘and’ a right blocking portion, (to block view of a portion or a whole of the watering can, from a right view, that is considered, for the sake of the present application, to support a claim that defines that the blocking arrangement comprises a left blocking portion, (to block view of a portion or a whole of the watering can, from a left view). It is also considered, for the sake of the present application, to support a claim that defines that the blocking arrangement comprises a right blocking portion, (to block view of a portion or a whole of the watering can, from a right view). Thus various options and/or embodiments are possible).

Preferably the blocking arrangement, at its furthest point back, is as far back as, or further back than, half of a main body of the watering can. Various examples are shown of this. For example, looking at FIG. 6, for example, (and to help explain), if it is imagined a point was made/shown at a centre point of the example main body 16 of the watering can 12 of FIG. 6, it can be seen that the blocking arrangement, in the example, at its furthest point back, is significantly further back than that point. Thus it is clear that this is an example of wherein the blocking arrangement, at its furthest point back, is further back than half of the main body of the watering can. (Examples are shown wherein the blocking arrangement, at its furthest point back, is as far back as, or further back than, half of the watering can). (Preferably the blocking arrangement, at its furthest point back, is as far back as, or further back than, a whole of the main body of the watering can). (Preferably the blocking arrangement, at its furthest point back, is as far back as, or further back than, a whole of the watering can).

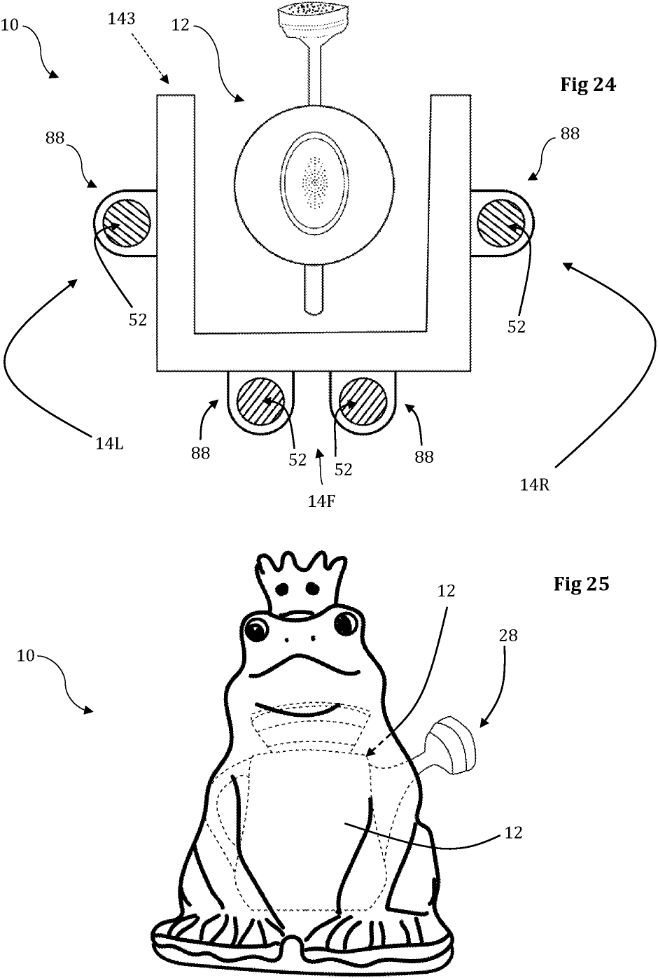

Preferably the left blocking portion, from a left view, at its furthest back point, is as far back as, or further back than, half of a main body of the watering can. (FIGS. 6, 7, 8, for example, (and FIGS. 15 and 24), perhaps show this most demonstrably). (Examples are shown wherein the left blocking portion, at its furthest point back, is as far back as, or further back than, half of the watering can). Preferably the right blocking portion, from a right view, at its furthest back point, is as far back as, or further back than, half of a main body of the watering can. (FIGS. 6, 7, 8, for example, (and FIGS. 15 and 24), perhaps show this most demonstrably). (Examples are shown wherein the right blocking portion, at its furthest point back, is as far back as, or further back than, half of the watering can). Preferably the left blocking portion, from a left view, at its furthest back point, is level with or further back than a whole of the main body of the watering can. (Examples are shown wherein the left blocking portion, at its furthest point back, is as far back as, or further back than, a whole of the watering can). Preferably the right blocking portion, from a right view, at its furthest back point, is level with or further back than a whole of the main body of the watering can. (Examples are shown wherein the right blocking portion, at its furthest point back, is as far back as, or further back than, a whole of the watering can). (FIG. 24 shows an example of wherein the left blocking portion and the right blocking portion, at their furthest point back, are further back than a whole of the main body 16 of the watering can, but are not further back than the whole of the watering can)).

(Examples are shown wherein the blocking arrangement, (from a front view), at its furthest left point, is as far left as, or further left than, a furthest left point of a main body of the watering can. (Examples are shown of wherein the blocking arrangement, (from a front view), at its furthest left point, is as far left as, or further left than, a furthest left point of the watering can). Examples are shown wherein the blocking arrangement, (from a front view), at its furthest right point, is as far right as, or further right than, a furthest right point of a main body of the watering can. (Examples are shown wherein the blocking arrangement, (from a front view), at its furthest right point, is as far right as, or further right than, a furthest right point of the watering can)).

Preferably, at any point, (the term ‘at any point’ here being a broad term), the blocking arrangement, from a front view, in front of the watering can, is at least half width of the main body of the watering can. (Examples are provided of wherein, at any point, the blocking arrangement, from a front view, in front of the watering can, is at least half width of the watering can). (Examples are provided of wherein, at any point, the blocking arrangement, from a front view, in front of the watering can, is more than half width of the main body of the watering can. (Examples are provided of wherein, at any point, the blocking arrangement, from a front view, in front of the watering can, is more than half width of the watering can). Preferably, at any point, the blocking arrangement, from a front view, in front of the watering can, is at least three quarters width of the main body of the watering can. (Examples are provided of wherein, at any point, the blocking arrangement, from a front view, in front of the watering can, is at least three quarters width of the watering can). Preferably, at any point, the blocking arrangement, from a front view, in front of the watering can, is as wide as, or wider than, width of the main body of the watering can. (Examples are provided of wherein, at any point, the blocking arrangement, from a front view, in front of the watering can, is as wide, or wider than, width of the watering can). Preferably, at any point, the blocking arrangement, from a left view, in front of the watering can from the left view, is at least half width of the main body of the watering can. (Examples are provided of wherein, at any point, the blocking arrangement, from a left view, in front of the watering can from the left view, is at least half width of the watering can). (Examples are provided of wherein, at any point, the blocking arrangement, from a left view, in front of the watering can from the left view, is more than half width of the main body of the watering can. (Examples are provided of wherein, at any point, the blocking arrangement, from a left view, in front of the watering can from the left view, is more than half width of the watering can). Preferably, at any point, the blocking arrangement, from a left view, in front of the watering can from the left view, is at least three quarters width of the main body of the watering can. (Examples are provided of wherein, at any point, the blocking arrangement, from a left view, in front of the watering can from the left view, is at least three quarters width of the watering can). Preferably, at any point, the blocking arrangement, from a left view, in front of the watering can from the left view, is as wide as, or wider than, width of the main body of the watering can. (Examples are provided of wherein, at any point, the blocking arrangement, from a left view, in front of the watering can from the left view, is as wide, or wider than, width of the watering can). Preferably, at any point, the blocking arrangement, from a left view, in front of the watering can from the left view, is at least half width of the main body of the watering can. (Examples are provided of wherein, at any point, the blocking arrangement, from a left view, in front of the watering can from the left view, is at least half width of the watering can). (Examples are provided of wherein, at any point, the blocking arrangement, from a left view, in front of the watering can from the left view, is more than half width of the main body of the watering can. (Examples are provided of wherein, at any point, the blocking arrangement, from a left view, in front of the watering can from the left view, is more than half width of the watering can). Preferably, at any point, the blocking arrangement, from a left view, in front of the watering can from the left view, is at least three quarters width of the main body of the watering can. (Examples are provided of wherein, at any point, the blocking arrangement, from a left view, in front of the watering can from the left view, is at least three quarters width of the watering can). Preferably, at any point, the blocking arrangement, from a left view, in front of the watering can from the left view, is as wide as, or wider than, width of the main body of the watering can. (Examples are provided of wherein, at any point, the blocking arrangement, from a left view, in front of the watering can from the left view, is as wide, or wider than, width of the watering can). (And it should be said, (with reference to the front view and/or left view and/or right view), rather than ‘at any point’, more limited definition may be afforded, such as, for example, ‘in total, for an amount that is at least a quarter of total height of the main body of the watering can, (or total height of the watering can), (or, rather than ‘at least a quarter’, more limited definition may be afforded, such as, ‘at least half’, or ‘morethan half or ‘at least three quarters, or ‘a whole, or more’. To explain, if the watering can is twelve inches tall, and it is stated that, in total, the blocking arrangement, from a front view, for an amount that is at least a half of total height of the watering can is at least half width of the watering can, then for a total of at least six inches, (ie either for a continuous amount that is six inches or more, or in a plurality of amounts that are not continuous, but together total at least six inches, the blocking arrangement, from a front view, is at least half width of the watering can.

(Examples are shown of wherein, at any point, the left blocking portion spans a whole width of a main body of the watering can, from the left view. Examples are shown of wherein, at any point, the right blocking portion spans a whole width of a main body of the watering can, from the right view. (Examples are shown of wherein, at any point, the left blocking portion spans a whole width of the watering can, from the left view. Examples are shown of wherein, at any point, the right blocking portion spans a whole width of the watering can, from the right view)).

Examples are shown, (provided simply by way of example only), within a scope of wherein, at any point, the blocking arrangement spans a whole width of a main body of the watering can, from the left view. (Examples are shown/provided that are within a scope of wherein, at any point, the blocking arrangement spans a whole width of the watering can, from the left view). Examples are shown within a scope of wherein, at any point, the blocking arrangement spans a whole width of a main body of the watering can, from the right view. (Examples are shown/provided that are within a scope of wherein, at any point, the blocking arrangement spans a whole width of the watering can, from the right view). (Examples are shown within a scope of wherein, at any point, the blocking arrangement spans a whole width of a main body of the watering can, from the left view; and at any point, the blocking arrangement spans a whole width of a main body of the watering can, from the right view. (Examples are shown/provided that are within a scope of wherein, at any point, the blocking arrangement spans a whole width of the watering can, from the left view; and at any point, the blocking arrangement spans a whole width of the watering can, from the right view).

Examples are shown, (provided simply by way of example only), within a scope of wherein the blocking arrangement spans a whole width of the main body of the watering can, at least up to height of half height of the main body, from the left view. (Examples are provided of wherein the blocking arrangement spans a whole width of the watering can, at least up to height of half height of the watering can, from the left view). Examples are shown within a scope of wherein the blocking arrangement spans a whole width of the main body of the watering can, at least up to height of half height of the main body, from the right view. (Examples are provided of wherein the blocking arrangement spans a whole width of the watering can, at least up to height of half height of the watering can, from the right view). (Examples are shown within a scope of wherein the blocking arrangement spans a whole width of the watering can, at least up to height of half height of the main body, from the left view. Examples are shown within a scope of wherein the blocking arrangement spans a whole width of the watering can, at least up to height of half height of the main body, from the right view).

Examples are shown within a scope of wherein the blocking arrangement spans a whole width of the main body of the watering can, at least up to height of three quarters height of the main body, from the left view. (Examples are provided of wherein the blocking arrangement spans a whole width of the watering can, at least up to height of three quarters height of the watering can, from the left view). Examples are shown within a scope of wherein the blocking arrangement spans a whole width of the main body of the watering can, at least up to height of three quarters height of the main body, from the left view. (Examples are provided of wherein the blocking arrangement spans a whole width of the watering can, at least up to height of three quarters height of the watering can, from the right view).

(Examples are shown within a scope of wherein the blocking arrangement spans a whole width of the watering can, at least up to height of three quarters height of the main body, from the left view. Preferably the blocking arrangement spans a whole width of the watering can, at least up to height of three quarters height of the main body, from the left view).

Examples are shown within a scope of wherein the blocking arrangement spans a whole width of the main body of the watering can, at least up to height of a highest point of the main body, from the left view. (Examples are provided of wherein the blocking arrangement spans a whole width of the watering can, at least up to height of a highest point of the watering can, from the left view). Examples are shown within a scope of wherein the blocking arrangement spans a whole width of the main body of the watering can, at least up to height of a highest point of the main body, from the right view. (Examples are provided of wherein the blocking arrangement spans a whole width of the watering can, at least up to height of a highest point of the watering can, from the right view). (Examples are shown within a scope of wherein the blocking arrangement spans a whole width of the watering can, at least up to height of a highest point of the main body, from the left view. Preferably the blocking arrangement spans a whole width of the watering can, at least up to height of a highest point of the main body, from the right view).

(Example(s) are shown of wherein the blocking arrangement blocks view of a whole of a main body of the watering can, from the left view; and the blocking arrangement blocks view of a whole of a main body of the watering can, from the right view. (FIG. 15 perhaps shows an example of this most demonstrably)).

(Example(s) are shown of wherein the blocking arrangement blocks view of a whole of the watering can, from the left view; and the blocking arrangement blocks view of a whole the watering can, from the right view. (FIG. 15 perhaps shows an example of this most demonstrably)).

(Example(s) are shown of wherein the blocking arrangement blocks view of a portion or a whole of the watering can, from the left view. Example(s) are shown of wherein the blocking arrangement blocks view of a portion or a whole of the watering can, from the right view.

(Example(s) are shown of wherein the blocking arrangement blocks view of a portion or a whole of a main body of the watering can, from the left view. Example(s) are shown of wherein the blocking arrangement blocks view of a portion or a whole of a main body of the watering can, from the right view)).

Preferably, the water catching apparatus 10 comprises a portion 32 for the watering can, in the water catching position, to be positioned on. (Various examples are shown of this in the drawings, eg FIG. 8, for example, is an example, and the embodiments of FIGS. 10 to 22 are also examples of this). (Looking at these examples, it can clearly be seen that, in the water catching position, (eg now looking at FIG. 16, for example), a portion or a whole of a main body of the watering can, from a top view, is within a perimeter of the portion 32 that the watering can is positioned on). (It is clearly an example of wherein a portion or a whole of a main body of the watering can, from a top view, is within a perimeter of the apparatus that the watering can is positioned on). (FIG. 16 is a good view of an example of wherein the water catching apparatus 10 comprises a portion 32 that the watering can, in the water catching position, is positioned on). Looking at the embodiments of FIGS. 15-22, there is shown an example part 33. (In the example, part 33 comprises the portion 32 for the watering can, in the water catching position, to be positioned on). In the example, there is also shown an example part 35. (In the example, part 35 plays a role, relating to blocking). Part 33, in the example, does not comprise a portion of the blocking arrangement, (to block view of a portion or a whole of the watering can), (and does not comprise a whole of the blocking arrangement. However, it should be stated, (eg in other embodiments), it may, or may not, comprise a portion or a whole of the blocking arrangement, (to block view of a portion or a whole of the watering can). (It may, or may not, comprise a portion or a whole of the front blocking portion of the blocking arrangement, (to block view of a portion or a whole of the watering can, from the front view)). (It may, or may not, comprise a portion or a whole of the left blocking portion of the blocking arrangement, (to block view of a portion or a whole of the watering can, from the left view)). (It may, or may not, comprise a portion or a whole of the right blocking portion of the blocking arrangement, (to block view of a portion or a whole of the watering can, from the right view). To explain what is intended by this, it will be apparent, looking at FIG. 11, for example, (taken purely by way of example only, out of the Figures), that it is feasible that (a portion or a whole of) the portion 32 the watering can is positioned on, (the watering can being depicted in a water catching position), may be provided as one part with a portion or a whole of feature 35. (It t may be provided as one part with a portion or a whole of the same apparatus/part that provides a portion or a whole of the blocking arrangement, (which is shown generically, in those Figures). For example, imagining the front blocking portion is made of ceramic, for example, (eg a ceramic ‘mural-type’ scene being used, to block view of a portion or a whole of the watering can, for example), it will be apparent, (looking at the example of FIG. 11, for example, (taken by way of example only)), that the example portion 32 that the example watering can is positioned on, may be part of the same apparatus that comprises a portion or a whole of the blocking arrangement, (ie, in the example in FIG. 11, may form part of a portion or a whole of the example front blocking portion). It should also be stated, rather than the apparatus the watering can is positioned on itself comprising a portion or a whole of the blocking arrangement, it may, broadly speaking, ‘play a role in’ the blocking arrangement. For example, it may, itself, not block view of any portion of the watering can, but may, for example, provide a ‘base’ for a portion or a whole of the blocking arrangement. For example, the apparatus the watering can is positioned on may comprise a planting area(s), for example, into which a plant(s) is planted, to thus block view of a portion or a whole of the watering can. In another example, it may provide a base for a figure/item, (eg a (ceramic) gnome, or frog, for example), to go on top of. Thus, again, this would be an example of wherein the apparatus the watering can is positioned on itself ‘plays a role in’ the blocking arrangement. (This may involve the front blocking portion and/or the left blocking portion and/or the right blocking portion). Broadly put, the part/apparatus the watering can is positioned on, (in the water catching position), may itself, feasibly, have a portion or a whole of the blocking arrangement positioned on it. (This would include, for example, if plant(s) are planted into it, or if any item(s), (eg ceramic figure(s), for example), are positioned on it. Thus various options and/or embodiments are possible, and this will be apparent, in light of the nature of the present application.

(Examples are shown of the system for catching rainwater, wherein, in the water catching position, the watering can is positioned on an apparatus. (Looking at the examples, it can clearly be seen that, in the water catching position, (eg now looking at FIG. 16, for example), a portion or a whole of a main body of the watering can, from a top view, is within a perimeter of the apparatus that the watering can is positioned on). (Various examples are shown of this in the drawings). The apparatus the watering can is positioned on, in the water catching position, may, or may not, comprise a portion or a whole of the blocking arrangement, (to block view of a portion or a whole of the watering can).

(Note: Wherever, in the present application, phrases are used such as ‘the apparatus may comprise ‘a portion or a whole of the blocking arrangement”, when the broad term is used, (ie ‘a portion or a whole of the blocking arrangement’, it includes within its scope, (and is herein stated as providing support for), ‘a portion or a whole of a front blocking portion of the blocking arrangement’, and/or ‘a portion or a whole of a left blocking portion of the blocking arrangement’, and/or ‘a portion or a whole of a right blocking portion of the blocking arrangement’).

To explain what is meant by a portion or a whole of a main body of the watering can, from a top view, being within a perimeter of the apparatus that the watering can is positioned on, looking at FIG. 8, (or FIG. 16, for example, which is another good example), for example, it can clearly be seen that, from the top view shown, (top ‘view’ here being subject to the same ‘rules’ as have been explained with reference to ‘front view’ and ‘left/right view’, but now relating to a ‘top’ view, (from above)), a portion or a whole, (and, in fact, in the example embodiment, a ‘whole’), of the main body of the watering can is within a perimeter of the apparatus it is positioned on. (It would also be within a scope of ‘ a portion or a whole of the main body of the watering can being within a perimeter of the apparatus it is positioned on’ if just a portion, (but not a whole) of the main body, from the top view, was within a perimeter of the apparatus it is positioned on, (eg if some of the main body, was hanging over the edge of the apparatus it is positioned on, outside the perimeter of the apparatus it is positioned on, (from the top view)). (Various examples are shown in the Figures of a portion or a whole of a base 34 of the watering can being positioned on an apparatus. (FIG. 16, for example, is a good example/view of a base of a watering can sitting on an apparatus)).

Preferably, the system for catching rainwater comprises a positioning system, to keep the watering can positioned in the water catching position. (Various examples are shown of a positioning system, configured to keep the watering can positioned in the water catching position, which will be explored. (Various examples are shown of a rainwater catching apparatus, comprising a positioning system, to keep the watering can positioned in the water catching position).

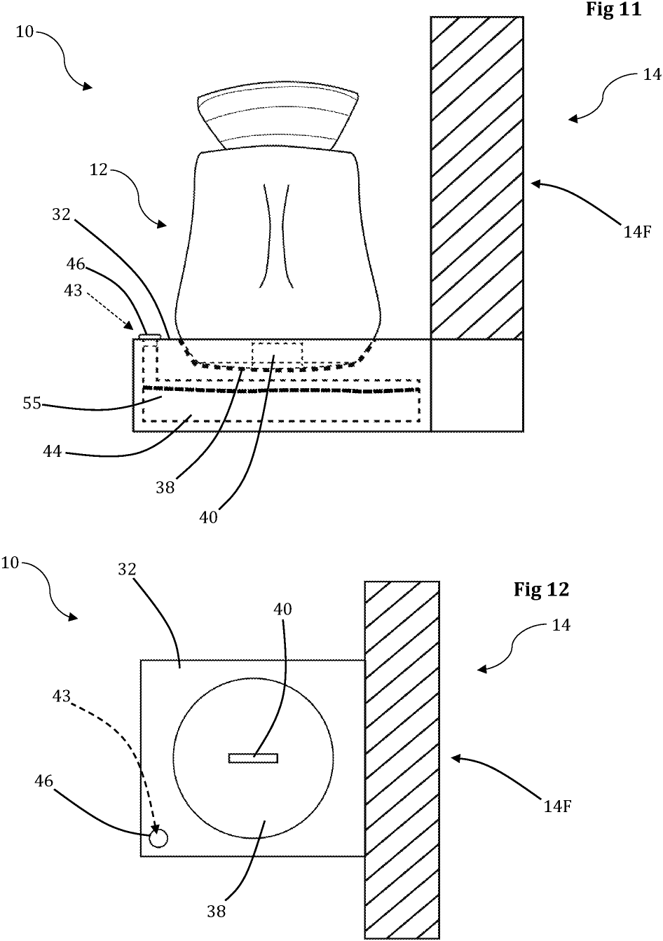

There are various ways in which a positioning system may keep the watering can positioned in the water catching position. For example, (in an embodiment wherein there is a portion that the watering can is positioned on, in the water catching position), the positioning system may include/comprise that the portion the watering can is positioned on comprises a receiving portion, to receive a portion of the watering can. An example embodiment(s) of this is shown, for example, in FIGS. 11, 12 and 14, where there is shown an example receiving portion 38. A portion of the watering can is shown being received into the example receiving portion 38. In the example, a base of the watering can is shown received into the example receiving portion. Thus it will be apparent that this can help keep the watering can in a desired position. (This is thus within a scope of wherein at least one of: the portion the watering can is positioned on, in the water catching position, comprises a receiving portion, to receive a portion of the watering can; and the watering can comprises a receiving portion, to receive a portion of the portion that the watering can is positioned on, in the water catching position). (It should be stated, whilst preferably a whole of a main body of the watering can is, from a top view, within a perimeter of the apparatus the watering can is positioned on, it should be stated, (even with reference to there being a receiving portion that receives a portion of the watering can), it is possible this is not the case. For example, looking at FIG. 12, for example, and the example receiving portion 38, it will be noted that the example receiving portion 38, (provided simply by way of example only), is circular in shape. If it is now imagined that the receiving portion, rather than forming a full circular shape well within the perimeter of the apparatus that comprises it, instead if further left (from the view shown in the Figure), such that the circular shape does not ‘complete’ itself, but instead is positioned so that, for example, a (small) portion of the base of the watering can hangs over an edge of the apparatus it is positioned on, when received by the receiving portion. It will be apparent that such an embodiment could be provided, and could still nevertheless do its job/perform its function. Thus whilst preferably a whole of a main body of the watering can is, from a top view, within a perimeter of the apparatus the watering can is positioned on, it should be stated, (even with reference to there being a receiving portion that receives a portion of the watering can), it is possible this is not the case.

Another way the positioning system may facilitate keeping the watering can positioned in the water catching position, (and a particularly preferred embodiment/method), is via mating. ‘Mating’ is here defined as there being a ‘male’ feature that is received by a ‘female’ feature. Now looking at FIGS. 11-22, for example, good examples of wherein the positioning system comprises/includes mating are shown. There is shown an example protruding portion 40, (male feature), and an example receiving portion 42, (female feature), that receives the example protruding portion. In FIGS. 11 and 14, (as well as in FIGS. 15, 16 and 22), the protruding portion 40 and the receiving portion 42 are ‘mated’. This is a good method of facilitating keeping the watering can in the water catching position. (In the example embodiment, it is the watering can that comprises the receiving portion 42, (female feature), and the portion that the watering can is positioned on, (in the water catching position), that comprises the protruding portion 40, (male feature). However, it should be stated that it is possible the reverse could be provided, with the watering can comprising the protruding portion, (male feature), and the portion that the watering can is positioned on, (in the water catching position), comprising the receiving portion, (female feature). (It is even possible that the watering can and the portion that the watering can is positioned on may each comprise both a male feature(s), (that is received by a female feature(s), of the other), and female feature(s), (that receives a male feature(s), of the other). Thus it is feasible that the watering can and the portion that the watering can is positioned on may each comprise both a protruding portion(s), (that is received by a receiving portion(s), of the other), and a receiving portion(s), (that receives a protruding portion(s), of the other). (It should also be stated, it is feasible the watering can could comprise a plurality of male features, with the portion that the watering can is positioned on comprising a plurality of female features, (or vice versa)). Thus various options and/or embodiments are possible). Thus an example(s) is provided/shown of wherein the positioning system includes/comprises a protruding portion (male feature) being received by a receiving portion (female feature). Thus an example(s), (provided simply by way of example only), is provided of a mating arrangement.

(Note, it is feasible ‘mating’ could occur, not limited to being mating between the watering can and a portion that the watering can is positioned on. For example, a watering can could be adjacent to a portion of an apparatus, and could ‘mate’ with it, (ie male feature being received by a female feature), but not with the watering can being positioned on the portion of the apparatus. For example, (taken simply by way of example only), a protruding portion could extend, (eg substantially sideways/horizontally, for example), from a portion of the water catching apparatus, (at any (relevant) place/position), and this could be received by a receiving portion of a watering can, (eg the receiving portion being generally at a ‘side’ of the watering can). Thus this would be mating. (However, it will be apparent that mating between the watering can and a portion that the watering can is positioned on, (in the water catching position), can be particularly effective).

(Note: Where two features, (eg Feature A and Feature B) are mated, the term ‘male-female’, (eg ‘male-female mating’ or ‘male-female arrangement’, for example), includes within its scope Feature A comprising the male feature(s), and Feature B comprising the female feature(s), and also includes within its scope Feature A comprising the female feature(s), and Feature B comprising the male feature(s). (Effectively, then, the term ‘male-female’ is considered, for the sake of the present application, to include within its scope ‘male-female’ mating, and ‘female-male’ mating). It should also be said that disclosure of one, (eg Feature A comprising the male feature(s), and Feature B comprising the female feature(s)), is considered, for the sake of the present application, to provide support for the other, (ie it would thus support where Feature A comprises the female feature(s), and Feature B comprises the male feature(s))).

Another way the positioning system may facilitate keeping the watering can positioned in the water catching position is via the watering can being removably attachable. An example of this, (ie of the watering can being removably attachable), is denoted/shown in FIG. 14. An example attachment arrangement 19 is shown, (shown by way of example only), (to facilitate the watering can being removably attachable). In the example, the example watering can is removably attachable ‘directly’ to the blocking arrangement itself. However, in other embodiments, it may be removably attachable ‘directly’ to any other part(s)/feature(s) of the apparatus. (Thus the example is provided by way of example only). (For example, (in embodiments wherein there is a portion for the watering can to be positioned on, in the water catching position), the watering can could be removably attachable ‘directly’ to the portion that it is positioned on). (All of these fall within the scope of the watering can being removably attachable). (If the watering can is removably attachable, it may be removably attachable to any part(s)/feature(s) of the apparatus). It will be apparent that there are many possible options and/or embodiments, to facilitate removable attachability. Thus various options and/or embodiments are possible. (Thus an example is shown of wherein the watering can is removably attachable, into the water catching position). (It should be stated, the example attachment arrangement (to facilitate the removable water collecting apparatus being removably attachable) is shown by way of example only, and it will be apparent that there are a vast array of feature(s)/method(s)/way(s) that may be used, to facilitate removably attachability. For example, the (or any) attachment arrangement may comprise a clipping arrangement(s), (thus it may ‘clip’ in place, to attach it), and/or a clamping arrangement(s), (thus it may ‘clamp’ in place, to attach it), and/or a magnetic solution(s), etc, etc. Thus what is shown is provided by way of example only. It will be apparent that various options and/or embodiments are possible)).

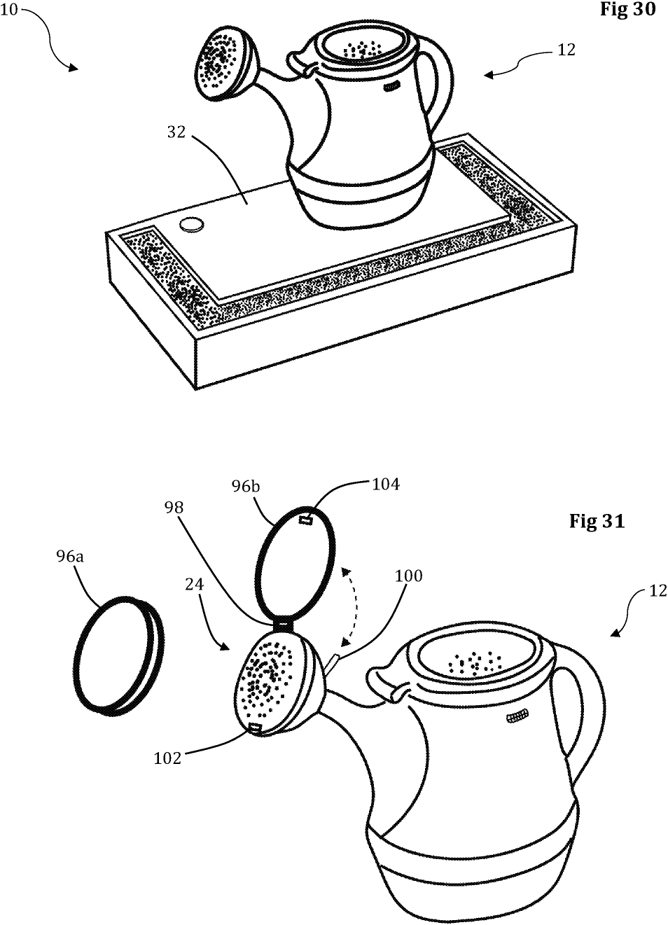

Another way the positioning system may facilitate keeping the watering can positioned in the water catching position, is via blocking. Thus a blocking arrangement may be provided, to block movement of the watering can, (to keep the watering can in the water catching position). (This may also be referred to as a ‘stopping arrangement, to stop movement of the watering can, (to keep the watering can in the water catching position). An example of this is shown in FIG. 29. An example area 90 is shown, that the watering can can go into. Dashed arrow A1 denotes that the watering can can go into the example area 90. Once the watering can is in the area 90, example wall 92 blocks movement of the watering can. (It will be apparent that this can be used, to keep the watering can in the water catching position). (It should be noted that, in the example embodiment of FIG. 29, (provided by way of example only), the example area is fairly small, (with reference to the example watering can, (thus allowing for little or no movement of the watering can, once it is in the example area 90. However, it should be noted, in other embodiments, the area may be far bigger. In other embodiments, the area may be far bigger, relative to the watering can. For example, it may be double the size, compared to what is shown in FIG. 29, for example. Thus some movement of the watering can may be possible, in such embodiments. (Nevertheless, a blocking arrangement, to block movement of the watering can, can still be effective, in keeping the watering can in the water catching position). So it should also be stated, whilst, in the example embodiment, the area is generally round, (and generally matches shape of the (main body of the) watering can, in other embodiments, it may, or may not, be round, and may be any shape. For example, the area 90 may be square, for example, or rectangular, for example, or any shape.

Preferably, there is a portion 32 for the watering can to be positioned on, (when in the area). However, it is feasible the area is ‘open’ at an underside, and that the watering can simply goes on the ground, when inside the area.

It should be stated, whilst there is only one wall 92 in the example, (to facilitate blocking movement of the watering can), in other embodiments, there may be a plurality of walls, (to facilitate blocking movement of the watering can). For example, if the area 90 is rectangular, or square, for example, there may be four walls, for example, (eg a front wall, a back wall, a left wall and a right wall. In other embodiments, other features may do some or all of the blocking. For example, in one embodiment, plant(s), (eg that play a blocking role in the front blocking portion), may block forward movement of the watering can. There may then be a wall(s) to block backward, left and right movement of the watering can. (This is just one example, and various combinations/permutations of features may be possible).

Furthermore, it should be stated, even in an embodiment such as that shown in FIG. 29, there could be a plurality of walls, (rather than just one). Thus there could be a plurality of walls, which, for example, form a circular arrangement/shape, (rather than just one wall in a circular shape, as shown). Thus various options and/or embodiments are possible.

It should also be stated, whilst the example embodiment of FIG. 29 is an example where the area 90 (and the watering can) is completely surrounded, other embodiments may be provided wherein this is not the case. For example, there may be a ‘gap’, (at the back of the water catching apparatus/blocking arrangement for blocking movement. (Thus it may not fully surround). The gap may be small enough such that the watering can is still blocked from moving. (In such example, example wall 92 may thus have a ‘gap’ at the back of the water catching apparatus. Thus this can still be effective as a blocking arrangement to block movement. (It should also be stated, a ‘gap(s)’ is not limited to being at the back, and may be at any point. Furthermore, there may be a plurality of gaps. Thus various options and/or embodiments are possible, and it will be apparent, in light of the present disclosure in the present application, that there are many options and/or embodiments, with regard to a positioning system, (to keep the watering can positioned in the water catching position). (Thus there are many options and/or embodiments, with regard to a positioning system, to position the watering can. Thus there are many options and/or embodiments, with regard to a positioning system, to keep the watering can in a (desired) position).

In the example embodiment of FIG. 29, there is shown an example planting area 52. (No soil or plants are shown planted in the planting area). However, in other embodiments, there may be a plurality of planting areas, for example, (and this will be apparent, in light of the present disclosure). Thus various options and/or embodiments are possible. Furthermore, this example, (wherein the blocking arrangement, to block view of a portion or a whole of the watering can), comprises plant(s) is provided by way of example only. In other examples, the blocking arrangement may not comprise plant(s). In other embodiments, the blocking arrangement may comprise other feature(s), (whether it also comprises plant(s), or not). For example, looking at the example embodiment of FIG. 24, it will be apparent that the watering can is blocked from moving forwards, left, and right. It will be apparent it could also, (in a slightly different embodiment), block movement backwards. Thus this can be achieved, and in an embodiment wherein there are no plants that play a blocking role. Thus various options and/or embodiments are possible.

In the embodiment shown, (provided simply by way of example only), there is a blocking arrangement that blocks the watering can from moving, limiting its movement. It will be apparent that this can be useful, to keep the watering can in the water catching position. A ‘blocking arrangement’ may use any feature(s) that carry out the function of blocking, even if those feature(s) also carry out other function(s), (eg blocking view of a portion or a whole of the watering can). (And/or, for example, comprising a planting area(s), for example). Blocking in forwards (and backwards) movement, will tend to be particularly important, since it will be apparent that, whilst rain may fall from a roof, (dependent on the roof’s length, etc), along a significant length, the area where rain falls, (in terms of forward/backward movement of the watering can), may be relatively small). In the example embodiment in FIG. 29, the blocking arrangement, (to block movement), comprises a front blocking portion, to block forward movement of the watering can. In the example embodiment in FIG. 29, the blocking arrangement, (to block movement), comprises a back blocking portion, to block backward movement of the watering can. (In the example embodiment in FIG. 29, the blocking arrangement, (to block movement), comprises a left blocking portion, to block left movement of the watering can. In the example embodiment in FIG. 29, the blocking arrangement, (to block movement), comprises a right blocking portion, to block right movement of the watering can). The embodiment provided is provided by way of example only, and it will be apparent that various options and/or embodiments are possible, for a blocking arrangement, to block movement of the watering can. (The example shown in FIG. 29 is an example of wherein there is a blocking arrangement, to block movement of the watering can, comprising a front blocking portion, to block forward movement of the watering can. The example shown in FIG. 29 is an example of wherein there is a blocking arrangement, to block movement of the watering can, comprising a left blocking portion, to block left movement of the watering can. The example shown in FIG. 29 is an example of wherein there is a blocking arrangement, to block movement of the watering can, comprising a right blocking portion, to block right movement of the watering can. The example shown in FIG. 29 is an example of wherein there is a blocking arrangement, to block movement of the watering can, comprising a back blocking portion, to block backward movement of the watering can). Preferably the blocking arrangement, to block movement of the watering can, blocks all of: movement forwards, movement backwards, movement left, and movement right, (of the watering can). (The example of FIG. 29 is an example of this, provided by way of example only).

(Various options and/or embodiments have been explored and/or disclosed, with reference to the/a positioning system, to keep the watering can positioned in the water catching position. But it should also be stated, any combination of what is disclosed, (with reference to a positioning system), may also be provided. For example, there could be mating, and also the watering can could be removably attachable. (For example, whilst the examples in FIGS. 11-22 are not considered to be an example where the watering can is removably attachable, (mating occurs, but the watering can is not ‘removably attachable’), it is feasible both mating and removable attachability could occur; for example, the example protruding portion, (in the example of FIG. 11, or any relevant example(s)), could have a slightly bulbous end. The receiving portion that it is received into could then have a slightly bulbous end, with the user only being able to get the slightly bulbous end of the protruding portion into the slightly bulbous end of the receiving portion via applying at least some pressure. (Plastic, for example, of the protruding portion and/or receiving portion, (eg due to deformability characteristics), may allow for deforming, to achieve this). In such an example, for example, once the slightly bulbous end of the protruding portion is received into the slightly bulbous end of the receiving portion, this therefore ‘attaches’ the watering can. Thus both mating, and removably attachability can occur. (This example is/was provided simply by way of example only, and is an example of wherein ‘tightness’ can be used, to facilitate the watering can being removably attachable. It will be apparent, in the example given, that there need not be a corresponding ‘slightly bulbous’ end of the receiving portion. For example, there may simply be a more ‘wide/open’ portion of the receiving portion. More broadly still, it should be stated that ‘tightness’ (between a protruding portion and a receiving portion that receives the protruding portion) is therefore shown to be a way in which removable attachability can be achieved. In broad terms, a mating arrangement where a portion(s) of the protruding portion is tight through any portion(s) of the receiving portion can facilitate removable attachability, (either directly as a result of the protruding portion, (when the watering can is in the ‘attached’ position), being tightly held, or by virtue of the protruding portion being prevented from exiting the receiving portion, by virtue of a portion of the protruding portion having travelled through a tight portion of the receiving portion, and now being ‘blocked’ from exiting the receiving portion, due to the tight portion. Broadly speaking, then, these are examples to show that removable attachability can be achieved, via mating, (rather than having mating alone, without being removably attachable). This various options and/or embodiments are possible. (It should also be stated, (as stated previously), that whilst examples are given of wherein the watering can comprises the female feature(s), (that is then received by a female feature(s)), it could be the other way around, with the watering can comprising a female feature(s), (that is then received by a male feature(s)). Thus various options and/or embodiments are possible).

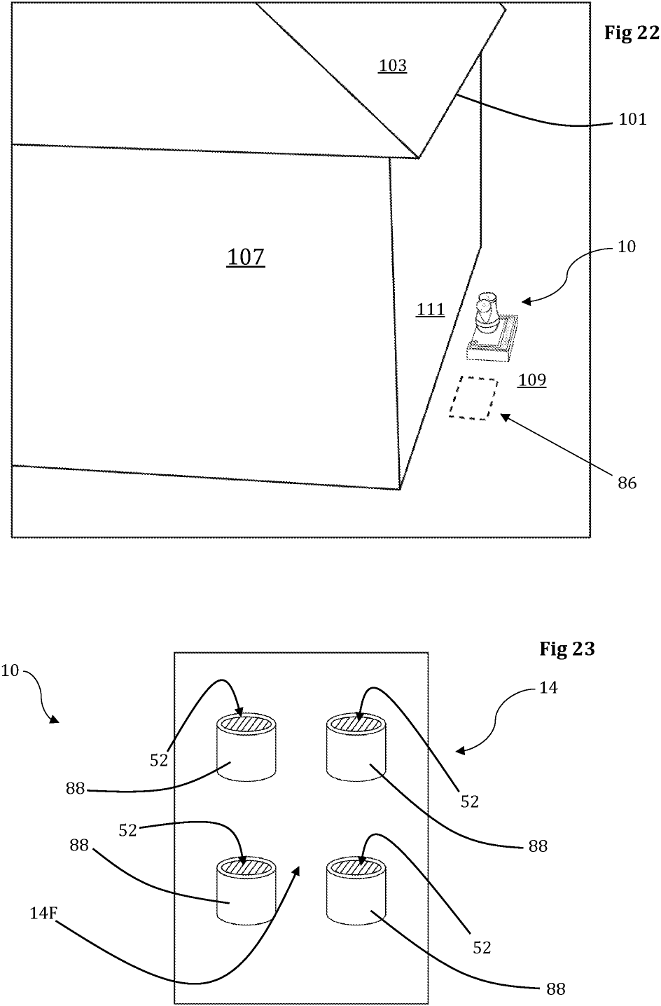

(It should be stated, whilst it will tend to be highly important that the positioning system heavily limits forward (and backward) movement of the watering can, (to keep it in the water catching position), it may be possible for a positioning system to allow for significant sideways (ie left/right) movement of the watering can, but still nevertheless keeping it in the water catching position. To explain, this (ie how a watering can can stay in a water catching position, even despite significant sideways movement), it will be apparent that, due to nature of shape of a roof, when rain falls off the roof, it will tend to do some across the breadth of the side of the roof. (This may or may not be the case, dependent on the particular house/roof). If one imagines, then, that the side of a roof, (off which rain falls), is five metres in breadth, (ie ‘across’), the rain will tend to fall off the roof along the whole of that five metres, (or at least for a significant amount of it, dependent on the particular house/roof). Thus, if the rain falls off the side of the roof for a breadth of five metres, (ie along five metres of roof), it will be apparent, (returning now to the nature of the apparatus/system for catching rain water from the roof), that the watering can could, in theory, (and, in fact, in reality), move ‘sideways’, (in theory, along the whole five metres), whilst still staying in a water catching position. However, depending on how rain falls off a particular roof, (which could be affected by angle, speed, ferocity, for example, of how the rain falls off the roof), there will tend to be far less scope for forward (or backward) movement, in order to stay in a water catching position. Thus, now looking at the example of FIG. 22, for example, it will be apparent that if the example embodiment allowed the watering can to slide (ie, broadly, ‘move’) left and right, significant sideways movement could be possible and/or allowed, with the watering can still staying in the water catching position. (In the example shown in FIG. 14, (simply mentioned by way of example only, for example), there could, for example, be a slide mechanism, that allows the watering can to slide (ie move) left or right, when it is attached. (For example, an attachment feature(s) of the watering can, when the watering can is attached, may be able to ‘slide’ sideways, (eg within a an aperture that receives and holds it, for example. (Or, the feature(s) the watering can is attached to, itself, may be able to move sideways, thus facilitating the watering can in moving sideways, when attached. This is just one example given, simply by way of example only, to demonstrate that it is possible that significant sideways movement could be possible, with the watering can staying in the water catching position).

The watering can can be seen to be portably movable from the example apparatus it sits on. For example, (looking at FIGS. 15 or 16, for example), when the user wants to use the watering can, (ie if it has water in it, caught from the roof, and they want to now use the watering can, to water plants around their garden, for example), they can simply pick up the watering can, and go about using it.

Preferably, the rainwater catching apparatus comprises an area(s) to input water into that the watering can does not comprise, to help keep the watering can in the water catching position, due to weight of the water. (Various examples are shown on the Figures of the water catching apparatus 10 comprising an area(s) to input water into that the watering can does not comprise, to help keep the watering can in the water catching position, due to weight of the water. (Thus various examples are shown of wherein there is an apparatus that comprises an area(s) to input water into, to help keep the watering can in the water catching position, due to weight of the water, the apparatus that comprises the area(s) to input water into not being the watering can). (Thus examples are shown of a system for catching rainwater from a roof, wherein there is an area to input water into that the watering can does not comprise, to help keep the watering can in the water catching position, due to weight of the water)).

(Examples are shown, (provided by way of example only), of a rainwater catching system, where there is an area for inputting water into. (Benefit of helping keep the watering can in the water catching position, due to weight of the water, has already been mentioned)).

The apparatus that comprises an area(s) to input water into, (to help keep the watering can in the water catching position, due to weight of the water), may, or may not, comprise a portion or a whole of the blocking arrangement, to block view of a portion or a whole of the watering can. (Broadly put, the apparatus that comprises an area(s) to input water into may, or may not, ‘play a role in’ the blocking arrangement. (Please see earlier disclosure relating to this, (ie the term ‘playing a role in’), which is relevant).

Preferably, in the water catching position, the watering can is positioned on an apparatus, and the apparatus that the watering can is positioned on comprises an area(s) to input water into. (This is shown in various examples in the Figures, and is perhaps most demonstrably shown in FIG. 11. (The embodiments of FIGS. 15-22 also are an embodiment of this, (comprising an area to input water into, (which, in the example embodiment, is a water storage area that is operable in a closed mode, where water cannot escape). (Wavy dashed lines are shown in FIG. 20, intended to denote water 55 being in the water storage area of example part 33). (As has been stated, due to weight of the water, this can prove helpful in keeping the watering can in a water catching position).

Preferably, the area to input water into is a water storage area that is operable in a closed mode, where water cannot escape. (An example of this is best shown in FIG. 16, where there is shown an example closing element 46. (In the example, the closing element is a cap). This cap can be removed, so that water can be inputted into the example apparatus that comprises the area(s) to input water into. (A cap is simply an example of a closing element 46). Other embodiments of a closing element may be a ‘lid’ for example, or an openable and closable ‘door’/’hatch’, etc, for example. (Thus various options and/or embodiments are possible, with reference to a closing element). Thus what is shown is an example of an area to input water into that is openable and closable, (provided simply by way of example). Thus what is shown is an example of there being an input point, to input water into the/an area to input water into. (In the example, the input point is shown closed/covered, by the example closing element 46). (Note, it is feasible there could be a plurality of input points). In the example, there is a closing element, to facilitate closing the input point. The closing element may, or may not, stay attached to the apparatus, when the input point is open. For example, in the example shown, the example cap, (an embodiment of a closing element), is not attached, when the input point is opened. However, in another embodiment, when the input point is opened, (the cap removed), it may stay attached to the apparatus, (eg via plastic, for example). Thus a closing element, (whatever embodiment of a closing element it may be), may, or may not, stay attached, when the input point is opened.

Examples are provided of wherein the area to input water into is an internal area. (Various examples are shown of this; for example, an example is shown in FIG. 11, for example, and examples of this are also shown in the embodiments of FIGS. 15-22, for example. (Note: Even in an embodiment such as that shown in FIG. 29, an area(s) to input water into, (where the area is internal), may be provided. (For example, there may be an internal area, to input water into, at a bottom of example area 90, for example)). Various examples are shown of a water storage area 44 that is operable in a closed mode, wherein water cannot escape). However, it should be stated that an area to input water into may, feasibly, be external. For example, there could be an area on a surface of an apparatus, the area being recessed, for example, such that water can be stored in it. A significant disadvantage of this, however, is that if winds affect this area, the wind may knock the water out. Another disadvantage of this may be that, if the apparatus is being used in an area that has mosquitos, for example, (or any other undesired pests/insects that are attracted to water, (eg as sites for breeding)), this may lead to mosquitoes, etc, using the water, for breeding purposes. Therefore preferably the area to input water into is an internal area. (The area for inputting water into being ‘openable and closable’ may also be extremely helpful in stopping mosquitos, etc, getting to the water. The example cap, in the example embodiment(s) shown, stops any mosquitos from accessing the area for inputting water into). (It should also be stated, it is feasible an area to input water into that is internal could be provided, but wherein it is not operable in a closed mode. For example, looking at the example of FIG. 16, if an embodiment was provided, but wherein there is no closing element 46 to close the input point 43, then the input point would just stay open).

(It should be stated, there is much disclosure, in the present application, of example apparatus/part 33 comprising the/an area(s) for inputting water into. However, it should be stated, the/an area(s) for inputting water into may feasibly be provided anywhere. For example, example part/apparatus 35, for example, may comprise the/an area(s) for inputting water into. For example, looking at FIG. 24, for example, there could be a (preferably openable and closable) input point generally at point 143, for example, (or at any other place(s)/position(s). Water could therefore nevertheless be inputted. (It should also be stated, looking now at FIG. 16, and imagining, for example, that, rather than a planting area, the blocking arrangement comprises a plurality of ceramic figures and ornamental design, for example, if it is imagined that there was an internal area for inputting water into, for example, for example generally where the planting area is, in the example of FIG. 16, water could be inputted into the area for inputting water into, and could therefore be useful in weighing the example water catching apparatus down. This, in such an example, this could be very useful in helping to keep the watering can in the water catching position. Thus various options and/or embodiments are possible, and the example area(s) to input water into are shown and/or disclosed simply by way of example, only. (Therefore there are various ways/place(s) that an area(s) for to input water into, (eg a water storage area, operable in a closed mode, where water cannot escape), can be provided. The examples are provided by way of example only).

There may be an area to input water into that is a planting area, (for planting one, or more than one, plant into). (Note: Whilst it is the case that planting areas tend to comprise drainage apertures, (to drain water away, (eg so that soil and/or plant(s) do not become waterlogged)), if matter (eg matter for plant(s), (real and/or fake), to be planted into), is used in the planting area, (eg soil, for example), this can ‘soak up’ water, and thus this would fall within the scope of being an ‘area to input water into’, because water can be inputted into the planting area, (onto the soil), be soaked up by the soil, for example, with the result that that area is now ‘carrying’ water within it. (It should be noted, for fake plant(s), a ‘foam’, (or the like), (or any ‘soil substitute matter’ could be used. This, similarly to soil, may be able to ‘soak up’ water). However, preferably the area(s) for inputting water into is a water storage area 44 that is operable in a closed mode, where water cannot escape from it. (This differentiates, therefore, from areas that have drainage hole(s), for example, (or that are ‘external’ and constantly ‘not closed’, therefore).

(It should also be stated, there could be a plurality of areas to input water into. For example, in the example of FIG. 16, for example, it can be stated that there is more than one area to input water into. For example, there is the area that soil can be seen in, (which water can be inputted into, and soaked up by the soil), and the example part 33 also comprises an area to input water into. (The area to input water into that the apparatus comprises is a water storage area 44 that is operable in a closed mode, where water cannot escape from it, whereas the area that the soil is in has drainage holes, (see FIGS. 18-20), and therefore is not operable in a closed mode, where water cannot escape from it. However, it should be stated, embodiments could be provided where there are a plurality of water storage areas that are operable in a closed mode, where water cannot escape from it. It should also be stated, embodiments could be provided where there are a plurality of areas for inputting water into that are not operable in a closed mode. Thus various options and/or embodiments are possible.

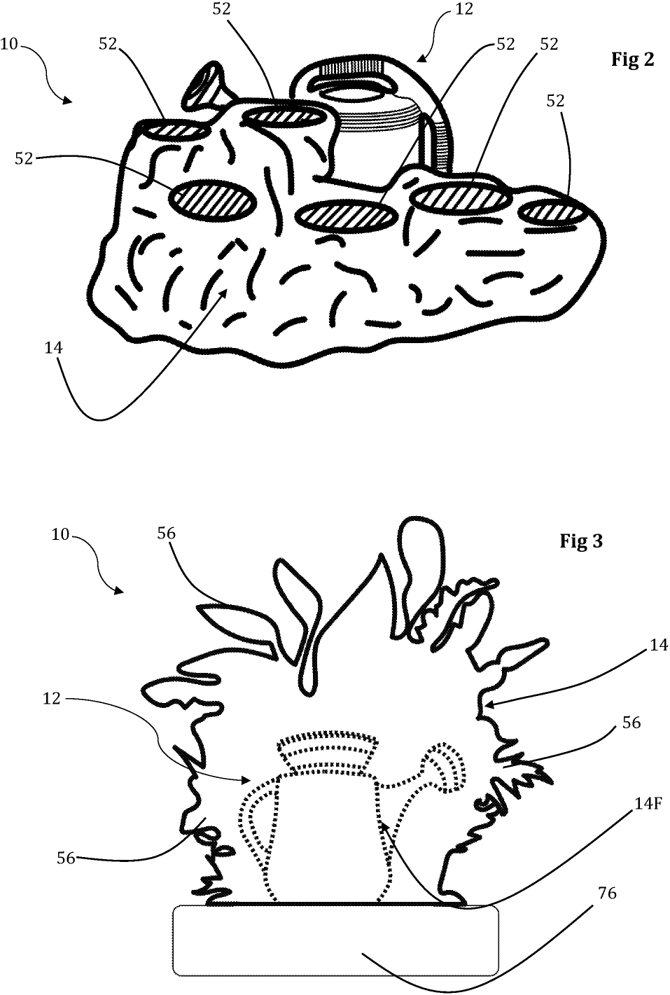

Preferably, there is provided a planting arrangement, (comprising at least one planting area 52), (to plant one, or more than one, plant into). (Various examples of this are shown in the Figures). (Note: The term ‘planting arrangement’ is simply a broad term, including within its scope whether there is only one planting area, (to plant one, or more than one, plant into), or more than one planting area, to plant one, or more than one, plant into). For example, in the example of FIG. 2, there is more than one planting area 52, (to plant one, or more than one, plant into). But in the example of FIG. 16, for example, there is only one planting area 52, (albeit a large one). Thus each are an example of a ‘planting arrangement’, (comprising at least one planting area). There may be more than one planting area, or there may be only one planting area. (FIG. 2 perhaps most clearly shows/displays each planting area comprising a cavity, (which may be referred to as a planting cavity), for planting into).

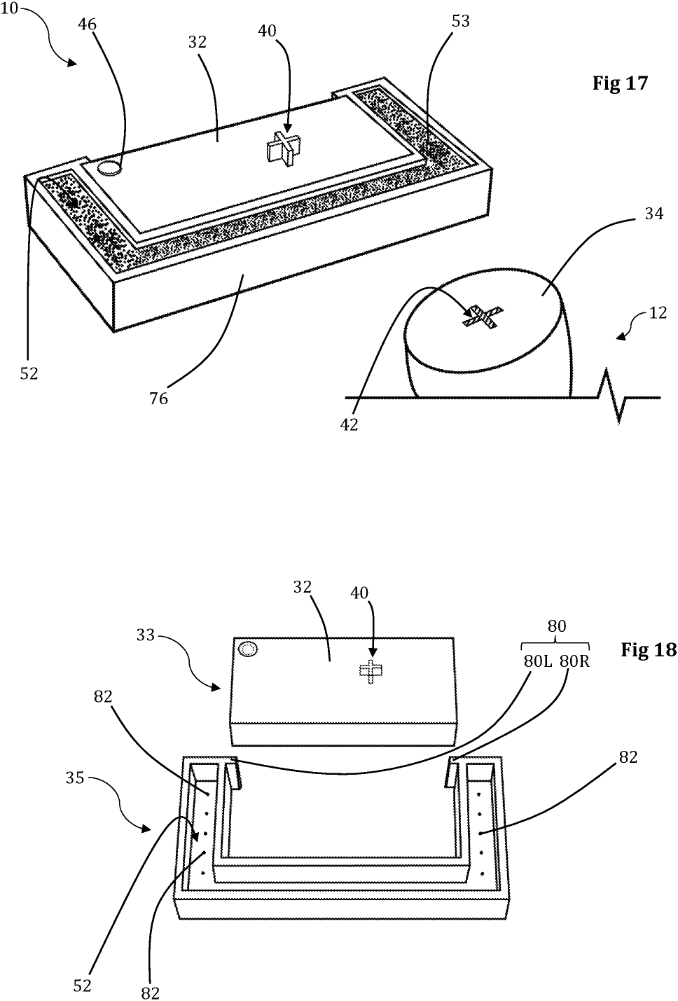

Example soil 53 is shown in the planting area, in FIGS. 16 and 17, for example.

It is denoted that water 55 is in the area to input water into, in FIG. 11, to help keep the watering can in the water catching position, due to weight of the water. (This is also shown/denoted in FIG. 20, denoted with wavy dashed lines, to signify/denote that water is in the example water storage area (that is operable in a closed mode) of FIG. 20). Thus this shows, ‘in action’, water being used, to weigh down the apparatus, to help keep the watering can in the water catching position.

There is shown, in various Figures, an example(s) of wherein there is one, or more than one, plant 56, planted in a planting area(s), (and thus within a ‘planting arrangement’). (FIGS. 1 and 2 show a planting area(s), (and in fact show a plurality of planting areas), but without any plant in them. But FIG. 15, for example, is a good example of there being shown/denoted a planting area(s) where there is one, (or more than one) plant planted in the planting area(s).

Preferably, at least one of the one, or more than one, plant planted in the planting area(s) plays a blocking role in the blocking arrangement blocking view of a portion or a whole of the watering can. Preferably, at least one of the one, or more than one, plant planted in the planting area(s) plays a blocking role in the front blocking portion blocking view of the portion or the whole of the watering can, from the front view. (An example of this is perhaps best/most demonstrably shown in FIG. 3 and FIG. 15, where a plant(s) is clearly shown playing a blocking role in the front blocking portion blocking view of the portion or the whole of the watering can, from the front view). (It is possible that at least one of the one, or more than one, plant planted in the planting area(s) plays a blocking role in the left blocking portion blocking view of the portion or the whole of the watering can, from the left view. (An example of this is perhaps best/most demonstrably shown in FIG. 3 and FIG. 15, where a plant(s) is clearly shown playing a blocking role in the left blocking portion blocking view of the portion or the whole of the watering can, from the left view)). (It is possible that at least one of the one, or more than one, plant planted in the planting area plays a blocking role in the right blocking portion blocking view of the portion or the whole of the watering can, from the right view. (An example of this is perhaps best/most demonstrably shown in FIG. 3 and FIG. 15, where a plant(s) is clearly shown playing a blocking role in the right blocking portion blocking view of the portion or the whole of the watering can, from the right view)). (Note: It should be stated, it is feasible there could be a plant(s), that does not play a blocking role, in blocking view of a portion or a whole of the watering can. (For example, there could be a blocking arrangement that already is high enough to completely block view of the watering can, and there could, nevertheless, be a plant(s) positioned above this, that therefore plays no blocking role, in blocking view of the watering can). (Note: It should also be stated, the idea of a plant not playing a blocking role is not limited to it being in a ‘high’ position. For example, an embodiment may be provided where there is a blocking arrangement comprising a front blocking portion, (eg made of plastic, or ceramic, for example) that blocks view of the watering can, from the front view, (eg fully), and there are then plant(s), further in front, but which are effectively not playing a blocking role, because the front blocking portion already blocks view of the watering can fully, (without the plant(s)). Thus various options and/or embodiments are possible. Thus there could feasibly be a plant(s) that play a blocking role, and a plant(s) that does not. (An example of there being a plant(s) that does not play a blocking role will be described, with reference to FIGS. 23 and 24).

Preferably, the blocking arrangement comprises at least one plant that plays a blocking role. (Various examples of this are shown and/or alluded to in the Figures). (Note, if a plant is positioned/shaped so that a portion (but not a whole) of it plays a blocking role in blocking view of the watering can, that is still considered to be an example of a plant that plays a bocking role, because at least a portion of it plays a blocking role). Preferably, the blocking arrangement comprises at least one plant that plays a blocking role in the front blocking portion blocking view of the portion or the whole of the watering can, from the front view.

(Example embodiments where the front blocking portion, (in use), comprises at least one plant that plays a blocking role in the front blocking portion blocking view of the portion or the whole of the watering can, from the front view are shown most demonstrably, in FIGS. 2, 3 and 15. Note: the term ‘in use’ here is simply included to make clear, for example, that whilst no plant(s) are shown in the view of FIG. 2, (where no plant(s) have been planted into the example planting area(s)), it will be apparent that, ‘in use’, there is ‘at least one plant that plays a blocking role in the front blocking portion blocking view of the portion or the whole of the watering can, from the front view’. (It should also be stated, an embodiment with fake plant(s) that play a blocking role, for example, even if the fake plant(s) are not ‘planted’, and instead are permanently in position, (eg using plastic manufacturing method(s), for example, where the plant(s) is ‘formed as one piece’ with a portion or a whole of another part(s) of the/an apparatus, (which is technically possible)), would still be an example of wherein, ‘in use’, the blocking arrangement comprises at least one plant that plays a blocking role, (because, ‘in use’, they play a blocking role). (As will be explained, definition of a plant(s) playing a blocking role is not limited to their being a planting area(s). For example, if fake plant(s) are provided, there may, or may not, be a planting area(s)- for example, fake plant(s), (eg partially or wholly made out of plastic(s)), may, or may not, need to be ‘planted’.

(Manufacturing methods could allow for a portion or a whole of a fake plant(s) to be ‘formed as one piece’ with a portion or a whole of another part(s) of the/an apparatus)). Thus a planting area(s) may not be required. Thus definition that the blocking arrangement comprises a plant(s) (that plays a blocking role) is not limited to there being a planting area(s).

Preferably, at least one of the at least one plant that plays a blocking role in the front blocking portion blocking view of the portion or the whole of the watering can from the front view is a fake plant. (Thus ‘synthetic’ plant(s) can be used). (Note: ‘Depictions’ of plants, or ceramics that are painted or shaped to ‘look like’ plants are not considered to be within the scope of being plant(s), for the sake of the present application. Only ‘real’, (ie organic), plants, or ‘synthetic’ plants, (ie that ‘mimic’ real plants), are deemed within a scope of being ‘plants’, for the sake of the present application). (Note: It is possible that there are a plurality of plants that play a blocking role in the front blocking portion blocking view of the portion or the whole of the watering can from a front view and that all the plants that play a blocking role in the front blocking portion blocking view of the portion or the whole of the watering can from a front view are fake plant. (For example, all the plants in FIG. 15, for example, could be fake)). (So the same, (with regards to a plant(s) being fake), may (or may not) be the case, for the left blocking portion). (So the same, (with regards to a plant(s) being fake), may (or may not) be the case, for the right blocking portion).

At least one of the at least one plant that plays a blocking role in the front blocking portion blocking view of the portion or the whole of the watering can may be a real plant. (Note: It is possible that there are a plurality of plants that play a blocking role in the front blocking portion blocking view of the portion or the whole of the watering can from a front view and that all the plants that play a blocking role in the front blocking portion blocking view of the portion or the whole of the watering can from a front view are real plant. (For example, all the plants in FIG. 15, for example, could be real)). (So the same, (with regards to a plant(s) being real), may (or may not) be the case, for the left blocking portion). (So the same, (with regards to a plant(s) being real), may (or may not) be the case, for the right blocking portion).

(Note: Looking at the example of FIG. 15, for example, the plants could be real, could be fake, (or could, (feasibly), be a mixture (ie combination) of the real and fake).

Referring briefly to each Figure, FIG. 1 depicts an example embodiment of the water catching apparatus 10, with the watering can 12 in a water catching portion, under a side 101 of a roof 103 of a building 107. (An example wall 111 of the building is also shown). It can be appreciated that rainwater that falls off the side of the roof can be caught by the watering can. (Note: In the example of FIG. 1, the example is an example wherein the blocking arrangement is intended, in use, to comprise a plant(s), (to block view of a portion or a whole of the watering can). This is clear by the fact that various planting area(s) are depicted. However, the plant(s) have not been planted into the planting areas, in the depiction in FIG. 1. (It is intended that, in use, the plant(s) planted in the planting areas play a blocking role, in blocking view of a portion or a whole of the watering can, from a front view. (Other example of wherein the blocking arrangement comprises a front portion, to block view of a portion or a whole of the watering can, from the front view, and wherein a plant(s) plays a blocking role in the front blocking portion blocking view of a portion or a whole of the watering can, from the front view, are shown most clearly/demonstrably, for example, in FIG. 3 and FIG. 15)).

In FIG. 2, a close-up view of the example embodiment of the water catching apparatus is shown. The example planting areas 52 are particularly clear to see. In the example, artistic wavy lines are shown, to denote that, in the example, the water catching apparatus, (simply in this particular embodiment/design), is designed to look stone/boulder-like. It may therefore have an uneven surface. Plastic, (preferably lightweight), may be used to achieve this look, (since stone would be extremely heavy and provide manufacturing challenges and/or costs). (Plastic is given as an example only, and any (suitable) material(s) may be used).

In FIG. 3, clearly an example blocking arrangement that comprises a front blocking portion that blocks view of a portion or a whole of the watering can, from the front view, is shown. In the example, the example front blocking portion blocks view of a whole of the watering can. The watering can is depicted/shown in dotted lines, to denote it is ‘behind’ the example blocking arrangement, and is ‘hidden’. In the example water catching apparatus, there is a portion 76. In the example, this may be referred to as a ‘base’ (and/or a ‘base portion’, (and/or a ‘front base’, and/or a ‘front base portion’). (In the example, (provided by way of example only), it may be referred to as a ‘base for the front blocking portion’). In the example, the blocking arrangement 14 comprises a plant(s) 56. (The number ‘56’ is provided multiple times in FIG. 3, simply to help denote that, in the example embodiment, (provided by way of example only), there are many plant(s), (rather than just one plant). (There could be far more than three plants, and the number ‘56’ I used several times only to denote that there are a plurality of plants, in the example)). (In the example, the front blocking portion 14F comprises a plant(s)). The plants are depicted merely by a thick black outline, (to avoid complexity, which it is hoped provides significant clarity as to what is being shown/demonstrated). The actual nature of the plants, in the example, is that there are leaves, and flowers. (Thus this is an example of wherein the plant(s) comprise leave(s). Thus this is an example of wherein the plant(s) comprise flower(s)). However, for simplicity (and clarity), these are simply depicted by depicting their outline, with a thick black line, (as shown)).

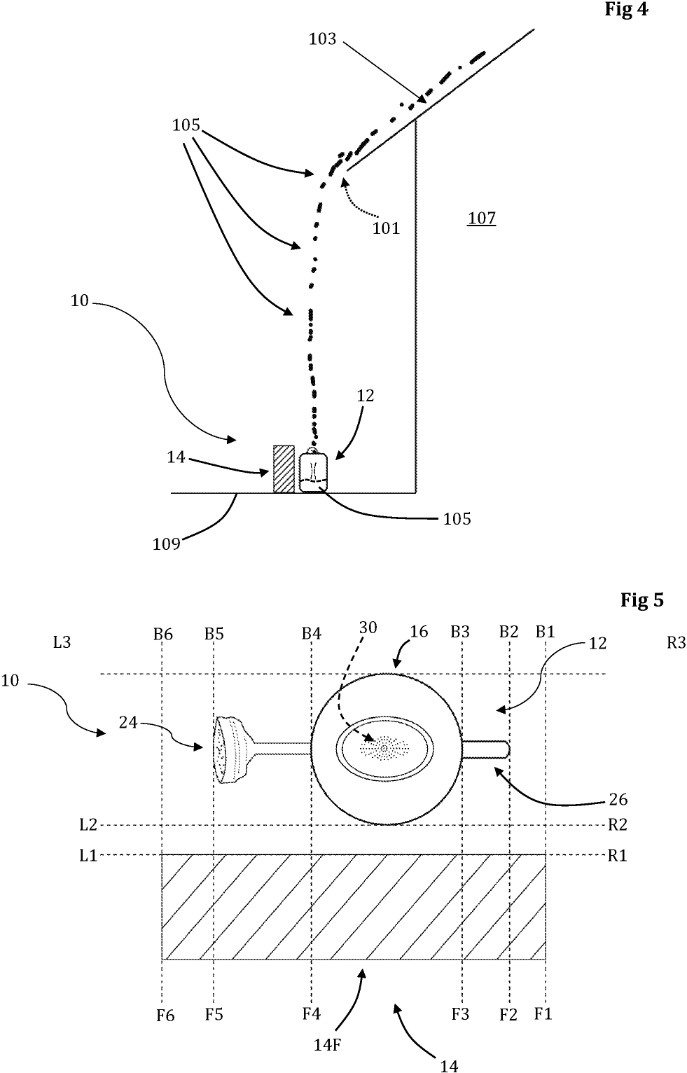

In FIG. 4, rainwater 105 is shown falling off a side 101 of an example roof 103 of an example building 107. It is clear, by what is shown, that the watering can is in a water catching position, (and a dotted line within the watering can is intended to depict rainwater 105 collecting in the watering can). The example watering can and example blocking arrangement are shown on the ground 109. (The ground 109, in FIG. 1, is paved, (provided simply by way of example only). (Whilst in the example of FIG. 4, the apparatus does not comprise a portion for the watering can to be positioned on, in the water catching position, (the watering can is simply it positioned on the ground), it will be apparent that such feature(s) may be provided). (Whilst there is no positioning system in the example of FIG. 4, (to keep the watering can positioned in the water catching position), it will be apparent that such feature(s) may be provided).

In FIG. 5, a top view is provided of a basic depiction/representation, showing an example watering can, hidden behind an example blocking arrangement that comprises a front blocking portion 14F, to block to block view of a portion or a whole of the watering can, from a front view. (In this example, the blocking arrangement, (and front blocking portion), block view of a whole of the watering can, from the front view, (although the height of the blocking arrangement cannot, of course, be shown, from the view shown)).

In FIG. 6, a top view is provided of a basic depiction/representation, now showing an example where the blocking arrangement 14 comprises a front blocking portion, (to block view of a portion or a whole of the watering can, from a front view); a left blocking portion 14L, (to block view of a portion or a whole of the watering can, from a left view); and a right blocking portion 14R, (to block view of a portion or a whole of the watering can, from a right view). In the example of FIG. 6, the example blocking arrangement is generally curved in shape.

In FIG. 7, a similar example is shown to that of FIG. 6, (and also from a top view), but wherein, in the example, the example blocking arrangement is generally cubic in shape. (In the example, the front blocking portion is ‘straight’. In the example, the left blocking portion is ‘straight’. In the example, the right blocking portion is ‘straight’. (This is in contrast to the ‘curved’ example of FIG. 6).

In FIG. 8, an extremely similar example is shown to that of FIG. 7, but wherein the water catching apparatus 10 now comprises a portion 32 for the watering can to be positioned on. (And the wating can is shown positioned on the portion 32). (FIG. 22 shows an example the water catching apparatus comprising a portion the watering can is positioned on, in the water catching position).

In FIG. 9, a basic depiction/representation of a watering can and a blocking arrangement, (comprising a front blocking portion), are shown. Various dashed lines are included, to help clarify what is meant by ‘height’ definitions, (from the front view). It can be seen, in the example, that the blocking arrangement, at its highest point, (defined by line FH1), is higher than a highest point of the watering can. (In the example, the highest point of the watering can, (defined by dashed line FH2), is at a highest point of an example sprinkler head 28, (which is not fully visible, due to being on the other side of the watering can, with reference to the view shown). (Another example of a watering can where the highest point of the watering can is at the highest point of a sprinkler head is clearly shown/visible in FIG. 16, for example). Also shown are dashed line FH3, (defining a highest point of a main body 16 of the example watering can, and dashed line FH4, (defining half height of the watering can). (Dashed line FH5 is also shown, defining half height of the main body of the watering can, in the example).

In FIG. 10, a basic depiction/representation is shown of an embodiment very similar to FIG. 5, but now wherein the water catching apparatus comprises a portion 32 for the watering can to be positioned on, (in the water catching position).

In FIG. 11, an example is depicted, (from a side view), showing an example blocking arrangement, comprising a front blocking portion 14F, and showing an example of a positioning system being used, to position the watering can in a desired position. In the example, the positioning system comprises an example receiving portion 38, that receives a portion of the watering can. (In FIG. 11, it can be shown how the base of the example watering can has already been received by the receiving portion). There is also shown to be ‘mating’, (to facilitate positioning of the watering can). In the example, the watering can comprises a receiving portion 42 that receives an example protruding portion 40. Thus mating has occurred. (It will be apparent how useful (and effective) this can be, to keep the watering can in an upright position). (It will be apparent how useful (and effective) this can be, to keep the watering can in a desired position). (It will thus be apparent how useful (and effective) this can be, to keep the watering can in a water catching position).

FIG. 12 shows the example of FIG. 11, from a top view, but without the watering can present, showing the example receiving portion 38, (and example protruding portion 40 that plays a role in ‘mating’). In the example, the example receiving portion 38 is a recess. (Thus this is an example of wherein the receiving portion 38 comprises a recess(es)). In the example, the example recess is a curved recess. (However, a recess could be of any suitable shape, not limited to being a curved recess. (And it will be apparent that, in a situation such as what is shown/denoted in FIGS. 11, 12 and 13, where the base of the watering can is received by the receiving portion), that shape of the watering can base may define what is an appropriate shape for the receiving portion 38, (and vice versa)). There is also denoted an example water input point 43, (a dashed line used to generally point towards the example water input point 30, to denote that it is not visible, in the view shown, due to an example closing element 46), which, in the example embodiment, is covered by an example closing element 46. The water input point is shown closed, by the example closing element 46. (In the example, the example closing element is a cap). (It should be stated, in other embodiments, the water input point may be positioned in a different place. It should be stated, in other embodiments, the water input point may be a different size and/or shape and/or design. In other embodiments, there may be more than one water input point. Thus various options and/or embodiments are possible).

FIG. 13 shows an underside of an example watering can, showing an example receiving portion 42 the watering can comprises. Thus ‘mating’ can occur between the example protruding portion 40, (shown in FIG. 12), and the example receiving portion 42, (shown in FIG. 13). The example receiving portion is shown on an underside of the example watering can. (The example watering can is also shown comprising a spout body 20. The example watering can is also shown comprising a sprinkler head 28. The example watering can is also shown comprising an example handle 26).

In FIG. 14, an example is shown of wherein the watering can is removably attachable. (Note: Whilst, in the example of FIG. 14, there is shown a portion 32 for the watering can to be positioned on, (which it is shown positioned on, in FIG. 14), it will be apparent that the watering can being removably attachable is not limited to embodiments that comprise a portion for the watering can to be positioned on. For example, looking at FIG. 14, an embodiment could be provided, (eg similar to that shown in FIG. 4, (or FIG. 9), for example), where the watering can simply is positioned on the ground, (and where there is not a portion 32 for the watering can to be positioned on). (Thus the example is provided by way of example only, and no undue limitation should be read onto it).

An example attachment arrangement 19, (to facilitate the watering can being removably attachable), is shown, (provided by way of example only). In the example, the watering can comprises a feature (feature 21). In the example, this attaches to example feature 23, (eg via clipping, for example, or any other way). Thus the watering can can be attached. When it comes to removing the watering can, user may have to use some force, or, for example, perhaps manipulate one or both of the features, 21, 23, to facilitate removing the watering can. In other embodiments, the watering can may simply have a receiving feature, (eg a recess(es), for example), that receives a features, to facilitate removable attachability. It will be apparent that many options and/or embodiments are possible, to generate removable attachability.

In FIG. 15, an embodiment is shown, from a perspective (and slightly raised) view, showing an embodiment where the blocking arrangement, (to block view of a portion or a whole of the watering can), comprises plant(s) 56. It can be seen that the blocking arrangement comprises: a front blocking arrangement; a left blocking arrangement; and a right blocking arrangement. (The watering can is present, but is hidden from view by the example blocking arrangement). (The example embodiment is an example of wherein the front blocking portion 14F comprises a plant(s). The example embodiment is an example of wherein the left blocking portion 14F comprises a plant(s). The example embodiment is an example of wherein the right blocking portion 14F comprises a plant(s). The example embodiment is an example of wherein a plant(s) plays a blocking role in the front blocking portion 14F blocking view of a portion or a whole of the watering can, from a front view. The example embodiment is an example of wherein a plant(s) plays a blocking role in the left blocking portion 14F blocking view of a portion or a whole of the watering can, from a left view. The example embodiment is an example of wherein a plant(s) plays a blocking role in the right blocking portion 14F blocking view of a portion or a whole of the watering can, from a right view).

(Note: In FIG. 15, various different plants are denoted, in the example. Structures such as stems are denoted, (albeit in basic artistic manner). Towards the top of the example blocking arrangement, large leaves, (typical for tropical-type plants), are shown/denoted, (albeit in basic artistic manner). Towards the lower area of the example blocking arrangement, more regular, (smaller), leaves are shown/denoted, (albeit in basic artistic manner). Slightly higher than this are shown some example flowers. Thus various options and/or embodiments are possible, for the plant(s). In the example, the watering can is obscured to such an extent that an onlooker would have no idea there is a watering can behind. This is provided simply by way of example only).

FIG. 16 shows the same embodiment as FIG. 15, but with the plants, (and hence the blocking arrangement, in the example), removed. The example watering can 12 can clearly be seen. The example apparatus clearly comprises a portion 32 for the watering can to be positioned on, (which it is shown positioned on). An example planting area 52 is clearly visible. Soil 53 is shown in the example planting area. (It should be stated, in other embodiments, there may be a plurality of planting area(s), with soil in them). (What is shown is an example of wherein there is a planting area that plays a role in the front blocking portion blocking a portion or a whole of the watering can, from a front view. What is shown is an example of wherein there is a planting area that plays a role in the left blocking portion blocking a portion or a whole of the watering can, from a left view. What is shown is an example of wherein there is a planting area that plays a role in the right blocking portion blocking a portion or a whole of the watering can, from a right view. (What is shown is an example of wherein there is a planting area that plays a role in (all of): the front blocking portion blocking a portion or a whole of the watering can, from a front view; the left blocking portion blocking a portion or a whole of the watering can, from a left view; and the right blocking portion blocking a portion or a whole of the watering can, from a right view. (In the example, the front blocking portion ‘shares’ a planting area that plays a role in both the front blocking portion blocking, and the left blocking portion block and/or the right blocking portion blocking. However, it will be apparent that, (whether any ‘sharing’ of any planting area(s) occurs or not), there could be provided an embodiment, (eg similar to what is otherwise shown in FIG. 16, for example, (or perhaps significantly different)), wherein there is a planting area(s) that plays a role in the front blocking portion blocking, and a different planting area(s) that plays a role in the left blocking portion blocking. There could be provided an embodiment, (eg similar to what is otherwise shown in FIG. 16, for example, (or perhaps significantly different)), wherein there is a planting area(s) that plays a role in the front blocking portion blocking, and a different planting area(s) that plays a role in the right blocking portion blocking. (There could be provided an embodiment, wherein there is a planting area(s) that plays a role in the left blocking portion blocking, and a different planting area(s) that plays a role in the right blocking portion blocking. Thus various options and/or embodiments may be possible, which will be apparent, in light of the nature of the disclosure of the present application, (and it should be made clear, any option/possibility/combination etc of a planting area(s) being ‘shared’, or being ‘different/separate’ may be provided/is possible)). (A planting area(s) is said to be ‘playing a role’ in a blocking arrangement/portion blocking if it is used for planting of a plant(s) that plays a blocking role). (Note: It should be stated, if fake plant(s) are provided, there may, or may not, be a planting area(s). Fake plants, it will be known, do not need soil, (although soil can still add a realism). If there are fake plant(s), there may still be a planting area(s). If so, (for fake plant(s)), soil, (or any other matter, (for plant(s), (real and/or fake), to be planted into)), could be put in the planting area(s). A ‘foam’, (or the like), could be used. (Even if this provides no other benefit, it could be helpful, to allow fake plant(s) to be ‘planted’.This could help get (and keep) them in the right position, for example. However, as stated, if fake plant(s) are provided, there may, or may not, be a planting area(s)- for example, fake plant(s), (eg partially or wholly made out of plastic(s)), may, or may not, need to be ‘planted’.They can be provided, for example, with a ‘flat’ base, for example, which could, for example, be ‘attached’ in place. Or, for example, a portion or a whole of a fake plant(s) could even be ‘formed as one piece’ with a portion or a whole of another part(s) of the/an apparatus. Thus, (whilst unlikely), looking at example portion 76 in FIG. 15, it is feasible a portion or a whole of a fake plant(s) could be ‘formed as one piece’ with a portion or a whole of the example portion 76. (Thus they could both be plastic, with a portion or a whole of a fake plant(s) could being ‘formed as one piece’ with a portion or a whole of the example portion 76). Thus various options and/or embodiments are possible.

(Only several of the plants, in FIG. 15, are numbered with the number ‘56’. However, in the example embodiment, there are many, many plants. In the example embodiment, there are many flowers. In the example embodiment, there are many leaves).

FIG. 17 shows the same embodiment as FIG. 15 and FIG. 16, but now with the watering can not shown in position, on the example portion 32. (A base 34 of the/a watering can 12 is shown/alluded to, the watering can being shown upside down, in a cut-off view). An example protruding portion 40, (to facilitate mating), is shown. (An example base 34 of a watering can is shown, (not showing much else of the watering can), simply to show an example receiving portion 42, to receive the example, protruding portion 40. (In the example, the protruding portion 40 is generally a ‘cross’ shape. (The example receiving portion 42 is also, in the example, generally a ‘cross’ shape). However, this is provided by way of example only, and the protruding portion, (and receiving portion), are not limited to any particular shape. (In the example of FIGS. 12, and 13, for example, the protruding portion 40 is more of a ‘fin’ shape. In the example of FIGS. 12, and 13, the protruding portion 40 is linear, (again shown by way of example only)).

In FIG. 18, it is revealed that the portion 32 the watering can is positioned on, (eg in FIG. 16), is provided by way of a separate part/apparatus, (numbered ‘33’). (In the example embodiment, part/apparatus 33 may also be referred to as a ‘unit’). (In FIG. 18, the apparatus has been ‘removed’ from position, and is thus clearly visible). Thus, what is shown in FIG. 18 is an example of a water catching apparatus, comprising a watering can, (not shown in FIG. 18, but shown clearly in FIG. 16, for example); a part/apparatus 33 for the watering can to be positioned on, (which is shown, in action, in the example, in FIG. 16); and a blocking arrangement part/apparatus 35, (which either itself performs a portion of the blocking, and/or acts as a ‘base’ for the blocking arrangement, or performs a whole of the blocking). (The example of FIGS. 23 and 24 is an example of where there is a blocking arrangement apparatus that itself performs all the blocking, (not simply acting as a ‘base’, for example, for other blocking features, such as plant(s), for example)). It is shown that example part/apparatus 33 is an example of an part/apparatus that does not comprises a portion, and does not comprise a whole, of the blocking arrangement. (Unusual embodiments could feasibly be provided. For example, looking at what is shown in FIG. 18, it is technically feasible that a portion, (eg a central front portion), of the planting arrangement could be provided by apparatus/part 33. It could then ‘slide’ into position, for example

It can be seen that, in the example, the water catching apparatus comprises a back blocking portion 80, (may also be referred to as a back stopping portion), that blocks movement of part/apparatus 33, (thus keeping it in position). (In the example, the back stopping portion is provided by way of example back stopping sub-portions 80L and 80R. However, it should be made clear, in other embodiments, instead of having ‘sub-portions’, the stopping portion could extend a whole way along, and thus not be in multiple separate portions, (ie thus not being provided in ‘sub-portions’, but rather in one whole ‘portion’). The example part/apparatus? 33, in the example, comprises an area for inputting water into. (This is not visible, from what is shown, but an example closing element 46 is shown, (thus indicating the apparatus comprises an area for inputting water into), which can be used to open and close the area for inputting water into). The example part/apparatus 33 is an example of an apparatus that comprises a water storage area. (The area, in the example of FIG. 11, (and in the case of the area for inputting water into that part/apparatus 33 comprises), is an example of a water storage area. Both are examples of a water storage area that is operable in a closed mode, where water cannot escape. (This differentiates from the example planting area of the example embodiment(s) of FIGS. 15-22, which have drainage hole(s), (and therefore for this, (or any other reason(s)- eg not being closed at a top of the area, for example), is not an area that is operable in a closed mode, where water cannot escape). (As stated, water can be useful, for weighing down, (ie by virtue of weight), to help keep the watering can in a desired position. One can imagine, for example, looking at FIG. 16, for example, that if a significant amount of water is stored in example part/apparatus 33, then, when the watering can is in the water catching position, (eg as shown in FIG. 22, for example), due to the positioning system, (which, in the example embodiment, includes/comprises ‘mating’), and the weight of the water, it significantly protects against the watering can being moved out of position, (eg by (strong) winds)).

(Note: Whilst FIGS. 18 to 20 reveal the portion 32 the watering can is positioned on is provided by way of a separate apparatus, it should be stated, this need not be the case. For example, looking at FIG. 16, portion 32 could feasibly not be ‘separate’ from, (in the example, the feature numbered feature 35 in FIG. 18. Thus portion 32 could be formed as one part with a portion or a whole of feature 35. (Looking at FIG. 18, if it is imagined that feature 33, rather than being ‘separate’ as it is shown, was formed as one part with a portion or a whole of feature 35, that would be an example of this). In more basic terms, looking at FIG. 17, if it is imagined what is shown in FIG. 17 is all in one piece, for example, that is also possible. (An example of this is shown in FIG. 30). (This shows that embodiments can be provided wherein the portion 32 for the watering can to be positioned on does not have to be ‘separate’ in the way shown in the example embodiments of FIGS. 15-22). Thus various options and/or embodiments will be possible, which will be apparent, in light of the nature of the present disclosure.

(FIG. 18 also shows example drainage hole(s) 82. (Thus it shows an example of wherein there is a drainage hole(s) for a planting area(s). Thus it shows an example of a planting area(s) 52 that comprises a drainage hole(s) 82).

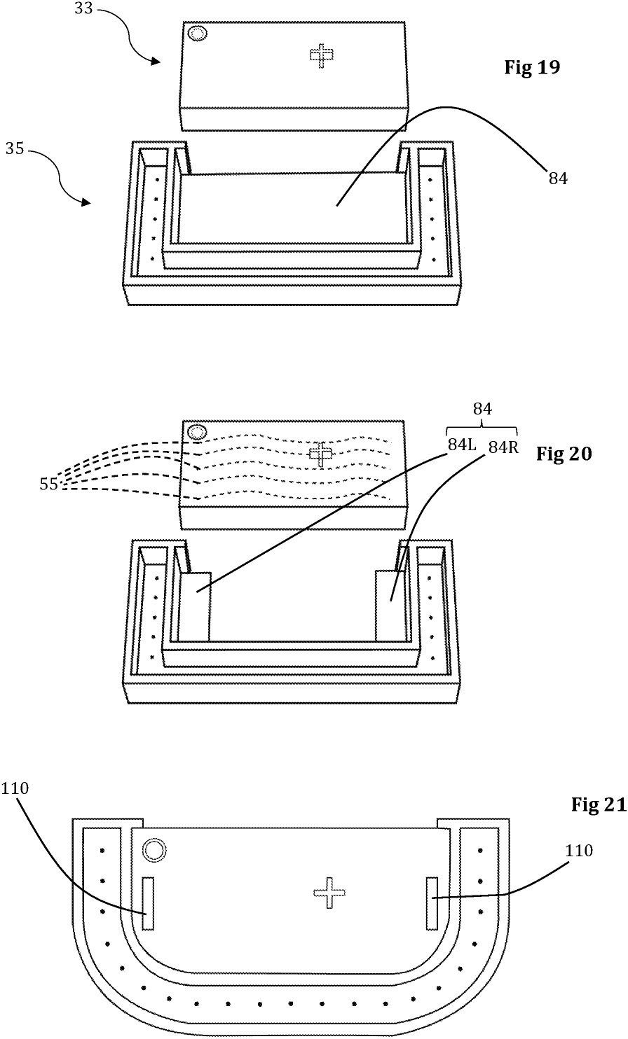

FIG. 19 shows an almost identical embodiment to the embodiment of FIG. 18, but now showing an example portion 84 that part/apparatus 33 is positioned on, (when put in position). (This can be useful, so that a user can pick up the whole water catching apparatus together. (To explain, if a user tries to pick up the example water catching apparatus, but it is one like the example of FIG. 18, (which does not have a portion 84 that part/apparatus 33 is positioned on), then, in the example of FIG. 18, for example, if they grab either side of the water catching apparatus), then part/apparatus 33 may simply remain on the ground, which could be problematic. However, in the embodiment of FIG. 19 (and FIG. 20), that cannot happen. The example portion 84 guarantees that, when grabbing the water catching apparatus from the sides, for example, to pick it up, part/apparatus 33 is also picked up. Thus this can be a significant benefit, (eg if a person wishes to move the whole water catching apparatus in one go, for example).

(Note: The examples shown in FIG. 19 and FIG. 20 are both example of wherein the water catching apparatus comprises a portion that goes under the apparatus that comprises the portion for the watering can to be positioned on, (in the water catching position). However, it should be stated, other embodiments are possible. For example, looking at the example of FIG. 20, example sub-portions 84L and 84R are substantially horizontal (ie ‘flat’, here). The underside of example part/apparatus 33, in the example, is also substantially flat. However, an embodiment could be provided, for example, where example sub-portion 84L, for example, in angled inwardly. (Thus it could have an inwardly angled face). So the same, on the other side, may be the case for sub-portion 84R. A portion or a whole of each side of example part/apparatus 33 could than have (reverse) inwardly angled sides, (part/apparatus 33 becoming ‘narrower’, downwardly there). Thus, when part/apparatus 33 is in position, (such as as shown in FIG. 17, for example), the angled nature of the sub-portions and angled nature of a portion or a whole of sides of part/apparatus 33 would have much the same effect of allowing a user, in picking up part/apparatus 35, to also pick up part/apparatus 33, which would be prevented from falling through part/apparatus 35 by the sub-portions. Thus this would be another example of wherein the water catching apparatus comprises a portion that goes under the apparatus that comprises the portion for the watering can to be positioned on. (It would also be another example of wherein the water catching apparatus comprises a portion that protrudes under one side of the apparatus that comprises the portion for the watering can to be positioned on, and a portion that protrudes under the other side of the apparatus that comprises the portion for the watering can to be positioned on, (FIG. 19 already clearly having shown an example of this)). (It would thus be another example of wherein the water catching apparatus comprises a portion that protrudes under a portion of the apparatus that comprises the portion for the watering can to be positioned on, and another portion that protrudes under another portion of the apparatus that comprises the portion for the watering can to be positioned on, (FIG. 19 already clearly having shown an example of this)). (Broadly stated, it would be another example of there being provide a portion(s) under part/apparatus 33). (It would be another example of there being provide a portion(s) under a positioning part of the water catching apparatus). Again, this would help the user to pick up both parts, (part/apparatus 33 and part/apparatus 35), by virtue of the fact that part/apparatus 33 would stay in position, if part/apparatus 35 is lifted. Thus various options and/or embodiments are possible

(In the example embodiment, an underside of portion 84 provides a portion of an underside of the water catching apparatus. (In the example embodiment, a portion or a whole of an underside of example portion 84 engages with the ground, when the apparatus is on the ground. (Thus it is an example within a scope of wherein a portion or a whole of the underside of portion 84 provides a portion or a whole of the underside of the water catching apparatus that engages with the ground, when the apparatus is on the ground))).

FIG. 20 shows an almost identical embodiment to the embodiment of FIG. 19, but now showing how portion 84 can be provided by way of ‘sub-portions’. (Sub-portions 84L and 84R are shown). Nevertheless, this still has much the same result, in terms of facilitating part/apparatus 33 being picked up together with part/apparatus 35, (eg to move it), when part/apparatus 35 is picked up. (It should be noted, the sub-portions may themselves comprise sub-portions, (which may be referred to as ‘sub-sub-portions’), (eg portion 84L may itself be provided by way of three, (or any number, for example) protruding portions that protrude to the right, (not dissimilarly to how example portion 84L is shown protruding to the right), but nevertheless doing much the same job. (So the same for portion 84R)). Note: It should be stated, a benefit of the embodiment of FIG. 19 is that the water catching apparatus can have a flat underside, (provided in one part). This can stop water and/or pests, (eg insects), from getting underneath the water catching apparatus. In the embodiment of FIG. 18, such a design make it more likely water, (eg from rain), and/or insects, etc could get underneath the apparatus. Preferably, the underside of the apparatus is flat, (and provided in one part), to help protect against this. (It should be noted, looking at FIG. 18, with reference to FIG. 17, with example part/apparatus 33 is position, even if the base of the water catching apparatus is flat, any gap(s) between example part/apparatus 33 and example part/apparatus 35 may allow for water and/or insect(s) etc to get underneath the apparatus. (This may also be more likely to occur if part/apparatus 33 is removed, for any reason, thus giving the opportunity, (during the time it is removed), for water and/or insects, etc, to get under the water catching apparatus, (ie into the area that will under the part/apparatus 33, when it is put back in place).

With reference to the issue of water and/or insects, etc getting under the water catching apparatus, whilst complete flatness of an underside of the water catching apparatus is ideal, it should be stated that an underside of the water catching apparatus being flat, around the perimeter of the underside of the water catching apparatus, is of particular importance, since, if this is achieved, even if the underside of the water catching apparatus is ‘raised’ within the perimeter, the fact that the perimeter of the underside of the water catching apparatus is flat, (and is flat to a ground surface it is positioned on), can be enough, to stop water and/or insects, etc getting under the water catching apparatus. Thus preferably an underside of the water catching apparatus is flat. Preferably most of the underside of the water catching apparatus is flat. Preferably all of the underside of the water catching apparatus is flat.

FIG. 21 shows an extremely similar embodiment to the embodiment(s) of FIGS. 15-20, but showing an embodiment that is more ‘curved’ in shape, (rather than cubic).

FIG. 22 shows a basic depiction, (from a raised side view), of the embodiment of FIG. 15, in use, (but not showing any plant(s), (similarly to FIG. 16), (and thus not showing the example blocking arrangement), showing the watering can in a water catching position. It can clearly be imagined how rainwater would fall off the side 101 of the example roof 103 of the example building 107, and into the watering can. A dashed shape 86 shows/suggests how another water catching apparatus could be provided, simply showing that users may decide to employ more than one water catching apparatus, potentially for the same roof side. (It should also be stated, broadly, that more than one water catching apparatus could be used for one building, (not limited to them being used for the same roof side. (For example, one or more could be employed for rain falling off one side of the building/roof, with one or more employed for another side(s) of the building/roof)).

FIG. 23 shows a significantly different embodiment of a water catching apparatus 10. It still shows a blocking arrangement, comprising a front blocking portion 14F. It also shows example planting areas 52. However, in the example shown, any plant(s) planted in the planting area(s) do not play a blocking role. They are purely ornamental, in the example. (Plants(s), (whether fake or real), can still play a role, (aesthetically), in blending the apparatus in to its surroundings, (and/or simply provide aesthetic value). In the example, the front blocking portion 14F is of such height that, at its highest point, it is higher than a highest point of the watering can. Thus even plant(s) in the example higher planting area(s) are not needed, to block view of the watering can. Thus they are not, in the example embodiment, playing a blocking role. (Thus this is an example of wherein the blocking arrangement comprises a planting area(s), (but wherein a plant(s) planted in the planting area(s) does not play a blocking role)). (Thus, what is shown in FIG. 23 is an example of wherein the front blocking portion comprises a planting area(s), (but wherein a plant(s) planted in the planting area(s) does not play a blocking role)).

FIG. 24 shows an example very similar to that of FIG. 23, from a top view. (In the example, the example watering can is facing backwards. However, in other embodiments, there may be room for it to face more sideways, (eg akin to in many other of the Figures/embodiments). (It is shown that, in the example embodiment, the blocking arrangement comprises a left blocking portion 14L and a right blocking portion 14R). In the example, the front blocking portion 14F comprises a planting area(s), (but wherein a plant(s) planted in the planting area(s) does not play a blocking role). In the example, (provided simply by way of example only), the left blocking portion 14F comprises a planting area(s), (but wherein a plant(s) planted in the planting area(s) does not play a blocking role). In the example, the right blocking portion 14R comprises a planting area(s), (but wherein a plant(s) planted in the planting area(s) does not play a blocking role). It can be seen that, in the example, the embodiment comprises a protruding portion(s) 88 that comprises a planting area(s) 52. (In the example embodiment, the front blocking portion comprises a protruding portion(s) 88 that comprises a planting area(s). It is also shown, (albeit in dotted lines), how the left blocking portion and/or the right blocking portion may comprise a planting area(s), (but wherein a plant(s) planted in the planting area(s) does not play a blocking role). (In the example embodiment, the left blocking portion comprises a protruding portion(s) 88 that comprises a planting area(s). In the example embodiment, the right blocking portion comprises a protruding portion(s) 88 that comprises a planting area(s)). (Note: There being shown/provided ‘protruding portion(s)’ 88 is shown by way of example only, and is simply a possible design/option). The example shown is shown by way of example only).

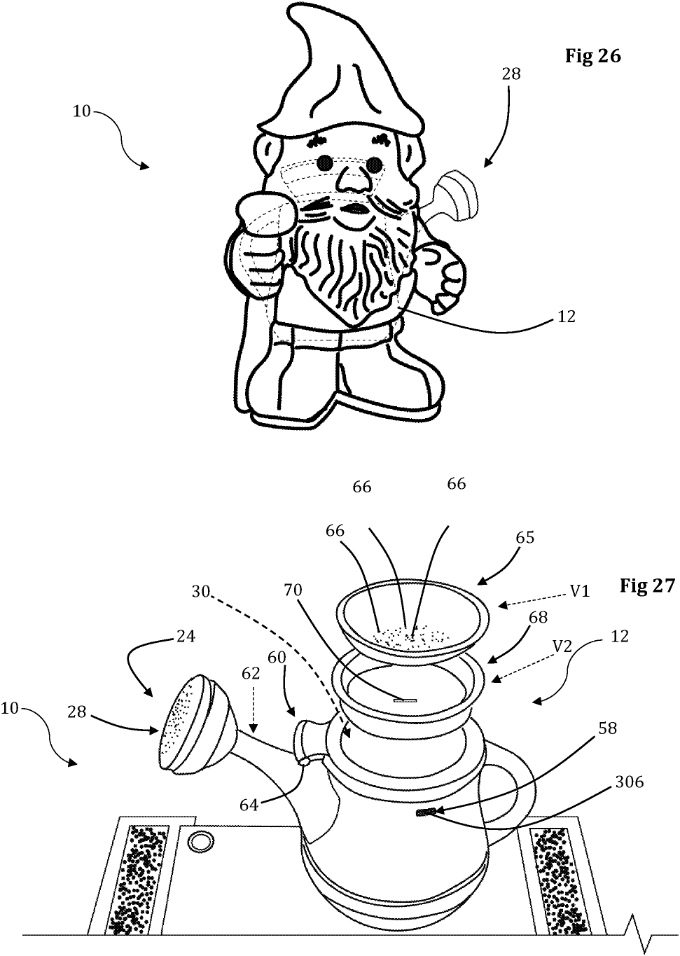

In FIG. 25, an example is shown wherein the blocking arrangement comprises a frog figure. (In the example, a ‘frog king’ is depicted). A ‘frog’ figure is just one type of figure, and it should be stated, the blocking arrangement may comprise any figure(s), not limited to a frog figure. For example, in FIG. 26, the blocking arrangement comprises a gnome figure. In both FIGS. 25 and 26, a sprinkler head 28 of the example watering can(s) can be seen, (not blocked from view, from the front view, by the blocking arrangement). Nevertheless, both are examples of wherein a whole of a main body of the watering can is blocked from view, (from the front view). Both are also example of wherein more than half of the watering can is blocked from view, (from the front view). Both are also examples of wherein more than three quarters of the watering can is blocked from view, (from the front view).

FIG. 27 shows an exploded view of the example watering can, (and, more specifically, an exploded view of the example input point 30). (The example water input point of the example watering can is now more clearly shown, with example features shown, ‘exploded’, above it). (It is also a cut-off view, with a portion of the example water catching apparatus 10 not shown). It shows an example of wherein there are two ‘levels’ that comprise an aperture(s).

(A ‘level’ may also be referred to as a ‘layer’). The first ‘level’, (labelled ‘L1’, in the example), is shown comprising a plurality of apertures 66. In the example, the apertures are of a small size. It is thought this may deter mosquitoes, for example, from getting through. However, in case any mosquitoes get through this ‘layer’/’level’, there is another level, (labelled ‘V2’, in the example), below it. In the level below it, there is shown an example aperture 70, (although it should be stated, in other embodiments, there may be more than one aperture 70). In the example, the aperture is relatively ‘slit’-like. It is relatively narrow. Intent is that, if a mosquito gets through the first level, they are then unlikely to get through the second level. Then the/a standard input point 30 is shown, (which is shown to be a much larger opening). (Despite what is shown, it should be stated, it is feasible an embodiment could be provided that comprises only one ‘level’. For example, there may be an aperture arrangement, (eg mesh), that in-and-of-itself is able to prevent mosquitoes getting through. In that case, only one ‘level’ may be required, (Even if simply a mesh, for example, is provided, over the/a standard input point 30, this is considered, for the sake of the present application, to be a ‘level’/’layer’). Thus whilst parts such as those shown for the first level L1 and/or second level V2 may be provided, it should be stated, more basic embodiments may be provided, (and/or that rely less such parts, (ie do not comprise such parts), as shown). For example, a mesh, for example, could be attached in place. (Such a mesh could be attached on an outside of the input point 30, for example. (Such a mesh could be attached on an inside of the input point 30, for example. (Note: It should be stated, the watering can may comprise a mosquito-proof aperture arrangement, to stop mosquitos getting to water stored in the watering can, via the output point of the watering can.

(Note: In FIG. 27, a dashed line, with number ‘30’, (the number for the water input point of the watering can, points to an example large opening at the top of the example watering can, (similar to the water input point many watering cans have, (often having a (large) opening like this at their top). Whilst this is pointed to with the number ‘30’, it should be stated, in use, when the two example levels V1 and V2, for example, are in position, they are considered to be part of the water input point of the watering can. However, in an exploded view, (such as that shown), it seems appropriate to number the example large opening revealed, (even if it be with a dashed arrow), in such a way).

In FIG. 28, another (similar) embodiment is shown, in an exploded view. An example first ‘level’, (labelled ‘V1’, in the example), is shown, (and arrow A1 points towards a depiction of that feature, but now shown from a top view). In the example, (provided by way of example only), a plurality of apertures 66 are shown, from the top view). An example second ‘level’, (labelled ‘V1’, in the example), is shown, (and arrow A2 points towards a depiction of that feature, but now from a top view). In the example, (provided by way of example only), a single aperture 70 is shown, from the top view, (although it should be stated, in other embodiments, there may be more than one aperture 70)). In the embodiment of FIG. 28, an example mosquito-proof aperture arrangement 206 is also shown, in the example embodiment. In this example, this, in use, covers/blocks example aperture(s) 70. (For example, it may attach to the part above it, under example aperture(s) 70). (For example, it may attach to the part above it, above example aperture(s) 70). It therefore stops anything getting through that is unable to get through the mosquito-proof aperture arrangement 206.

(Note: In the example, because there is no ‘gap’ between example aperture 70 and example mosquito-proof aperture arrangement, in the example, it is considered that example mosquito-proof aperture arrangement is part of the ‘second level/layer’). The apertures of the example mosquito-proof aperture arrangement are of such small size that they prevent mosquitoes from getting through. Thus mosquitoes are prevented from getting into the (water storage area of the) watering can. (It should be stated, in other embodiments, simply a mosquito-proof aperture arrangement may be provided. Thus the other features shown may not (need to be) provided). (It should be stated, if there are a plurality of apertures for the mosquito-proof aperture arrangement to cover/block, there may either be provided one ‘piece’ of mosquito-proof aperture arrangement or there could be provided more than one ‘piece’ of mosquito-proof aperture arrangement. (These may be referred to as ‘mosquito-proof aperture arrangement portions’).

In FIG. 31, it is denoted that the watering can may comprise an openable and closable water output point. Two possible closing elements 96 are shown, (example closing element 96a and example closing element 96b). Showing two possible embodiments is not intended to suggest them both being used simultaneously- both are shown simply to show two different options/embodiments. Example closing element 96a shows a basic embodiment, which can simply be removed, (when the user wants to use the watering can for watering). It may be removably attachable, (eg it may screw into place, or may ‘click’ into place, or may be magnetically removably attachable, for example). However, rather than being removably attachable, it may simply stay in place, (covering the water output point 24), due to its shape fitting in position, (eg its shape generally fitting around the example sprinkler head 28, in the example, for example). (If the shape fits tightly enough, this may facilitate it being ‘removably attachable’. But it may not be tight, and may be generally held in place, due to its shape generally fitting to the watering can, in a position where it covers the water output point. Example closing element 96b denotes an example where the closing element stays attached to the watering can, when the water output point is in an open mode. In the example, it remains attached via example feature 98. (This feature may be plastic, or the like, for example, (or any relevant/suitable material(s))). The embodiment/design shown is shown by way of example only. In the example, example closing element 96b can be rotated, between the closed mode and the open mode of the water output point. Embodiments may be provided where the closing element can be held in position, when in an open position. In the example, it can be held in an open position. (In the example, (provided simply by way of example only), it clips to example feature 100, to keep it in the non-covering position). Embodiments may be provided where the closing element can be held in position, when in a closed position. In the example, provided simply by way of example only, the example closing element 96b can be clipped into the closed position via clipping features 102 and 104. Various options and/or embodiments are possible for an openable and closable water output point, (and/or for a closing element). (It should be stated, it will be apparent that the water output point of the watering can may be openable and closable, whether or not the water output point comprises a sprinkler head. Thus a water output point may be provided where there is no sprinkler head, and where the water output point is openable and closable. For example, there could be no sprinkler head, (and instead there could be just a (fairly large) output aperture, for example, and there could be a closing element, to facilitate the water output point being openable and closable. Thus various options and/or embodiments are possible.

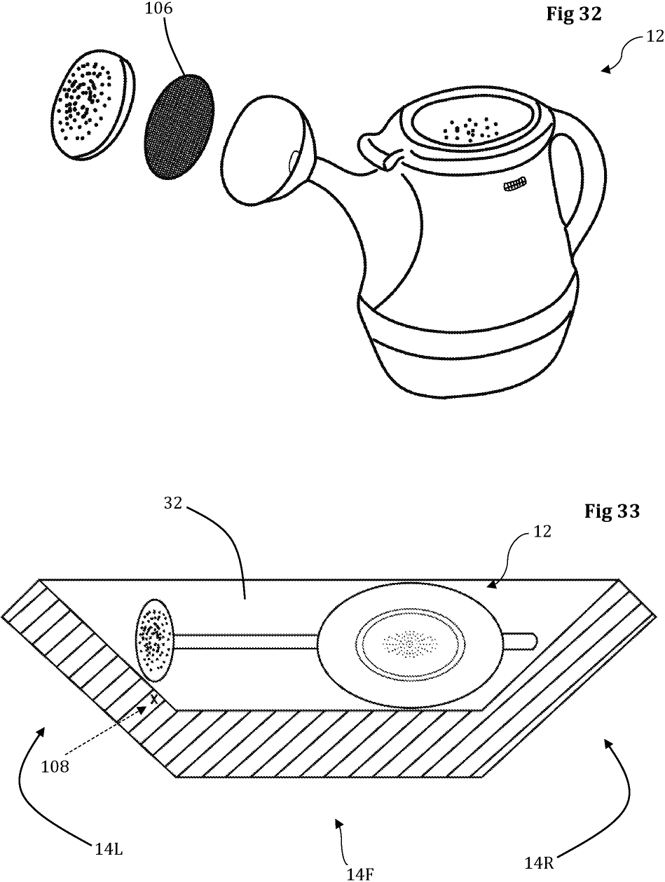

The water output point being openable and closable can be extremely useful, to prevent mosquitos, for example, from getting into the watering can, via the water output point. An example of another way to prevent this is shown in FIG. 32. FIG. 32 shows a basic exploded view of an example water output point. The example sprinkler head is shown in an exploded view. It is shown that there is a mosquito-proof aperture arrangement 106. By virtue of this, in the example, mosquitos are prevented from getting to water stored in the watering can, (via the water output point). In the example, the mosquito-proof aperture arrangement is netting. The netting comprises a plurality of apertures that are so small that mosquitos cannot get through them. In the example, (provided by way of example only), the mosquito-proof aperture arrangement is provided on an inside of the example sprinkler head. However, in other embodiments, it may be provided on an outside of the sprinkler head. (For example, it may be attached on an outer side). (It may be provided directly next to the output aperture(s) of the water output point, or it may not). In other embodiments of a mosquito-proof aperture arrangement, rather than being provided by way of netting, more rigid embodiments may be provided, eg a ‘mesh’, (eg metal). It should also be stated that, whilst, in the example of FIG. 32, the mosquito-proof aperture arrangement is provided as a separate part to the aperture(s) of the water output point, in other embodiments, it is feasible the apertures of the mosquito-proof aperture arrangement may themselves be the apertures of the water output point. For example, a water output point may be manufactured to have a plurality of apertures, wherein the apertures are so small that mosquitos cannot get through, thus providing, (and being), mosquito-proof aperture arrangement. (For example, this could be done via plastics manufacturing methods). This would also be an example of the water output point being mosquito-proof).

Looking at FIG. 33, a top view is provided of a basic depiction/representation, similar to what is shown in FIGS. 6-8. An embodiment is shown/denoted. Note: Imagining this embodiment to block view of a whole of the watering can, from the front view, (ie the blocking arrangement being high enough to do so), it should be clearly stated that this, then, would be considered to be an embodiment wherein the blocking arrangement comprises a front blocking portion that blocks view of a whole of the watering can, from the front view. (This is the case, even though, (looking at the left side), part of the example portion of the blocking arrangement that is angled backward, in the example, plays a blocking role in blocking view of the watering can, from the front view. Nevertheless, such an example would be an example wherein the blocking arrangement blocks view of a whole of the watering can, from the front view, and would thus be considered an embodiment wherein the blocking arrangement comprises a front blocking portion that blocks view of the whole of the watering can, from the front view. (It should also be stated that, in the example, an ‘X’ character, (numbered 108), is shown, to denote that there can be an area that is part of the front bocking portion, (that blocks view from the front view), and is part of the left blocking portion, (that blocks view from the left view). Thus there can be ‘overlap’. (So the same is the case for the/a right blocking portion, of course))).

Preferably the watering can comprises an overflow output point. (An example overflow output point 58 is shown in FIG. 16, for example. Preferably, the overflow output point is mosquito-proof. (An example(s) has been shown and/or described of there being a mosquito-proof aperture arrangement. (The term ‘aperture arrangement’ is simply a broad term which means one, or more than one, aperture). In this case, the/a mosquito-proof aperture arrangement comprises a plurality of apertures that are of such small size that mosquitos cannot get through them. (Thus it may simply broadly be stated, (rather than using the term ‘aperture arrangement’), that preferably there are a plurality of apertures that are of such small size that mosquitos cannot get through them)).

It has been made clear it may be desirable for the input point 30 of the watering can to be mosquito-proof. Generally speaking, it has been made clear that the watering can comprising a mosquito-proof aperture arrangement, to stop mosquitos getting to water stored in the watering can, via the input point of the watering can, can be extremely beneficial. (An example embodiment where there is a mosquito-proof aperture arrangement 206 has been shown/disclosed. It should be stated, the example of FIG. 28 is shown by way of example only, and shows a relatively small mosquito-proof aperture arrangement. In other embodiments, a much larger one may be provided. For example, in a basic embodiment of a mosquito-proof input point, there may simply be one, (eg large), input aperture, and there may be a large mosquito-proof aperture arrangement that prevents mosquitos from getting through, (thus stopping mosquitos getting in to the water storage area of the watering can, where they may use the water as a breeding ground). In one embodiment, for example, the mosquito-proof aperture arrangement may be on an outer side of the input point of the watering can. In another embodiment, for example, the mosquito-proof aperture arrangement may be on an inner side of the input point of the watering can. (These characteristics, (eg of being on an ‘inner’ or ‘outer’ side), are relevant to any input or output point, (ie the input point and/or the output point and/or the overflow output point), with reference to the (or any) mosquito-proof aperture arrangement). Furthermore, it should also be stated, rather than being provided as a ‘separate part’, (as shown in the example of FIG. 32, most clearly, (and also the example of FIG. 28), a mosquito-proof aperture arrangement, (and thus, broadly, a plurality of apertures that are of such small size that mosquitos cannot get through them), may be ‘built-in’ to the watering can, (and/or to any part of the watering can). For example, looking at FIG. 13, for example, and the example output apertures 29, if the output apertures 29 are of such small size that mosquitos cannot get through, then that would be an example of the output point being mosquito-proof. It would be an example of a plurality of apertures that are of such small size that mosquitos cannot get through. (And it would be an example of a mosquito-proof aperture arrangement). Any disclosure/characteristics of a mosquito-proof aperture arrangement disclosed with reference to any of the input/output points may be afforded to any other of the input/output points. (Any disclosure/characteristics of preventing mosquitos from getting to water stored in the watering can disclosed with reference to any of the input/output points may be afforded to any other of the input/output points). It should also be stated that, looking at FIG. 32, it is possible, for example, that a mosquito-proof aperture arrangement could be provided quite deep, for example, within the elongate body of the spout of the watering can, (ie not so close to where water actually comes out). This could, nevertheless, prevent mosquitos from getting to water stored in (the water storage area of) the watering can. A primary intent is to stop mosquitos getting to water stored in the watering can, where they may breed. Thus, examples have been disclosed of wherein the watering can comprises a mosquito-proof aperture arrangement, to stop mosquitos getting to water stored in the watering can. Thus, examples have been disclosed of wherein the watering can comprises a mosquito-proof aperture arrangement, to stop mosquitos getting to water stored in the watering can, via the input point of the watering can. Thus, examples have been disclosed of wherein the watering can comprises a mosquito-proof aperture arrangement, to stop mosquitos getting to water stored in the watering can, via the output point of the watering can. Thus, examples have been disclosed of wherein the watering can comprises a mosquito-proof aperture arrangement, to stop mosquitos getting to water stored in the watering can, via the overflow output point of the watering can. (As has been disclosed, in various embodiments, the mosquito-proof aperture arrangement may be provided by way of mesh. As has been disclosed, in various embodiments, the mosquito-proof aperture arrangement may be provided by way of netting. However, these are only example embodiments, as has been made clear. (It is not easy to see the mosquito-proof aperture arrangement of the overflow output point, in the Figures, since the example overflow output point is relatively small. However, in the example embodiment, the mosquito-proof aperture arrangement is preferably provided by way of mesh or netting)).

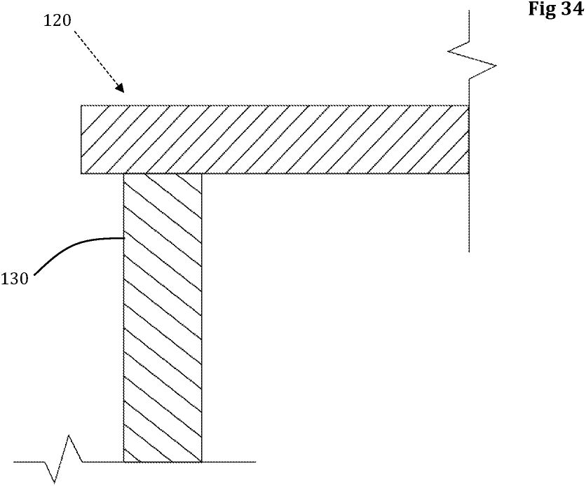

FIG. 21 shows the water catching apparatus, (or any part(s) of the water catching apparatus) may comprise a handle(s) 110. In the example, the handle(s), (provided by way of example only, are similar to brief-case type handles, having an aperture (not visible from the view shown), through which a user can place part of their hand. In the example, the handles can be useful, to help a user raise/lift example apparatus/part 33. (In a different embodiment, example apparatus/part 33 may comprise a lip portion that goes over a portion or a whole of the example border/edge of the example planting area that is next to example apparatus 33. This may help the user lift example apparatus/part 33. The lip portion may even protrude beyond the example border/edge of the example planting area, which may make it even easier to lift/raise apparatus/part 33. (Rather than there just being one lip portion, there may a plurality of lip portions. For example, there may be a left lip portion, and a right lip portion). The (or any) lip portion(s) may comprise feature(s), to help the user in picking up the apparatus/part that comprises the lip portion(s). For example, the (or any) lip portion(s) may comprise a recess(es), (or a protruding portion(s)), to help the user in lifting. Thus various options and/or embodiments are possible. (An example lip portion 120 is shown in FIG. 34, in a cross-sectional cut-off view. It can be seen that the lip portion goes over example border/edge 130 of an example planting area, (eg the example planting area that is next to example apparatus 33, in FIG. 17). In the example, the lip portion protrudes beyond the example border/edge 130 of the planting area. In an embodiment that does not protrude beyond the border/edge, it may, instead comprise a recess that nevertheless helps the user grip it, (so that they can lift apparatus/part 33). In the example, it is a left side lip portion. (There may also be a right lip portion).Thus an example is shown of a lip portion that goes over a portion or a whole of an example border edge, (of a planting area, in the example).

It should be stated, example parts 33 and 35 may, (or may not), themselves comprise a plurality of parts. For example, part 35 may have a left part, (eg for a portion or a whole of the left blocking portion; a right part, (eg for a portion or whole of the right blocking portion); and a front part, (eg for a portion or a whole of the front blocking portion). (This is provided simply by way of example only). If part 35 comprises a plurality of parts, any of the parts may, (or may not), be attachable to each other. Thus, in use, they may, or may not, be attached. (So the same is the case, for part 33). Thus this is broad disclosure, (not limited to the example mentioned, which is mentioned simply to aid understanding), to state that part 33 may itself comprise a plurality of parts. Thus this is broad disclosure, (not limited to the example mentioned, which is mentioned simply to aid understanding), to state that part 35 may itself comprise a plurality of parts. (It should be stated, example part 35 may, for example come in two parts, (rather than three, as mentions in the example. For example, an embodiment could be provided where it has a left part, (for the left blocking portion (and perhaps/potentially also for a portion or a whole of the front blocking portion)), and a right part, (for the right blocking portion (and perhaps/potentially) also for a portion or a whole of the front blocking portion). Thus various options and/or embodiments are possible, and it is simply broadly here stated that example part 35 may, (or may not), itself comprise a plurality of parts. (And it should be stated, looking at Feature 33 in Fig .., if an embodiment of feature 33 was provided wherein it is provided in two halves, (and the two halves attach together, for example, (possibly even joining under where the watering can goes), that, (provided simply by way of example only), would be an example of wherein part 33 is provided by way of a plurality of parts).

Part 33, in the example, (provided simply by way of example only), may be referred to (and/or considered to be), a part relating to position of the watering can. (In the example, the watering can is positioned on the part 33, when in the water catching position).

Part 33, in the example, (provided simply by way of example only), may be referred to (and/or considered to be), a part relating to storage of water. (In the example, it comprise a water storage area).

Part 35, in the example, may be referred to (and/or considered to be), a part relating to the blocking arrangement. (When blocking features are added to part 35, (eg plant(s) planted, and/or Figures placed on top of it, (and/or attached to it), (or whatever blocking feature(s) are used)), they may then be considered to be part of this ‘part’, (ie relating to blocking)

Relating generally to features of the rainwater catching apparatus, (and generally to features disclosed in the present application), it should be stated, various features may be formed as one piece, or, in other embodiments, may be separate parts, (and may, (or may not)), be attachable. Unless otherwise stated, all such options and/or embodiments are possible. For example, looking at FIG. 11, (a portion or a whole of) the portion 32 the example watering can is positioned on may be formed s one part with a (portion or a whole of) the denoted blocking arrangement. (For example, it could all be made of one piece of plastic, for example). However, in other embodiments, they may be separate parts, (and may, or may not, be attachable). For example, if they are separate parts, looking at FIG. 11, the portion 32 the watering can is positioned on may be attached to the blocking arrangement, (directly, or indirectly). For example if the blocking arrangement and the square shape below it, for example, are attached, (eg clipping together, for example), then if the portion 32 the watering can is positioned on is then attached to the square shape, (which may be a front base portion), then that is an example of wherein the portion 32 the watering can is positioned on and the example blocking arrangement are attached, ‘indirectly’, (ie via intermediate feature(s)). In other embodiments, they may be attached directly. Thus it is made clear that various options and/or embodiments are possible.

(Note: Looking at FIG. 15, in an embodiment similar to such an embodiment, for example, it is feasible a spout of the watering can may protrude into, (and may even protrude through), the blocking arrangement, (ie may protrude into, (and may even protrude through) the plants, in the example). Protruding into the blocking arrangement does not preclude the blocking arrangement from blocking (what protrudes into it) from view.

(As stated, a plant(s) may be provided that do not play a blocking role. As stated, fake plants may, or may not, need to be ‘planted’).

(Note: It should be clearly stated, (and is here stated), that when ‘dimension-type’ disclosure/definition is provided, relating to the blocking arrangement, (to block view of a portion or a whole of the watering can), (eg ‘height’, (relative to the watering can), or ‘width/’breadth’, (relative to the watering can)), (or ‘at its furthest point left/right’, (or the like), (or any other ‘dimension-type’ disclosure/definition), an embodiment that is ‘operable’ with such disclosure/definition being the case, (even if it also includes an option whereby such disclosure/definition is not the case), is considered to be within a scope of what is a claim, for example, that defines that disclosure/definition. An example of this has been explored, with reference to an embodiment wherein there is a ‘curved surface’ for the watering can to be positioned on, (in the water catching mode), where, when the watering can is on a portion of the curved surface, (eg a ‘high’ portion), the front blocking portion of the blocking arrangement, at its highest point, is not equal to or higher than height of half height of a main body of the watering can, but wherein, when the watering can is on another portion of the curved surface, (eg a ‘low’ portion), the front blocking portion of the blocking arrangement, at its highest point, is equal to or higher than height of half height of a main body of the watering can, and how this, for the sake of the present application, is deemed within a scope of wherein the front blocking portion, at its highest point, being equal to or higher than height of half height of a main body 16 of the watering can, in a water catching mode. To give another example, to explain this, looking at the embodiment of FIG. 6, as it is shown, the blocking arrangement, at its furthest point back, is not as far back as, or further back than, the main body of the watering can, (and is not as far back as, or further back than, the watering can). However, if an embodiment such as this is provided, and the watering can can be moved, (eg pushed closer to the denoted front blocking portion, in the example), such that the blocking arrangement, at its furthest point back, is as far back as, or further back than, the main body of the watering can, then that would be an embodiment within a scope of wherein the blocking arrangement, at its furthest point back, is as far back as, or further back than, the main body of the watering can, because it, (ie the example rainwater catching apparatus), is ‘operable’, (ie ‘usable’), with that definition being the case. Similarly, if the embodiment of FIG. 8 was shown with the watering can slightly hanging over the edge of portion 32, such that the blocking arrangement, at its furthest point back, is not as far back as the main body of the watering can, it would still be an example within a scope of wherein the blocking arrangement, at its furthest point back, is as far back as, or further back than, the main body of the watering can, because it is an embodiment that is ‘operable’ with the blocking arrangement, at its furthest point back, being as far back as, or further back than, the main body of the watering can, (as clearly shown, in FIG. 8). (It should also be stated that an embodiment such as that of FIG. 16, for example, which is configured to keep the watering can in a position, (and which, in the embodiment, comprises a positioning system, (as shown, with clarity, in FIG. 17), to keep the watering can in a position which, in the embodiment shown, results in/means that the blocking arrangement, at its furthest point back, is as far back as, or further back than, the main body of the watering can, is also, of course, within a scope of wherein the blocking arrangement, at its furthest point back, is as far back as, or further back than, the main body of the watering can, (and is, of course, an embodiment that is ‘operable’ with the blocking arrangement, at its furthest point back, being as far back as, or further back than, the main body of the watering can. Thus, to state clearly, if there is only one ‘option’, and the blocking arrangement, at its furthest point back, is as far back as, or further back than, the main body of the watering can, in that option, then that is also within a scope of wherein the rainwater catching apparatus is ‘operable with’ the blocking arrangement, at its furthest point back, is as far back as, or further back than, the main body of the watering can. (It should also be stated, for any such disclosure/definition provided in the present application, the term ‘operable with’ may be used, with such disclosure/definition).

According to another aspect of what is invented, there is provided a system for catching rainwater from a roof, comprising: a watering can, positioned under a side of the roof, in a position suitable for catching rainwater that falls off the side of the roof, the watering can thus being in a water catching position; and a blocking arrangement, to block view of a portion or a whole of the watering can, from a front view.

According to another aspect of what is invented, there is provided: an apparatus, comprising: a watering can 12; an apparatus/part that comprises an area to input water into, the apparatus not being the watering can; and a positioning system, to keep the watering can in a position. (It will be apparent that various examples of this are shown in the Figures, (FIGS. 11-22 being particularly relevant.

(Various examples are shown in the Figures of wherein the position is an upright position. (Examples have been explored, wherein the position is an upright position, there thus being provided: an apparatus comprising: a watering can; and an apparatus/part that comprises an area to input water into, the apparatus not being the watering can; and a positioning system, to keep the watering can positioned in an upright position). (Thus various examples are shown in the drawings of a positioning system, to keep the watering can in an upright position)). (Examples have been explored of the watering can being kept in a desired position, there thus being provided: an apparatus comprising: a watering can; and an apparatus/part that comprises an area for inputting water into, the apparatus not being the watering can; and a positioning system, to keep the watering can positioned in a desired position). (As can be seen in the Figures, preferably the position of the watering can is a position on the apparatus/part that comprises the area for inputting water into, the positioning system configured to keep the watering can on the apparatus that comprises the area for inputting. (An example of this is clearly seen in all the embodiments of FIGS. 11-22, for example, where there is a positioning system, for positioning the watering can on an apparatus, (a portion or a whole of a main body of the watering can, from a top view, being within a perimeter of the apparatus it is positioned on). (Various examples are shown/alluded to, in use, in the Figures, wherein the position is a water catching position. (FIG. 22 is perhaps a best example of this).

(Examples have been explaored wherein the position is a water catching position, (for catching rainwater that falls off a side of a roof), there thus being provided: an apparatus comprising: a watering can; and an apparatus/part that comprises an area for inputting water into, the apparatus not being the watering can; and a positioning system, to keep the watering can positioned in a water catching position, (for catching rainwater that falls off a side of a roof)).

(As already explained, it may be possible for the positioning system to allow for movement of the watering can. (For example, it has been explored that it may be possible for a positioning system to allow for significant sideways (ie left/right) movement of the watering can, but still nevertheless keeping it in the water catching position.). However, preferably little or (substantially) no movement is possible. Preferably the watering can is kept in a stationary position. (Preferably the positioning system is configured to prevent the watering can from moving more than 50 cm forward/back. Preferably the positioning system is configured to prevent the watering can from moving more than 50 cm left/right. Preferably the positioning system is configured to prevent the watering can from moving more than 40 cm forward/back. Preferably the positioning system is configured to prevent the watering can from moving more than 40 cm left/right. Preferably the positioning system is configured to prevent the watering can from moving more than 30 cm forward/back. Preferably the positioning system is configured to prevent the watering can from moving more than 30 cm left/right. Preferably the positioning system is configured to prevent the watering can from moving more than 20 cm forward/back. Preferably the positioning system is configured to prevent the watering can from moving more than 20 cm left/right. Preferably the positioning system is configured to prevent the watering can from moving more than 10 cm forward/back. Preferably the positioning system is configured to prevent the watering can from moving more than 10 cm left/right. Preferably the positioning system is configured to prevent the watering can from moving more than 5 cm forward/back. Preferably the positioning system is configured to prevent the watering can from moving more than 5 cm left/right. Preferably the positioning system is configured to prevent the watering can from moving more than 2 cm forward/back. Preferably the positioning system is configured to prevent the watering can from moving more than 2 cm left/right. Preferably the positioning system is configured to prevent the watering can from moving more than 1 cm forward/back. Preferably the positioning system is configured to prevent the watering can from moving more than 1 cm left/right. (It is possible the positioning system is configured to prevent watering can from moving even 1 cm forward/back. It is possible the positioning system is configured to prevent watering can from moving even 1 cm left/right.

Preferably the position the watering can is kept in is a position wherein the watering can is positioned on top of the apparatus that comprises the area to input water into. (Looking at the examples, it can clearly be seen that, in the water catching position, (for example), (eg now looking at FIG. 16, for example), a portion or a whole of a main body of the watering can, from a top view, is within a perimeter of the apparatus that the watering can is positioned on). (Various examples are shown of this in the drawings). (Various examples are shown of wherein the position the watering can is kept in is a position wherein the watering can is positioned on top of the apparatus that comprises the area to input water into, and a whole of a main body of the watering can is within a perimeter of the apparatus that comprises the area to input water into, from a top view).

Preferably the positioning system facilitates keeping the watering can positioned in the position via mating. ‘Mating’ is here defined as there being a ‘male’ feature that is received by a ‘female’ feature. (Various examples of this have been explored, in a significant amount of detail, (and an example(s) of this is most demonstrably shown in FIGS. 11-14, and FIG. 17))

It is possible the positioning system comprises the watering can being removably attachable to the apparatus that comprises the area for inputting water into. (An example of this is shown in FIG. 14, and has been explored). Note: Both ‘indirect’ attachment and ‘direct’ attachment is possible. For example, the watering can be removably attachable to the apparatus that comprises the area to input water into, ‘directly’. But, if, for example, there is another feature that is attached, (eg removably attachably), to the apparatus that comprises the area to input water into, and the watering can is removably attachable to that feature, this is considered to be the watering can being removably attachable to the apparatus that comprises the area to input water into, ‘indirectly’, and this is also considered to be within a scope of the watering can being removably attachable to the apparatus that comprises the area for inputting water into.

The positioning system may comprise a blocking arrangement, to block movement of the watering can, to keep the watering can in the position, relative to the apparatus that comprises the area for inputting water into.

Various examples are shown of wherein the area to input water into is an internal area.

Preferably the area to input water into is a water storage area that is operable in a closed mode, where water cannot escape.

Example(s) are shown of wherein water is in the area to input water into, (to help keep the watering can in the position, due to weight of the water).

Various examples are shown of wherein the position is a water catching position, for catching rainwater off a side of a roof, the watering can being under the side of the roof, in a position suitable for catching rainwater that falls off the side of the roof.

According to another aspect of what is invented, there is provided: a rainwater catching apparatus 10, comprising: a watering can 12; and a blocking arrangement 14, to block view of a portion or a whole of the watering can 12.

According to another aspect of what is invented, there is provided: a watering can, comprising a water storage area; and an output point 28. (The output point may also be referred to as a ‘water output point’). (Various examples of this are shown in the Figures, with the example watering can(s) being apportioned the number ‘12’). Various examples are shown of the watering can comprising a handle 26. (It will be apparent that various different types and/or designs of handle may be provided). Various examples are shown of the watering can comprising an input point 30. (The input point may also be referred to as a ‘water input point’). (It is shown in various Figures, (and simply by virtue of the nature of the disclosure of the present application), that rainwater than falls off the side of a roof can be ‘caught’ by the watering can, travelling into the watering can via the input point). Various examples are shown of the watering can comprising a spout body 20. Preferably the watering can comprises a sprinkler head 28. The watering can may comprise an overflow output point 58. This may be helpful/important, to stop the watering can overflowing. (Dependent on various aspects, (eg such as design/shape/nature of the input point of the watering can, (and/or of feature(s) surrounding the watering can)), the watering can overflowing with water may lead to standing water forming. This, (in certain environments), may attract pests, such as mosquitos, for example. (Furthermore, overflow of water may not be desirable for other reasons, (eg making water spillage, (when the user moves/picks up the watering can), more likely, (and/or even making the watering can heavier than desired, (eg if the watering can has a fairly large capacity))). Thus the/a overflow output point may be useful/important.

Looking now at FIG. 27, there is shown an example watering can 12, comprising a main body, (the main body itself comprising a water storage area, for storing water); and an output point, (for outputting water out of). The example is shown comprising an example handle. The example is shown comprising an input point 30, (for inputting water into the watering can). Water can go into the watering can, through the example input point, be stored in the example water storage area, and be outputted via the example output point 24. (It will be noted that the embodiment has a handle designed/positioned so that it does not get in the way of water that has fallen off of a roof falling into the watering can, through the input point. Many watering cans have handles that ‘loop’ over the top of the watering can, and would therefore at least partially block water that has fallen off the roof from going into the watering can. The example shown in FIG. 26 does not suffer from this problem).

Preferably the watering can comprises an overflow output point 58. (Thus the example has both a water input point, and also comprises an overflow output point). The overflow output point is an output point that allows water to escape from the watering can. This may be important, especially when the apparatus/system is used in territories where creatures such as mosquitos, (ie any creatures that may breed and/or use areas of standing water). It allows for water to escape, rather than starting to ‘back up’ at the water input point. If the water ‘backs up’ at the water input point, then, (dependent on nature of the design of the watering can/input point), it may create area(s) of standing water. (For example, if the input point of the watering can is curved inwardly, downwards, it may well be that if water ‘backs up’ to the input point, (ie if too much water gathers in the watering can), then it may create an area(s) of standing water). Again, this could attract mosquitos, etc, which are well known to breed, at areas of standing water.

Preferably the watering can comprises a mosquito-proof aperture arrangement, to stop mosquitos getting to water stored in the watering can, via the overflow output point. (An example mosquito-proof aperture arrangement 306 is shown (and denoted) in FIG. 27, for example, (but it is not easy to see, due to the example overflow output point 58 being fairly small, (and due to the denoted apertures of the mosquito-proof aperture arrangement also being significantly small). (One of the purposes of such an aperture arrangement is to stop mosquitos, etc, from being able to get in, and ‘access’ the water in the watering can, (which, as stated/mentioned, may lead to the mosquitos using the water, to breed)). The aperture arrangement, in the example, comprises many apertures. The apertures are extremely small, so that mosquitos, etc, are prevented from being able to get in, (ie due to the apertures being too small for them to be able to get through). The (or any) aperture arrangement(s) may be provided as/by way of a separate part, or may be ‘built in’ to the watering can. In the example embodiment, the aperture arrangement is preferably provided as/by way of a separate part. It is preferably removably attachable to the watering can. For example, it may have a (preferably rubber/plastic) outer portion, which allows it to be ‘snapped in place’, for example, (preferably on an inner side of the water overflow output point, (although it could feasibly be on an outer side of the water overflow output point)). In the example embodiment, the aperture arrangement is provided by way of mesh. It may, for example, be a metal mesh. (However, the mesh may be made out of any relevant material(s)). Thus an example, (provided simply by way of example), is provided, of a water overflow output point. (And an example, (provided simply by way of example), is provided, of an mosquito-proof aperture arrangement, for the/a water overflow output point, to stop mosquitos getting to water stored in the watering can, via the overflow output point).

There may be gap(s) in the blocking arrangement. (This is/may be particularly relevant when plant(s) are used, for blocking. However, there may be gap(s), whatever is used for blocking. For example, there could be a blocking arrangement similar in nature, for example, to the example of FIGS. 23 and 24, but with a gap, (eg a hole), in the front blocking portion, for example, (and/or the left blocking portion and/or the right blocking portion. (There could be a gap(s) for any reason- eg due to a design decision). (Examples are shown, however, within a scope of wherein, from the front view, (in front of the watering can), there are no gap(s) ten centimetres across, or more. Examples are shown within a scope of wherein, from the front view, (in front of the watering can), there are no gap(s) five centimetres across, or more. Examples are shown within a scope of wherein, from the front view, (in front of the watering can), there are no gap(s) two centimetres across, or more. (Instead of, (or on top of), the measurements of ‘ten’ centimetres, ‘five’ centimetres, and ‘two’ centimetres, the measurements ‘nine’, ‘eight’, ‘seven’, ‘six’, ‘four’, ‘three’ and ‘one’ may be used).

(Examples are shown wherein, from the front view, (in front of the watering can), there are no gaps in the blocking arrangement). (Examples are shown within a scope of wherein, from the left view, (in front of the watering can from the left view), there are no gap(s) two centimetres across, or more. (Instead of, (or on top of), the measurements of ‘ten’ centimetres, ‘five’ centimetres, and ‘two’ centimetres, the measurements ‘nine’, ‘eight’, ‘seven’, ‘six’, ‘four’, ‘three’ and ‘one’ may be used). (Examples are shown wherein, from the left view, (in front of the watering can from the left view), there are no gaps in the blocking arrangement). (Examples are shown within a scope of wherein, from the right view, (in front of the watering can from the right view), there are no gap(s) two centimetres across, or more.

(Instead of, (or on top of), the measurements of ‘ten’ centimetres, ‘five’ centimetres, and ‘two’ centimetres, the measurements ‘nine’, ‘eight’, ‘seven’, ‘six’, ‘four’, ‘three’ and ‘one’ may be used). (Examples are shown wherein, from the right view, (in front of the watering can from the right view), there are no gaps in the blocking arrangement).

The example watering can is shown comprising a front protruding portion 60. The example front protruding portion can be useful, to help the user lift up, (and even possible, to use the watering can, (ie holding the front protruding portion, to aid in lifting and balancing), to water plant(s)). This may be particularly useful/important, if the watering can is of a significant size, (and thus able to hold a significant amount of water). Looking at FIG. 8, for example, (shown from a top view), the watering can, if significantly full, may be heavy to lift up. A user can thus grab the handle with one hand, and grab under the example front protruding portion, to help them lift the watering can. (As stated, it may also help for them to use the front protruding portion when watering plants, to help balance the watering can, as they do the watering). In the example embodiment, the front protruding portion is shown provided around a top of the watering can. (In the example, it is shown provided around the rim, in the example). However, in other embodiments, it may not be in this exact position. For example, it could be provided slightly lower. (It is even feasible a protruding portion could be provided that protrudes backwardly, from the spout body, (eg at around point 62, for example), and that this could do much the same job, as previously described with reference to the front protruding portion. (Note: Such as ‘backwardly’ protruding portion could still be considered a front protruding portion, since it is still at the ‘front’ of the watering can, but simply protrudes backwards, rather than forwards. (Thus the example shown is an example of a ‘forwardly protruding’ front protruding portion))). (In the example embodiment, the example front protruding portion comprises a portion 64 that is downwardly protruding. This allows the user to have more grip/’purchase’, when trying to use the protruding portion. (Any protruding portion may comprise such a feature(s), not limited only to the example front protruding portion shown).

Still looking at FIG. 27, an example water input point 30 is clearly shown. Preferably there is provided a level V1 that comprises at least one aperture. The (or any) level(s), (that comprise at least one aperture), may be provided as a separate part, or may be ‘built in’ to the watering can. In the example embodiment, level V1 is provided as a separate part. (Preferably this is the case). It may be removably attachable to the watering can. For example, it may have a (preferably rubber/plastic) (outer) portion, which allows it to be ‘snapped in place’, for example. However, it may simply ‘lay’ in place. Example level V1 can be seen comprising a plurality of apertures 66. (Thus it is within a scope of comprising ‘at least one aperture’). This is intended to deter mosquitos, etc, from getting to the water in the watering can, (where they may breed). In one embodiment, level V1 may have apertures of such a small size, such that mosquitos cannot get through. (This would be an example of a mosquito-proof aperture arrangement). However, it is feasible the apertures may not be so small that a mosquito cannot get through, but may at least provide a level of protection, (from mosquitos), by at least making it less likely a mosquito gets through, (simply by the fact the water storage area is heavily ‘covered’/’hidden’ by example feature 65). However, if the holes are not so small as to prevent mosquitos from getting through, it is feasible another level/‘layer’ of protection may be required. With this in mind, in the example of FIG. 27, there is shown another level V2. (In the example, level V1 is provided by feature 65, and level V2 is provided by feature 68. However, it should be stated, in other embodiments, levels V1 and V2 may be provided by one part). Level V2, (the ‘second level’), is also shown comprising an aperture(s) 70. (In the example, there is just one aperture, although there could, feasibly, be more than one aperture). This is designed so that, if any mosquitos get through the first ‘layer’ of aperture(s), (ie level V1, in the example), there is another ‘layer’ of aperture(s), for them to get through, in order to get to the water storage area. Thus this makes it even less likely that mosquitos will get to the water storage area. Thus, broadly stated, this is an example of wherein, for the input point, the watering can comprises: a first level, comprising an aperture(s); and a second level, comprising an aperture(s). (It can be seen that the second level is below the first level). Thus this offers a level of protection against mosquitos etc getting into the watering can, (where they could breed). (It should be stated, whilst the first level, (level V1), (comprising an aperture(s)) and the second level, (level V2), (comprising an aperture(s)) are here shown provided by separate parts, in other embodiments, for example, a single part could comprise both levels. (Another example embodiment of this is shown/denoted in FIG. 27. (Note: Stating that there is a ‘first’ level, and a ‘second’ level does not preclude that there could be even more levels that comprise an aperture(s)). One, or both, levels may be provided as a separate part. One, or both, levels may be ‘built in’ to the watering can. (Both levels may be provided together, as one part). (If there are more than two ‘levels’, one, or more than one, (or all) may be provided as a separate part. If there are more than two ‘levels’, one, or more than one, (or all) may be ‘built in’ to the watering can).

(Note: It should be stated, in the present application, if/when the term ‘body’ is used, generally speaking, it allows for the ‘body’ to itself be made up of multiple ‘bodies’. Thus if the term ‘spout body’ is used, it includes within its scope the possibility of the spout body itself being made up of more than one body, (or being made up of just one part/body). (So the same is the case for the word ‘part’, which allows for the possibility of the ‘part’ itself being made up of multiple parts).

According to another aspect of what is invented, there is provided an apparatus, comprising: a watering can; and an apparatus/part comprising a planting area, to plant one, or more than one, plant into. (The apparatus/part may comprise a plurality of planting areas). (It has been shown how plant(s) can be useful in blocking view of a portion or a whole of a watering can).

(What is shown in FIG. 1, for example, is an example of a system for catching rainwater from a roof, comprising: a watering can, positioned under a side of the roof, in a position suitable for catching rainwater that falls off the side of the roof, the watering can thus being in a water catching position; and an apparatus/part comprising a planting area, (to plant one, or more than one, plant into)).

According to another aspect of what is invented, there is provided: a system for catching rainwater from a roof, comprising: a watering can, positioned under a side of the roof, in a position suitable for catching rainwater that falls off the side of the roof, the watering can thus being in a water catching position; and a blocking arrangement, to block view of a portion or a whole of the watering can.

According to another aspect of what is invented, there is provided: a rainwater catching apparatus, comprising: a watering can; and a blocking arrangement, to block view of a portion or a whole of the watering can.

According to another aspect of what is invented, it is here stated that, for any invention invented and/or stated that includes a ‘watering can’, it is here more broadly stated that the broad term ‘water storage apparatus’ may be used, (which includes a ‘watering can’ within its scope), and is, (by virtue of this statement), deemed fully supported. The term ‘water storage apparatus’ is a broad term, and includes within its scope any apparatus used to store water, and would include within its scope, for example, a bucket, or, for example, any ‘generic’ apparatus that can catch rainwater that falls of a roof, not limited to being a watering can. For example, according to this aspect, a ‘tub’, for example, may be used, (as a water storage apparatus).

Any combination of any of the features shown and/or disclosed in the present application may be provided, (to form an invention), and this should be apparent, in light of the nature of the disclosure of the present application. For example, (whether expressly shown and/or textually disclosed, or not), the embodiment of FIG. 24, for example, may comprise a portion 32 for the watering can to be positioned on, (in the water catching position). (This is just one example, but it should be stated clearly again that any of the features shown and/or disclosed in the present application, (eg for one or more embodiment) may be provided (eg for/to any other embodiment(s)), and this should be apparent, in light of the nature of the disclosure of the present application. To make clear, any feature(s)/disclosure afforded to any embodiment(s) may be afforded to any other embodiment(s).

### In Use

An example(s) will now be described in use, described by way of example only, referring to a particularly preferred embodiment(s), in no way limiting a scope of the invention.

Thus, referring in use (by way of example) to a particularly preferred example, preferably water is inputted into the apparatus, into a water storage area(s). (Preferably the (or any) water storage area is internal to the portion 18 that goes under a portion or a whole of the removable water collecting apparatus). This helps to weigh the apparatus down, making it less likely to move, (eg due to heavy winds). Before, or after this, the apparatus is positioned so that rainwater falling off the house, (eg off an edge (eg ledge) of a roof), can be caught by the removable water collecting apparatus. Once rainwater is collected in the removable water collecting apparatus, the removable water collecting apparatus can be removed, to be used to water plants, (eg around a garden). In differing embodiments, it is feasible differing designs/embodiments of blocking arrangement(s) can be used, to blend into (and/or match) the surrounding scenery, (eg of a household garden).

Thus an example has been described, in use. (It should be stated, once again, that the example(s) described, in use, is/are described simply by way of example only, referring to a particularly preferred embodiment(s), and in no way limiting a scope of the invention).

The embodiments described above are provided by way of example only, and various other modifications will be apparent to persons skilled in the art without departing from the scope of the invention as defined in the appended claims.

### Broader And/Or Different Invention(s) May Be Claimed (And Are Supported)

The appended claims define limited inventions. However, it should be recognized and understood that the disclosure of the present application includes a vast array of inventions, not limited to inventions set out in the appended claims and/or any statement(s) of invention.

For example, if the present disclosure of the present application (inclusive of drawing(s) and/or description) discloses features a to z, it should be recognized and understood that any invention may be claimed, comprising any feature(s) out of features a to z. Thus if the appended claim 1 defines the invention claimed as comprising essential features a, b, and c, it should be understood that an invention may be claimed comprising solely feature a, or solely feature b, or solely feature c, or any combination of features a, b, and c. Furthermore, it should be understood that an invention may be claimed comprising any of feature(s) d to z, whether or not also comprising any of features a, b, or c.

Furthermore, no feature disclosed is limited to only being set forth in a claim when used in conjunction with other particular feature(s) it is disclosed with in the specification, but may be claimed with any other feature or combination of features disclosed in the present application. Thus if a feature is disclosed ‘clustered’ with several other feature(s) when disclosed in the specification, the applicant(s) nevertheless reserves the right to ‘extract’ that feature(s) from the several other feature(s) it is disclosed with, and set it forth in a claim, combined with any other feature(s) disclosed in the present application, which other feature(s) may, or may not, also be ‘extracted’ from any other feature(s) they are clustered with in the disclosure of the present application. Thus any permutation/combination of features may be claimed for patent in a future claim and/or patent application.

A final claim is (or may be) appended which serves to signify that I reserve the right to claim any invention (ie ‘thing’), comprising any feature, or combination of features, disclosed in the present application (inclusive of drawing(s) and/or description). This statement (and/or final appended claim), if so desired, should be seen as a statement of invention, stating any invention (ie ‘thing’), comprising any feature, or combination of features disclosed in the present application (in any permutation/combination). The applicant(s) reserves the right to claim any (such) invention (ie ‘thing’), and considers an objection by a patent office/examiner (stating that such an invention is not supported by/disclosed in the present application) to be in direct conflict with this statement of invention. Thank you to the relevant patent office/examiner for taking note of this. It is intended (or plausible) that such invention(s) may be claimed in a future application(s) which claims benefit of priority of the present application, or, for example, in future filed claims of the present application. The present disclosure of the present application supports such invention(s)/claim(s).

### Adjectival And Adverbial Use, In The Present Application, Does Not Limit The Ability To Claim Without The Adjective/Adverb

In the present application, adjectival definition of a noun/feature in no way limits the ability to claim, (or in any way include in a claim(s)), the noun/feature, without the adjective. Thus if a ‘curved edge’ is disclosed, it should be understood that it is disclosed simply by way of example, as an embodiment of ‘an edge’, and that an invention may be claimed, comprising an ‘edge’, and not limited to comprising a ‘curved edge’, even if the only disclosure in the specification is of a ‘curved edge’. This goes for every single adjective example in the present application, and also applies to adverbs in the same way, with reference to how they limit a broader verb/action, which verb/action/characterizing feature may be included in a claim (and is supported), not limited by the adverb that further defines it. This also applies to ‘usage for’ definitions. Thus if an instrument/apparatus, for example, is described, with reference to use for a particular thing (eg a ‘pet cleaning apparatus’, (which is therefore a cleaning apparatus, for use on pets)), then a ‘cleaning apparatus’ may be claimed, (or in any way be included in a claim(s)), not limited to being a ‘pet’ cleaning apparatus and/or not limited to being for use on pets, even if all disclosure in the patent application relates to a ‘pet cleaning apparatus’.

### The Title Of The Present Application Does Not Limit What May Be Claimed

The title of the present application (and the claims presented) do not limit what may be claimed futurely, based upon (and supported by) the present application. For example, if the title is ‘Pet Cleaning Apparatus’, even if all disclosure in the patent application relates to a pet cleaning apparatus (as do the claims), nevertheless, a ‘cleaning apparatus’ may be claimed (not limited to being for pets), as it is clear a ‘pet cleaning apparatus’ is an embodiment of a ‘cleaning apparatus’. As stated previously, in the present application, adjectival definition of a noun in no way limits the ability to claim, (or in any way include in a claim(s)), the noun, without the adjective. This also applies to the title. Furthermore, an invention may be claimed comprising any feature, or combination of features, disclosed in the present application.

### Any Feature Disclosed May Be More Broadly Defined/Claimed As A Feature/Arrangement

Any feature (for/with a given purpose) disclosed in the present application, whatever it is disclosed or defined as, may be more broadly defined in a claim as a feature (or arrangement) for the given purpose. Thus, if, for example, in the present application, a ‘pin’ is disclosed, for holding element ‘a’ and element ‘b’ together, such disclosure supports definition in a claim (in this, or a future patent application that claims benefit of priority to the present patent application) of a ‘holding feature’ (or ‘holding arrangement’), for holding element ‘a’ and element ‘b’ together. This is the case for all feature(s)/disclosure, even including feature(s) defined in any statement(s) of invention and/or title of the invention.

### Feature(s) Shown In The Drawings May Be Combined To Form An Invention

Any feature(s) or combination of feature(s) shown in any drawing(s) may be combined with any other feature(s) or combination of feature(s) shown in any other drawing(s), to form an invention, which may be claimed. This may be the case for any embodiment shown in any drawing(s), and applicant(s) reserves the right to claim any such invention(s). Furthermore, such feature(s) may, of course, be combined with any other feature(s) and/or disclosure of the present application, to form an invention(s), which may be claimed. Such an invention(s) may be claimed in a future application(s) which claims benefit of priority of the present application, or, for example, in future filed claims of the present application. The present disclosure of the present application supports such invention(s)/claim(s).

1. A system for catching rainwater from a roof, comprising:
a watering can, positioned under a side of the roof, in a position suitable for catching rainwater that falls off the side of the roof, the watering can thus being in a water catching position; and
a blocking arrangement, comprising a front blocking portion, to block view of a portion or a whole of the watering can, from a front view.

2. A system for catching rainwater from a roof as claimed in claim 1, wherein, in a water catching mode, the front blocking portion, at its highest point, is equal to or higher than height of half height of a main body of the watering can.

3. A system for catching rainwater from a roof as claimed in claim 1, wherein, in a water catching mode, the front blocking portion, at its highest point, is equal to or higher than height of a highest point of a main body of the watering can.

4. A system for catching rainwater from a roof as claimed in claim 1, wherein, in a water catching mode, the blocking arrangement blocks view of at least a quarter of a main body of the watering can, from the front view.

5. A system for catching rainwater from a roof as claimed in claim 1, wherein, in a water catching mode, the blocking arrangement blocks view of at least a half of a main body of the watering can, from the front view.

6. A system for catching rainwater from a roof as claimed in claim 1, wherein, in a water catching mode, the blocking arrangement blocks view of at least three quarters of a main body of the watering can, from the front view.

7. A system for catching rainwater from a roof as claimed in claim 1, wherein, in a water catching mode, the blocking arrangement blocks view of a whole of a main body of the watering can, from the front view.

8. A system for catching rainwater from a roof as claimed in claim 1, wherein, in a water catching mode, the blocking arrangement blocks view of a whole of the watering can, from the front view.

9. A system for catching rainwater from a roof as claimed in claim 1, wherein the blocking arrangement, at its furthest point back, is as far back, or further back, than half of a main body of the watering can.

10. A system for catching rainwater from a roof as claimed in claim 1, wherein the blocking arrangement, at its furthest point back, is as far back, or further back, than a whole of the main body of the watering can.

11. A system for catching rainwater from a roof as claimed in claim 1, wherein the blocking arrangement comprises:
a left blocking portion, to block view of a portion or a whole of the watering can, from a left view; and/or
a right blocking portion, to block view of a portion or a whole of the watering can, from a right view.

12. A system for catching rainwater from a roof as claimed in claim 1, wherein the blocking arrangement comprises:
a left blocking portion, to block view of a portion or a whole of the watering can, from a left view; and
a right blocking portion, to block view of a portion or a whole of the watering can, from a right view.

13. A system for catching rainwater from a roof as claimed in claim 12, wherein:
the left blocking portion, at its highest point, is equal to or higher than height of half height of a main body of the watering can; and
the right blocking portion, at its highest point, is equal to or higher than height of half height of the main body of the watering can.

14. A system for catching rainwater from a roof as claimed in claim 12, wherein:
the left blocking portion, at its highest point, is equal to or higher than height of a highest point of a main body of the watering can; and
the right blocking portion, at its highest point, is equal to or higher than height of a highest point of the main body of the watering can.

15. A system for catching rainwater from a roof as claimed in claim 12, wherein the system for catching rainwater is operable, in a water catching mode, with:
the left blocking portion, at its furthest point back, being further back than half of a main body of the watering can, from the left view; and
the right blocking portion, at its furthest point back, being further back than half of the main body of the watering can, from the right view.

16. A system for catching rainwater from a roof as claimed in claim 12, wherein the system for catching rainwater is operable, in a water catching mode, with:
the left blocking portion, at its furthest point back, being further back than half of a main body of the watering can, from the left view; and
the right blocking portion, at its furthest point back, being further back than half of the main body of the watering can, from the right view.

17. A system for catching rainwater from a roof as claimed in claim 1, wherein the system for catching rainwater comprises a positioning system, to keep the watering can positioned in the water catching position.

18. A system for catching rainwater from a roof as claimed in claim 17, wherein, in the water catching position, the watering can is positioned on an apparatus.

19. A system for catching rainwater from a roof as claimed in claim 17, wherein there is an area to input water into that the watering can does not comprise, to help keep the watering can in the water catching position, due to weight of the water.

20. A system for catching rainwater from a roof as claimed in claim 18, wherein the apparatus the watering can is positioned on, in the water catching position, comprises an area to input water into, to help keep the watering can in the water catching position, due to weight of the water.

21. A system for catching rainwater from a roof as claimed in claim 19, wherein the area to input water into is a water storage area that is operable in a closed mode, where water cannot escape.

22. A system for catching rainwater from a roof as claimed in claim 20, wherein the area to input water into is a water storage area that is operable in a closed mode, where water cannot escape.

23. A system for catching rainwater from a roof as claimed in claim 19, wherein water is in the area to input water into, to help keep the watering can in the water catching position, due to weight of the water.

24. A system for catching rainwater from a roof as claimed in claim 19, wherein the area to input water into is a planting area, for planting one, or more than one, plant into.

25. A system for catching rainwater from a roof as claimed in claim 24, wherein there is soil in the planting area.

26. A system for catching rainwater from a roof as claimed in claim 1, wherein the blocking arrangement comprises at least one plant that plays a blocking role in the front blocking portion blocking view of the portion or the whole of the watering can, from the front view.

27. A system for catching rainwater from a roof as claimed in claim 26, wherein at least one of the at least one plant that plays a blocking role in the front blocking portion blocking view of the portion or the whole of the watering can is a fake plant.
